(19) United States
(12) Patent Application Publication
(10) Pub. No.: US 2020/0054022 A1
(43) Pub. Date: Feb. 20, 2020

(54) COMPOSITIONS AND METHODS FOR CONTROLLING PLANT PESTS AND PLANT DISEASE

(71) Applicant: AgBiome, Inc., Durham, NC (US)

(72) Inventor: Eric R. Ward, Durham, NC (US)

(73) Assignee: AgBiome, Inc., Durham, NC (US)

(21) Appl. No.: 16/534,364

(22) Filed: Aug. 7, 2019

Related U.S. Application Data
(60) Provisional application No. 62/716,719, filed on Aug. 9, 2018.

(51) Int. Cl. A01N 63/00; A01N 63/02; A01N 63/04; A01N 43/40; A01N 43/653

(52) U.S. Cl. CPC A01N 63/00; A01N 63/02; A01N 43/653; A01N 43/40; A01N 63/04

(57) ABSTRACT

Compositions and methods for treating or preventing a fungal plant disease are provided. Such compositions and methods comprise a combination of one or more chemical fungicides and one or more fungicidal bacterial or fungal strains, or an active variant thereof, that controls one or more fungal pathogens that cause fungal plant disease. Methods for growing a plant susceptible to a fungal plant disease and methods for controlling a fungal plant pathogen are also provided.

### FIELD OF THE INVENTION

The invention relates to the use of a combination of a pesticidal microbial strain and one or more synthetic pesticides for controlling plant pests and plant disease.

### BACKGROUND

Plant pests, including plant pathogens and insect plant pests, are responsible for significant agricultural losses. Effects can range from mild to catastrophic plant damage, which can lead to major economic and social consequences. Methods are needed to effectively control plant pests and plant diseases.

### SUMMARY

Compositions and methods for controlling plant pests and plant diseases caused thereby are provided. Such compositions and methods comprise a combination of one or more pesticidal microbial strains, and/or a plant extract, and one or more chemical pesticides (e.g., fenhexamid, fluazinam, flutriafol, flutolanil, penflufen, propiconazole, tebuconazole, chlorothalonil, azoxystrobin, trifloxystrobin, triflumizole, difenoconazole, tetraconazole, prothioconazole, pyraclostrobin, metconazole, boscalid, fluoxastrobin, fosetyl-aluminum, metrafenone and/or acetamiprid). The combination of a pesticidal microbial strain and chemical pesticide(s) controls one or more plant pests, including plant pests that cause plant disease. Methods for growing a plant susceptible to a plant disease and methods and compositions for controlling plant pests and plant diseases are also provided.

### DETAILED DESCRIPTION

### I. Overview

Compositions and methods for controlling one or more plant pests and plant diseases caused thereby are provided. The compositions and methods provided herein involve the use of a combination of one or more chemical pesticides and a pesticidal microbial strain. A biological agent, biocontrol agent, pesticidal microbial strain, bacterial strain, modified bacterial strain, fungal strain, modified fungal strain, modified biological agent, or modified biocontrol agent or active variant thereof are used herein to describe a biocontrol agent that is used to control disease-causing plant pathogens (e.g., fungal plant pathogens). In some embodiments, the biocontrol agent is a pesticidal microbial strain, which in combination with a synthetic chemical pesticide exhibits synergistic pesticidal activity. In particular embodiments, a pesticidal microbial strain and a chemical pesticide(s) exhibit synergistic pesticidal activity. In further embodiments, a bacterial strain and a chemical fungicide(s) exhibit synergistic fungicidal activity.

### II. Microbial Strains of Interest

Biocontrol agents are provided which may be combined with at least one chemical pesticide to control one or more fungal plant pathogens and/or insect and/or nematode plant pests. The biocontrol agents of the presently disclosed compositions include pesticidal bacterial strains of interest, including: Bacillus amyloliquefaciens strain D747, (e.g. DOUBLENICKEL™ 55 or DOUBLENICKEL™ LC from Certis USA, L.L.C, having Accession No. FERM BP-8234 and described in U.S. Pat. No. 7,094,592, incorporated by reference in its entirety herein); Bacillus subtilis strain QST 713/AQ713 (e.g. SERENADE® MAX from Bayer CropScience LP, US, having NRRL Accession No. B-21661 and described in U.S. Pat. No. 6,060,051, incorporated by reference in its entirety herein; Bacillus subtilis strain AQ30002 (aka QST30002; NRRL Accession No. B-50421), and AQ30004 (aka QST3004; NRRL Accession No. B-50455), both from Bayer CropScience LP, US and described in U.S. Pat. No. 9,185,915, incorporated by reference in its entirety herein; Bacillus subtilis strain QST 713 (e.g. RHAPSODY® from Bayer CropScience, LP, US); Bacillus amyloliquefaciens strain GB03 (e.g. KODIAK® from Bayer CropScience, AG, DE); Bacillus pumilus strain QST 2808 (e.g. SONATA® from Bayer CropScience, having NRRL Accession No. B-30087); Bacillus pumilus strain GB34 (e.g. YIELD SHIELD from Bayer CropScience AG, DE); Bacillus finnus strain CNMC 1-1582 (e.g. VOTiVO® from Bayer Crop Science); Streptomyces lydicus strain WYEC108 (e.g. ACTINOVATE® from Natural Industries, US, having ATCC Accession No. 55445): Streptomyces griseoviridis strain K61 (e.g. MYCOSTOP® from Verdera, cf. Crop Protection 2006, 25, 468-475, having Accession No. DSM 7206); Agrobacterium radiobacter strain 1026 (e.g. NOGALL™ from Becker Underwood, US); Agrobacterium radiobacter strain K84 (e.g. GALLTROL-A® from AgBioChem, CA); Pseudomonas fluorescens strain A506 (e.g. BLIGHTBAN® by NuFarm and also e.g. FROSTBAN B by Frost Technology Corp); Bacillus thuringiensis subspecies aizawai strain GC-91 (e.g. AGREE® from Certis USA, LLC); Bacillus thuringiensis subspecies kurstaki (e.g. BT 320 DUST from Wilbur-Ellis Company); Bacillus thuringiensis subspecies kurstaki strain EG7841 (e.g. CRYMAX® from Certis USA LLC); Bacillus thuringiensis subspecies kurstaki strain SA-12 (e.g. DELIVER® from Certis USA LLC); Bacillus thuringiensis subspecies kurstaki strain ABTS-351 (e.g. DiPel® from Valent BioSciences Corp, having ATCC Accession No. SD-1275); Bacillus thuringiensis subspecies kurstaki strain SA-11 (e.g. JAVELIN® from Certis USA LLC); Bacillus thuringiensis subspecies tenebrionis strain SA-10 (e.g. TRIDENT® from Certis USA LLC); Chromobacterium subtsugae strain PRAA4-1 (e.g. GRANDEVO® from Marrone Biolnnovations, USA); Isaria fumosorosea Apopka Strain 97 (e.g. PFR-97™ from Certis USA LLC, having ATTC Accssion No. 20874); Burkholderia spp. strain A396 (e.g. VENERATE™ from Marrone Biolnnovations, USA); and Bacillus thuringiensis subspecies aizawai strain ABTS-1857 (e.g. XENTARI® from Valent BioSciences Corp, USA).

The biocontrol agents of the presently disclosed compositions also include pesticidal fungal strains. These fungal strains of interest include Trichoderma harzianum strain KRL-AG2 (also known as strain T-22, e.g. PLANTSHIELD® T-22G, ROOTSHIELD®, and TURFSHIELD from BioWorks, USA, having ATCC Accession No. 408479); Gliochladium vierns, aka Trichoderma vixens, strain GL-21 (e.g. SOILGARD® 12G from Certis USA, L.L.C); Coniothyrium minitans strain CON/M/91-8 (e.g. CONTANS® from Encore Technologies, LLC, having Accession No. DSM-9660); Purpureocilium lilacinum; Ulocladium oudemansii U3 strain (aka HRU3 strain), (e.g. BOTRY-ZEN® by Botry-Zen Ltd, NZ); and Beauveria bassiana strain GHA (e.g. MYCOTROL® from Lam International Corp.).

The biocontrol agents of the presently disclosed compositions also include pesticidal virus isolates. A virus may refer to a complete viral isolate itself or may refer to viral occlusion bodies. These viruses of interest include Cydia pomonella granulovirus (e.g. CYD-X® and CYD-X® HP, both from Certis USA LLC; CARPOVIRUSINE® from Sumitomo Corp.); Cydia pomonella granulovirus isolate V22 (e.g. MADEX HP from Andermatt Biocontrol AG); and polyhedral occlusion bodies of the nuclear polyhedrosis virus of Helicoverpa zea (e.g. GEMSTAR® from Certis USA LLC).

The biocontrol agents of the presently disclosed compositions also include biopesticides derived from plant extracts. These biopesticides of interest include extracts of Chenopodium ambrosioides (e.g. Requiem® from Bayer CropScience LP).

The biocontrol agents of the presently disclosed compositions also include biostimulants. A biostimulant is any microorganism or substance based on nautral resources. It is applied to plants, seeds, or the rhizosphere with the intention to stimulate natural processes of plants to benefit nutrient uptake, nutrient use efficiency, tolerance to abiotic stresses, and/or general plant health, including resistance to disease. Biostimulants include plant extracts, such as for example extracts derived from Reynoutria sachalinensis (e.g. REGALIA® from Marrone Bioinnovations, USA).

A cell, a spore, a forespore, or a combination of cells, spores, and/or forespores, of any of the bacterial strains described above or an active variant thereof, or any preparation thereof, can be used in the presently disclosed compositions and methods. Additionally, a cell, a spore, or a fungal part such as a piece of mycelium or hyphae, or a combination of cells, spores, and mycelia of any of the fungal strains described above or an active variant thereof, or any preparation thereof, can be used in the presently disclosed compositions and methods.

The term “isolated” encompasses a bacterium, fungus, spore, or other entity or substance, that has been (1) separated from at least some of the components with which it was associated when initially produced (whether in nature or in an experimental setting), and/or (2) produced, prepared, purified, and/or manufactured by the hand of man Isolated bacteria or fungi may be separated from at least about 10%, about 20%, about 30%, about 40%, about 50%, about 60%, about 70%, about 80%, about 90%, or more of the other components with which they were initially associated.

As used herein, a substance is “pure” if it is substantially free of other components. The terms “purify,” “purifying” and “purified” refer to a bacterium, spore, or other material that has been separated from at least some of the components with which it was associated either when initially produced or generated (e.g., whether in nature or in an experimental setting), or during any time after its initial production. A bacterium, fungus, fungal part, spore, bacterial population, fungal population, mass of mycelia, or a spore population may be considered purified if it is isolated at or after production, such as from a material or environment containing the it. A purified bacterium, bacterial population, fungus, fungal population, or spore may contain other materials up to about 10%, about 20%, about 30%, about 40%, about 50%, about 60%, about 70%, about 80%, about 90%, or above about 90% and still be considered purified. In some embodiments, purified bacteria, fungi, or spores and bacterial populations, fungal populations, or spore populations are more than about 80%, about 85%, about 90%, about 91%, about 92%, about 93%, about 94%, about 95%, about 96%, about 97%, about 98%, about 99%, or more than about 99% pure. In specific embodiments, a culture of bacteria or fungi contains no other microbial species in quantities to be detected by normal microbiological techniques.

By “population” is intended a group or collection that comprises two or more (i.e., 10, 100, 1,000, 10,000, 1×10⁶, 1×10⁷, or 1×10⁸ or greater). Various compositions are provided herein that comprise a population of cells, spores, forespores, mycelia, or a combination of cells, spores, forespores and/or mycelia of the recited bacterial or fungal strains or an active variant thereof. In specific embodiments, the population of cells, spores, forespores, mycelia, or a combination of cells, spores, forespores, and/or mycelia of the recited bacterial or fungal strains or an active variant thereof comprises a concentration of at least about 10³ CFU/ml to about 10¹¹ CFU/ml, about 10³ CFU/ml to about 10¹⁰ CFU/ml, about 10³ CFU/ml to about 10¹² CFU/ml, about 10³ CFU/ml to about 10⁶ CFU/ml, about 10³ CFU/ml to about 10⁵ CFU/ml, about 10³ CFU/ml to about 10⁴ CFU/ml, about 10⁶ CFU/ml to about 10⁷ CFU/ml, about 10⁷ CFU/ml to about 10⁸ CFU/ml, about 10⁸ CFU/ml to about 10⁹ CFU/ml, about 10⁹ CFU/ml to about 10¹⁰ CFU/ml, about 10¹⁰ CFU/ml to about 10¹¹ CFU/ml, about 10¹¹ CFU/ml to about 10¹² CFU/ml. In other embodiments, the concentration of a recited bacterial or fungal strain of interest or active variant thereof comprises at least about 10⁵ CFU/ml, at least about 10⁶ CFU/ml, at least about 10⁷ CFU/ml, at least about 10⁸ CFU/ml, at least about 10⁹ CFU/ml, at least about 10¹⁰ CFU/ml, at least about 10¹¹ CFU/ml, or at least about 10¹² CFU/ml.

A “spore” refers to at least one dormant (at application) but viable reproductive unit of a microbial species, such as a species of fungi or bacteria. It is further recognized the populations disclosed herein can comprise a combination of vegetative cells and forepores (cells in an intermediate stage of spore formation); a combination of forespores and spores; or a combination of forespores, vegetative cells and/or spores.

A. Active Variants of a Microbial Strain

Compositions and methods provided herein can comprise an active variant of a pesticidal microbial strain recited herein. Such variants will retain the ability to control one or more plant diseases (i.e., reduce disease severity and/or reduce disease development) and/or control one or more plant pathogens. Thus, the active variants of a recited pesticidal microbial strain of interest will retain pesticidal activity against a plant pathogen. As used herein, “pesticidal activity” refers to activity against one or more plant pathogens or plant pests, such that the plant pathogen or plant pest is killed or controlled. The plant pathogen may be fungal, bacterial, or viral. The plant pest may be an insect or a nematode. “Fungicidal activity” refers to activity against one or more fungal plant pathogens, such that the fungal plant pathogen is killed or controlled. “Insecticidal activity” refers to activity against one or more insect plant pests, such that the insect plant pest is killed or controlled.

Active variants of a pesticidal microbial strain include, for example, any isolate or mutant of any of the pesticidal microbial strains recited above.

The pesticidal microbial strain is compatible with the simultaneously or sequentially applied one or more chemical pesticides. In certain embodiments, the microbial strain is also compatible with an additional biocide (other than a chemical pesticide). A biocide is a chemical substance that can exert a controlling effect on an organism by chemical or biological means. Biocides include pesticides, such as fungicides or insecticides; herbicides; other crop protection chemicals, and the like. Such compounds are discussed in detail elsewhere herein. A microbial strain is compatible with a biocide when the microbial strain is able to survive and/or reproduce in the presence of an effective amount of a biocide of interest. In instances where the microbial strain is not compatible with a biocide of interest, if desired, methods can be undertaken to modify the microbial strain to impart the compatibility of interest. Such methods to produce modified microbial strains include both selection techniques and/or transformation techniques.

By “modified microbial strain” is intended a population wherein the strain has been modified (by selection and/or transformation) to have one or more additional traits of interest. The modified microbial strain comprises an active variant of a pesticidal microbial strain recited herein.

Recombinant bacterial strains can be made through genetic engineering techniques and such engineered or recombinant bacterial strains grown to produce a modified population of bacterial strains. A recombinant bacterial strain is produced by introducing polynucleotides into the bacterial host cell by transformation. Methods for transforming microorganisms are known and available in the art. See, generally, Hanahan, D. (1983) Studies on transformation of Escherichia coli with plasmids J. Mol. Biol. 166, 557-77; Seidman, C. E. (1994) In: Current Protocols in Molecular Biology, Ausubel, F. M. et al. eds., John Wiley and Sons, NY; Choi et al. (2006) J. Microbiol. Methods 64:391-397; Wang et al. 2010. J. Chem. Technol. Biotechnol. 85:775-778. Transformation may occur by natural uptake of naked DNA by competent cells from their environment in the laboratory. Alternatively, cells can be made competent by exposure to divalent cations under cold conditions, by electroporation, by exposure to polyethylene glycol, by treatment with fibrous nanoparticles, or other methods well known in the art.

Further active variants of a pesticidal microbial strain recited herein can be identified employing, for example, methods that determine the sequence identity relatedness between the 16S ribosomal RNA, methods to identify groups of derived and functionally identical or nearly identical strains include Multi-locus sequence typing (MLST), concatenated shared genes trees, Whole Genome Alignment (WGA), Average Nucleotide Identity, and MinHash (Mash) distance metric.

In one aspect, the active variants of a pesticidal microbial strain recited herein include strains that are closely related to said pesticidal microbial strain by employing the Bishop MLST method of organism classification as defined in Bishop et al. (2009) BMC Biology 7(1)1741-7007-7-3. Thus, in specific embodiments, an active variant of a pesticidal microbial strain recited herein includes a bacterial or fungal strain that falls within at least a 80%, 85%, 86%, 87%, 88%, 89%, 90%, 91%, 92%, 93%. 94%, 95%, 96%, 97%, 98%, 98.5%, 98.8%, 99%, 99.1%, 99.2%, 99.3%, 99.4%, 99.5%, 99.6%, 99.7%, 99.8%, or 99.9% sequence cut off employing the Bishop method of organism classification as set forth in Bishop et al. (2009) BMC Biology 7(1)1741-7007-7-3, which is herein incorporated by reference in its entirety. Active variants of the pesticidal microbial strain identified by such methods will retain the ability to reduce fungal plant disease severity, reduce plant disease development, and/or control plant pathogens when applied in an effective amount to a plant, plant part, an area of cultivation, or a population of plant pathogens.

In another aspect, the active variant of a pesticidal microbial strain recited herein include strains that are closely related to the pesticidal microbial strain on the basis of the Average Nucleotide Identity (ANI) method of organism classification. ANI (see, for example, Konstantinidis, K. T., et al., (2005) PNAS USA 102(7):2567-72; and Richter, M., et al., (2009) PNAS 106(45):19126-31) and variants (see, for example, Varghese, N.J., et al., Nucleic Acids Research (Jul. 6, 2015): gkv657) are based on summarizing the average nucleotides shared between the genomes of strains that align in WGAs. Thus, in specific embodiments, an active variant of a pesticidal microbial strain recited herein includes a microbial strain that falls within at least a 90%, 95%, 96%, 97%, 97.5%, 98%, 98.5%, 98.8%, 99%, 99.5%, or 99.8% sequence cut off employing the ANI method of organism classification as set forth in Konstantinidis, K. T., et al., (2005) PNAS USA 102(7):2567-72, which is herein incorporated by reference in its entirety. Active variants of the pesticidal microbial strain identified by such methods will retain the ability to reduce fungal plant disease severity, reduce plant disease development, and/or control plant pathogens when applied in an effective amount to a plant, plant part, an area of cultivation, or a population of plant pathogens.

In another aspect, the active variants of a pesticidal microbial strain recited herein includes strain(s) that are closely related to the pesticidal microbial strain on the basis of 16S rDNA sequence identity. See Stackebrandt E, et al., “Report of the ad hoc committee for the re-evaluation of the species definition in bacteriology,” Int J Syst Evol Microbiol. 52(3):1043-7 (2002) regarding use of 16S rDNA sequence identity for determining relatedness in bacteria. In an embodiment, the active variant is at least 95% identical to the pesticidal microbial strain on the basis of 16S rDNA sequence identity, at least 96% identical to the pesticidal microbial strain on the basis of 16S rDNA sequence identity, at least 97% identical to the pesticidal microbial strain on the basis of 16S rDNA sequence identity, at least 98% to the pesticidal microbial strain on the basis of 16S rDNA sequence identity, at least 98.5% identical to the pesticidal microbial strain on the basis of 16S rDNA sequence identity, at least 99% identical to the pesticidal microbial strain on the basis of 16S rDNA sequence identity, at least 99.5% to the pesticidal microbial strain on the basis of 16S rDNA sequence identity or at least 100% to the pesticidal microbial strain on the basis of 16S rDNA sequence identity. Active variants of the pesticidal microbial strain identified by such methods will retain the ability to reduce fungal plant disease severity, reduce plant disease development, and/or control plant pathogens when applied in an effective amount to a plant, plant part, an area of cultivation, or a population of plant pathogens.

The MinHash (Mash) distance metric is a comparison method that defines thresholds for hierarchical classification of microorganisms at high resolution and requires few parameters and steps (Ondov et al. (2016) Genome Biology 17:132). Mash distance strongly corresponds to Average Nucleotide Identity method (ANI) for hierarchical classification (See, Konstantinidis, K. T. et al. (2005) PNAS USA 102(7):2567-72, herein incorporated by reference in its entirety). That is, an ANI of 97% is approximately equal to a Mash distance of 0.03, such that values put forth as useful classification thresholds in the ANI literature can be directly applied with the Mash distance.

Active variants of a pesticidal microbial strain recited herein include strains that are closely related to the pesticidal microbial strain on the basis of the Minhash (Mash) distance between complete genome DNA sequences. Thus, in specific embodiments, an active variant of the pesticidal microbial strain includes microbial strains having a genome within a Mash distance of less than about 0.015 to the disclosed strains. In other embodiments, an active variant of the pesticidal microbial strain includes a distance metric of less than about 0.005, 0.010, 0.015, 0.020, 0.025, or 0.030. A genome, as it relates to the Mash distance includes both bacterial chromosomal DNA and bacterial plasmid DNA. In other embodiments, the active variant of pesticidal microbial strain has a genome that is above a Mash distance threshold to the recited bacterial or fungal strain of interest that is greater than dissimilarity caused by technical variance. In further instances, the active variant of the pesticidal microbial strain has a genome that is above a Mash distance threshold to the pesticidal microbial strain that is greater than dissimilarity caused by technical variance and has a Mash distance of less than about 0.015. In other instances, the active variant of the pesticidal microbial strain has a genome that is above a Mash distance threshold to the pesticidal microbial strain that is greater than dissimilarity caused by technical variance and has a Mash distance of less than about 0.005, 0.010, 0.015, 0.020, 0.025, or 0.030.

As used herein, “above technical variation” means above the Mash distance between two strains caused by errors in the genome assemblies provided the genomes being compared were each DNA sequenced with at least 20× coverage with the Illumina HiSeq 2500 DNA sequencing technology and the genomes are at least 99% complete with evidence for contamination of less than 2%. While 20× coverage is an art recognized term, for clarity, an example of 20× coverage is as follows: for a genome size of 5 megabases (MB), 100 MB of DNA sequencing from the given genome is required to have 20× sequencing coverage on average at each position along the genome. There are many suitable collections of marker genes to use for genome completeness calculations including the sets found in Campbell et al. (2013) PNAS USA 110(14):5540-45, Dupont et al. (2012) ISMEJ 6:1625-1628, and the CheckM framework (Parks et al. (2015) Genome Research 25:1043-1055); each of these references is herein incorporated in their entirety. Contamination is defined as the percentage of typically single copy marker genes that are found in multiple copies in the given genome sequence (e.g. Parks et al. (2015) Genome Research 25:1043-1055); each of these references is herein incorporated in their entirety. Completeness and contamination are calculated using the same collection of marker genes. Unless otherwise stated, the set of collection markers employed in the completeness and contamination assay is those set forth in Campbell et al. (2013) PNAS USA 110(14):5540-45, herein incorporated by reference.

Exemplary steps to obtain a distance estimate between the genomes in question are as follows: (1) Genomes of sufficient quality for comparison must be produced. A genome of sufficient quality is defined as a genome assembly created with enough DNA sequence to amount to at least 20× genome coverage using Illumina HiSeq 2500 technology. The genome must be at least 99% complete with contamination of less than 2% to be compared to the claimed microbe's genome. (2) Genomes are to be compared using the Minhash workflow as demonstrated in Ondov et al. (2016) Genome Biology 17:132, herein incorporated by reference in its entirety. Unless otherwise stated, parameters employed are as follows: “sketch” size of 1000, and “k-mer length” of 21. (3) Confirm that the Mash distance between the two genomes is less than 0.005, 0.010, 0.015, 0.020, 0.025, or 0.030. Active variants of the bacteria identified by such methods will retain the ability to reduce fungal plant disease severity, reduce fungal plant disease development, and/or control fungal plant pathogens when applied in an effective amount to a plant, plant part, an area of cultivation, or a population of fungal plant pathogens.

### III. Chemical Fungicides

The presently disclosed compositions and methods involve chemical fungicides. As used herein, a “fungicide” refers to a chemical or biological compound or organism that has fungicidal activity (i.e., activity against one or more fungal plant pathogens, such that the fungal plant pathogen is killed or controlled). A chemical fungicide is a fungicide that is not a biological organism or microorganism. A chemical fungicide can be naturally occurring or synthetic.

Fungicides that can be used in the various methods and compositions disclosed herein include aliphatic nitrogen fungicides (butylamine, cymoxanil, dodicin, dodine, guazatine, iminoctadine); amide fungicides (benzovindiflupyr, carpropamid, chloraniformethan, cyflufenamid, diclocymet, diclocymet, dimoxystrobin, fenaminstrobin, fenoxanil, flumetover, furametpyr, isofetamid, isopyrazam, mandestrobin, mandipropamid, metominostrobin, orysastrobin, penthiopyrad, prochloraz, quinazamid, silthiofam, triforine); acylamino acid fungicides (benalaxyl, benalaxyl-M, furalaxyl, metalaxyl, metalaxyl-M, pefurazoate, valifenalate); anilide fungicides (benalaxyl, benalaxyl-M, bixafen, boscalid, carboxin, fenhexamid, fluxapyroxad, isotianil, metalaxyl, metalaxyl-M, metsulfovax, ofurace, oxadixyl, oxycarboxin, penflufen, pyracarbolid, sedaxane, thifluzamide, tiadinil, vanguard); benzanilide fungicides (benodanil, flutolanil, mebenil, mepronil, salicylanilide, tecloftalam); furanilide fungicides (fenfuram, furalaxyl, furcarbanil, methfuroxam); sulfonanilide fungicides (flusulfamide); benzamide fungicides (benzohydroxamic acid, fluopicolide, fluopyram, tioxymid, trichlamide, zarilamid, zoxamide); furamide fungicides (cyclafuramid, furmecyclox); phenylsulfamide fungicides (dichlofluanid, tolylfluanid); sulfonamide fungicides (amisulbrom, cyazofamid); valinamide fungicides (benthiavalicarb, iprovalicarb); antibiotic fungicides (aureofungin, blasticidin-S, cycloheximide, griseofulvin, kasugamycin, moroxydine, natamycin, polyoxins, polyoxorim, streptomycin, validamycin, oxytetracycline); strobilurin fungicides (fluoxastrobin, mandestrobin); methoxyacrylate strobilurin fungicides (azoxystrobin, bifujunzhi, coumoxystrobin, enoxastrobin, flufenoxystrobin, jiaxiangjunzhi, picoxystrobin, pyraoxystrobin); methoxycarbanilate strobilurin fungicides (pyraclostrobin, pyrametostrobin, triclopyricarb); methoxyiminoacetamide strobilurin fungicides (dimoxystrobin, fenaminstrobin, metominostrobin, orysastrobin); methoxyiminoacetate strobilurin fungicides (kresoxim-methyl, trifloxystrobin); aromatic fungicides (biphenyl, chlorodinitronaphthalenes, chloroneb, chlorothalonil, cresol, dicloran, fenjuntong, hexachlorobenzene, pentachlorophenol, quintozene, sodium pentachlorophenoxide, tecnazene, trichlorotrinitrobenzenes); arsenical fungicides (asomate, urbacide); aryl phenyl ketone fungicides (metrafenone, pyriofenone); benzimidazole fungicides (albendazole, benomyl, carbendazim, chlorfenazole, cypendazole, debacarb, fuberidazole, mecarbinzid, rabenzazole, thiabendazole); benzimidazole precursor fungicides (furophanate, thiophanate, thiophanate-methyl); benzothiazole fungicides (bentaluron, benthiavalicarb, benthiazole, chlobenthiazone, probenazole); botanical fungicides (allicin, berberine, carvacrol, carvone, osthol, sanguinarine, santonin); bridged diphenyl fungicides (bithionol, dichlorophen, diphenylamine, hexachlorophene, parinol); carbamate fungicides (benthiavalicarb, furophanate, iodocarb, iprovalicarb, picarbutrazox, propamocarb, pyribencarb, thiophanate, thiophanate-methyl, tolprocarb); benzimidazolylcarbamate fungicides (albendazole, benomyl, carbendazim, cypendazole, debacarb, mecarbinzid); carbanilate fungicides (diethofencarb, pyraclostrobin, pyrametostrobin, triclopyricarb); conazole fungicides, conazole fungicides (imidazoles) (climbazole, clotrimazole, imazalil, oxpoconazole, prochloraz, triflumizole); conazole fungicides (triazoles) (azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, my clobutanil, penconazole, propiconazole, prothioconazole, quinconazole, simeconazole, tebuconazole, tetraconazole, triadimefon, triadimenol, triticonazole, uniconazole, uniconazole-P); copper fungicides (acypetacs-copper, Bordeaux mixture, Burgundy mixture, Cheshunt mixture, copper acetate, copper carbonate, basic, copper hydroxide, copper naphthenate, copper octanoate, copper oleate, copper oxychloride, copper silicate, copper sulfate, copper sulfate, basic, copper zinc chromate, cufraneb, cuprobam, cuprous oxide, mancopper, oxine-copper, saisentong, thiodiazole-copper); cyanoacrylate fungicides (benzamacril, phenamacril); dicarboximide fungicides (famoxadone, fluoroimide); dichlorophenyl dicarboximide fungicides (chlozolinate, dichlozoline, iprodione, isovaledione, myclozolin, procymidone, vinclozolin); phthalimide fungicides (captafol, captan, ditalimfos, folpet, thiochlorfenphim); dinitrophenol fungicides (binapacryl, dinobuton, dinocap, dinocap-4, dinocap-6, meptyldinocap, dinocton, dinopenton, dinosulfon, dinoterbon, DNOC); dithiocarbamate fungicides (amobam, asomate, azithiram, carbamorph, cufraneb, cuprobam, disulfiram, ferbam, metam, nabam, tecoram, thiram, urbacide, ziram); cyclic dithiocarbamate fungicides (dazomet, etem, milneb); polymeric dithiocarbamate fungicides (mancopper, mancozeb, maneb, metiram, polycarbamate, propineb, zineb); dithiolane fungicides (isoprothiolane, saijunmao); fumigant fungicides (carbon disulfide, cyanogen, dithioether, methyl bromide, methyl iodide, sodium tetrathiocarbonate); hydrazide fungicides (benquinox, saijunmao); imidazole fungicides (cyazofamid, fenamidone, fenapanil, glyodin, iprodione, isovaledione, pefurazoate, triazoxide); conazole fungicides (imidazoles) (climbazole, clotrimazole, imazalil, oxpoconazole, prochloraz, triflumizole); inorganic fungicides (potassium azide, potassium thiocyanate, sodium azide, sulfur, see also copper fungicides, see also inorganic mercury fungicides); mercury fungicides; inorganic mercury fungicides (mercuric chloride, mercuric oxide, mercurous chloride); organomercury fungicides ((3-ethoxypropyl)mercury bromide, ethylmercury acetate, ethylmercury bromide, ethylmercury chloride, ethylmercury 2,3-dihydroxypropyl mercaptide, ethylmercury phosphate, N-(ethylmercury)-p-toluenesulphonanilide, hydrargaphen, 2-methoxyethylmercury chloride, methylmercury benzoate, methylmercury dicyandiamide, methylmercury pentachlorophenoxide, 8-phenylmercurioxyquinoline, phenylmercuriurea, phenylmercury acetate, phenylmercury chloride, phenylmercury derivative of pyrocatechol, phenylmercury nitrate, phenylmercury salicylate, thiomersal, tolylmercury acetate); morpholine fungicides (aldimorph, benzamorf, carbamorph, dimethomorph, dodemorph, fenpropimorph, flumorph, tridemorph); organophosphorus fungicides (ampropylfos, ditalimfos, EBP, edifenphos, fosetyl, hexylthiofos, inezin, iprobenfos, izopamfos, kejunlin, phosdiphen, pyrazophos, tolclofos-methyl, triamiphos); organotin fungicides (decafentin, fentin, tributyltin oxide); oxathiin fungicides (carboxin, oxycarboxin); oxazole fungicides (chlozolinate, dichlozoline, drazoxolon, famoxadone, hymexazol, metazoxolon, myclozolin, oxadixyl, oxathiapiprolin, pyrisoxazole, vinclozolin); poly sulfide fungicides (barium polysulfide, calcium polysulfide, potassium polysulfide, sodium poly sulfide); pyrazole fungicides (benzovindiflupyr, bixafen, fenpyrazamine, fluxapyroxad, furametpyr, isopyrazam, oxathiapiprolin, penflufen, penthiopyrad, pyraclostrobin, pyrametostrobin, pyraoxystrobin, rabenzazole, sedaxane); pyridine fungicides (boscalid, buthiobate, dipyrithione, fluazinam, fluopicolide, fluopyram, parinol, picarbutrazox, pyribencarb, pyridinitril, pyrifenox, pyrisoxazole, pyroxychlor, pyroxyfur, triclopyricarb); pyrimidine fungicides (bupirimate, diflumetorim, dimethirimol, ethirimol, fenarimol, ferimzone, nuarimol, triarimol); anilinopyrimidine fungicides (cyprodinil, mepanipyrim, pyrimethanil); pyrrole fungicides (dimetachlone, fenpiclonil, fludioxonil, fluoroimide); quaternary ammonium fungicides (berberine, sanguinarine); quinoline fungicides (ethoxyquin, halacrinate, 8-hydroxyquinoline sulfate, quinacetol, quinoxyfen, tebufloquin); quinone fungicides (chloranil, dichlone, dithianon); quinoxaline fungicides (chinomethionat, chlorquinox, thioquinox); thiadiazole fungicides (etridiazole, saisentong, thiodiazole-copper, zinc thiazole); thiazole fungicides (ethaboxam, isotianil, metsulfovax, octhilinone, oxathiapiprolin, thiabendazole, thifluzamide); thiazolidine fungicides (flutianil, thiadifluor); thiocarbamate fungicides (methasulfocarb, prothiocarb); thiophene fungicides (ethaboxam, isofetamid, silthiofam); triazine fungicides (anilazine); triazole fungicides (amisulbrom, bitertanol, fluotrimazole, triazbutil); conazole fungicides (triazoles) (azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, huanjunzuo, imibenconazole, ipconazole, metconazole, my clobutanil, penconazole, propiconazole, prothioconazole, quinconazole, simeconazole, tebuconazole, tetraconazole, triadimefon, triadimenol, triticonazole, uniconazole, uniconazole-P); triazolopyrimidine fungicides (ametoctradin); urea fungicides (bentaluron, pencycuron, quinazamid); zinc fungicides (acypetacs-zinc, copper zinc chromate, cufraneb, mancozeb, metiram, polycarbamate, polyoxorim-zinc, propineb, zinc naphthenate, zinc thiazole, zinc trichlorophenoxide, zineb, ziram); petroleum oil; hydrogen peroxide; potassium bicarbonate; kaolin clay; unclassified fungicides (acibenzolar, acypetacs, allyl alcohol, benzalkonium chloride, bethoxazin, bromothalonil, chitosan, chloropicrin, DBCP, dehydroacetic acid, diclomezine, diethyl pyrocarbonate, ethylicin, fenaminosulf, fenitropan, fenpropidin, formaldehyde, furfural, hexachlorobutadiene, methyl isothiocyanate, nitrostyrene, nitrothal-isopropyl, OCH, pentachlorophenyl laurate, 2-phenylphenol, phthalide, piperalin, propamidine, proquinazid, pyroquilon, sodium orthophenylphenoxide, spiroxamine, sultropen, thicyofen, tricyclazole), or mefenoxam.

In some embodiments, the chemical fungicide utilized in the presently disclosed compositions and methods comprises a triazole fungicide, strobilurin fungicide, anilide fungicide, aromatic fungicide, organophosphorus fungicide, aryl phenyl ketone fungicide, or a combination thereof.

A triazole fungicide is a chemical fungicide that comprises at least one heterocyclic compound with the molecular formula C₂H₃N₃ within a five-membered ring of two carbon atoms and three nitrogen atoms. Non-limiting examples of triazole fungicides include azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, ipfentrifluconazole, mefentrifluconazole, metconazole, myclobutanil, paclobutrazol, penconazole, propiconazole, prothioconazole, quinconazole, simeconazole, tebuconazole, tetraconazole, triadimefon, triadimenol, triticonazole, uniconazole, and uniconazole-P. In particular embodiments, the triazole fungicide utilized in the presently disclosed compositions and methods comprises at least one of propiconazole, difenoconazole, tetraconazole, prothioconazole, metconazole, tebuconazole, and flutriafol.

The term “strobilurin fungicides” refers to fungicides that are quinone outside inhibitors (Q₀ inhibitors or Q₀I) that act to inhibit the respiratory chain by binding to the quinol outer binding site of the cytochrome bc₁ complex and are related in structure to the strobilurins extracted from the fungus Strobilurus tenacellus. The term “strobilurin fungicides” encompasses fungicides such as fluoxastrobin, mandestrobin, and pyribencarb; methoxyacrylate strobilurin fungicides (e.g., azoxystrobin, bifujunzhi, coumoxystrobin, enoxastrobin, flufenoxystrobin, jiaxiangjunzhi, picoxystrobin, pyraoxystrobin); methoxycarbanilate strobilurin fungicides (e.g., pyraclostrobin, pyrametostrobin, triclopyricarb); methoxyiminoacetamide strobilurin fungicides (e.g., dimoxystrobin, fenaminstrobin, metominostrobin, orysastrobin); and methoxyiminoacetate strobilurin fungicides (e.g., kresoxim-methyl, trifloxystrobin). In particular embodiments, the strobilurin fungicide utilized in the presently disclosed compositions and methods comprises at least one of azoxystrobin, pyraclostrobin, fluoxastrobin, and trifloxystrobin.

An anilide fungicide is a chemical fungicide that comprises at least one C₆H₅NH— group; or in otherwords, an amide in which a hydrogen of the amido group is replaced by phenyl; or rather, an acyl derivative of aniline Non-limiting examples of an anilide fungicide include benalaxyl, benalaxyl-M, bixafen, boscalid, carboxin, fenhexamid, flutolanil, fluxapyroxad, isotianil, metalaxyl, metalaxyl-M, metsulfovax, ofurace, oxadixyl, oxycarboxin, penflufen, pyracarbolid, pyraziflumid, sedaxane, thifluzamide, tiadinil, and vanguard. In certain embodiments, the anilide fungicide utilized in the presently disclosed compositions and methods comprises at least one of fenhexamid, flutolanil, and boscalid.

An aromatic fungicide is a chemical fungicide that comprises at least one aromatic hydrocarbon (i.e., aryl) group. Non-limiting examples of an aromatic fungicide include biphenyl, chlorodinitronaphthalenes, chloroneb, chlorothalonil, cresol, dicloran, fenjuntong, hexachlorobenzene, pentachlorophenol, quintozene, sodium pentachlorophenoxide, tecnazene, thiocyanatodinitrobenzenes, and trichlorotrinitrobenzenes. In some embodiments, the aromatic fungicide utilized in the presently disclosed compositions and methods comprises chlorothalonil.

An aryl phenyl ketone fungicide is a chemical fungicide that comprises a phenyl (C₆H₅) and an additional aryl group each bound to a C═O. Non-limiting examples of an aryl phenyl ketone fungicide include metrafenone and pyriofenone. In some embodiments, the aryl phenyl ketone fungicide utilized in the presently disclosed compositions and methods comprises metrafenone.

An organophosphorus fungicide is an organic chemical fungicide that comprises phosphorus. Non-limiting examples of an organophosphorus fungicide include ampropylfos, ditalimfos, edifenphos, fosetyl, fosetyl-A1, hexylthiofos, inezin, iprobenfos, izopamfos, kejunlin, phosdiphen, pyrazophos, tolclofos-methyl, and triamiphos. In some embodiments, the organophosphorus fungicide utilized in the presently disclosed compositions and methods comprises fosetyl-A1.

Insecticides that can be used in the various methods and compositions disclosed herein include imidacloprid, beta-cyfluthrin, cyantraniliprole, diazinon, lambda-cyhalothrin, methiocarb, pymetrozine, pyrifluquinazon, spinetoram, spirotetramat, thiodicarb, and Ti-435, carbamates, sodium channel modulators/voltage dependent sodium channel blockers, pyrethroids such as DDT, oxadiazines such as indoxacarb, acetylcholine-receptor agonists/antagonists, acetylcholine-receptor-modulators, nicotine, bensultap, cartap, chloronicotyinyls such as acetamiprid, bifenthrin, clothianidin, dinotefuran, imidac loprid, nitenpyram, nithiazine, thiacloprid, and thiamethoxam, spinosyns such as spinosad, cyclodiene organochlorines such as camphechlor, chlordane, endosulfan, gamma-HCH, HCH, heptachlor, lindane, methoxychlor, fiproles such as acetoprole, ethiprole, fipronil, vaniliprole, chloride-channel, 6.1 mectins such as avermectin, emamectin, emamectin-benzoate, ivermectin, and milbemycin, juvenile-hormone mimics such as diofenolan, epofenonane, fenoxycarb, hydroprene, kinoprene, methoprene, pyriproxyfen, and triprene, ecdysone agonists/disruptors, diacylhydrazine, chromafenozide, halofenozide, methoxyfenozide, tebufenozide, chitin biosynthesis inhibitors, benzoylureas such as bistrifluron, chlorfluazuron, diflubenzuron, fluazuron, flucycloxuron, flufenoxuron, hexaflumuron, lufenuron, novaluron, noviflumuron, penfluron, teflubenzuron, triflumuron, buprofezin, cyromazine, oxidative phosphorylation inhibitors, ATP disruptors, diafenthiuron, organotins such as azocyclotin, cyhexatin, fenbutatin-oxide, pyrroles such as chlorfenapyr, dinitrophenols such as binapacryl, dinobuton, dinocap, DNOC, site-I electron transport inhibitors, METI's such as fenazaquin, fenpyroximate, pyrimidifen, pyridaben, tebufenpyrad, tolfenpyrad, hydramethyinon, dicofol, rotenone, acequinocyl, fluacrypyrim, spirodiclofen, spiromesifen, tetramic acids, carboxamides such as flonicamid, octopaminergic agonists such as amitraz, magnesium-stimulated ATPase inhibitors such as propargite, BDCA's such as N2-[1,1-dimethyl-2-(methylsulfonyl)ethyl]-3-iodo-N1-[2-methyl-4-[1,2,2,2-tetrafluoro-1-(trifluoromethyl)ethyl]phenyl]-1,2-benzene, nereistoxin analogues such as thiocyclam hydrogen oxalate, and thiosultap sodium. In some embodiments, the insecticide used in the various methods and compositions disclosed herein is a neonicotinoid. Neonicotinoids include acetamiprid, chlothianidin, dinotefuran, imidacloprid, nitenpyram, thiochloprid, and thiamethoxam Preferably the insecticide is acetamiprid.

Nematicides that can be used in the various methods and compositions disclosed herein include, but are not limited to, acibenzolar-S-methyl, an avermectin (e.g., abamectin), carbamate nematicides (e.g., aldicarb, thiadicarb, carbofuran, carbosulfan, oxamyl, aldoxycarb, ethoprop, methomyl, benomyl, alanycarb), organophosphorus nematicides (e.g., phenamiphos (fenamiphos), fensulfothion, terbufos, fosthiazate, dimethoate, phosphocarb, dichlofenthion, isamidofos, fosthietan, isazofos ethoprophos, cadusafos, terbufos, chlorpyrifos, dichlofenthion, heterophos, isamidofos, mecarphon, phorate, thionazin, triazophos, diamidafos, fosthietan, phosphamidon), and certain fungicides, such as captan, thiophanate-methyl and thiabendazole.

In some embodiments, the chemical fungicide utilized in the presently disclosed compositions and methods comprises at least one of fenhexamid, flutriafol, propiconazole, tebuconazole, chlorothalonil, azoxystrobin, fluoxystrobin, trifloxystrobin, difenoconazole, propiconazole, tetraconazole, prothioconazole, pyraclostrobin, flutolanil, penflufen, metconazole, boscalid, fluoxastrobin, fosetyl-A1, and metrafenone.

In some cases, the combination of the chemical fungicide(s) and a recited bacterial or fungal strain of interest or an active variant thereof shows synergistic activity where the fungicidal activity of the mixture of the two components exceeds that expected from their simple additive effect. The term “synergistic” refers to a particular phenomenon that occurs when the observed fungicidal effect of a mixture of active ingredients is unexpectedly greater than might be expected from the sum of the observed fungicidal effects of the active ingredients administered separately. Synergy may be calculated in various ways, generally based on fungicide concentrations that produce a defined end point in measured fungal growth, or in measured or otherwise evaluated effects resulting from the fungal growth. Examples of such measurements or evaluated effects include colony diameter, percentage germination, weight loss of an infected plant or plant part, softening or weakening of an infected plant or plant part, and estimations of fungal infection based on coverage and density of fungal growth. Any of these and other parameters can be enumerated using an instrument and/or evaluated manually or visually and assigned to linear or non-linear rating scales.

Methods that may be used to calculate synergy are known in the art and include those described by Y. Levy, M. Benderly, Y. Cohen, U. Gisi, and D. Bassand (“The Joint Action of Fungicides in Mixtures: Comparison of Two Methods for Synergy Calculation”, 1986, Bulletin OEPP, 16, 651-657), by F. C. Kull, P. C. Eisman, H. D. Sylwestrowicz, and R. L. Mayer (“Mixtures of Quaternary Ammonium Compounds and Long-chain Fatty Acids as Antifungal Agents”, 1961, Applied Microbiology, 9, 538-541), and by R. S. Colby (“Calculating Synergistic and Antagonistic Responses of Herbicide Combinations”, 1967, Weeds 15, 20-22), each of which is incorporated by reference in its entirety.

### IV. Formulations

The compositions comprising one or more chemical fungicides and/or one or more of the bacterial or fungal strains recited herein, or an active variant thereof, can further comprise an agriculturally acceptable carrier. The term “agriculturally acceptable carrier” is intended to include any material that facilitates application of a composition to the intended subject (e.g., a plant or plant part susceptible to a fungal plant disease of interest (e.g., Asian Soybean Rust (ASR)). Carriers used in compositions for application to plants and plant parts are preferably non-phytotoxic or only mildly phytotoxic. A suitable carrier may be a solid, liquid or gas depending on the desired formulation. In one embodiment, carriers include polar or non-polar liquid carriers such as water, mineral oils and vegetable oils. Additional carriers are disclosed elsewhere herein.

The chemical fungicide(s) and/or one or more of the bacterial or fungal strains recited herein or an active variant thereof, can be formulated as a cell paste, wettable powders, a cell pellet, dusts, granules, a slurry, a dry powder, aqueous or oil based liquid products, and the like. Such formulations will comprise one or more chemical fungicides and/or a recited bacterial or fungal strain of interest or an active variant thereof, in addition to carriers and other agents. The formulations can be used in a variety of methods as disclosed elsewhere herein.

The chemical fungicide(s) and/or one or more of the bacterial strains recited herein or the active variants thereof can be formulated to include at least one or more of an extender, a solvent, spontaneity promoter, carrier, emulsifier, dispersant, frost protectant, thickener, and/or adjuvant. In some embodiments, the extender solvent, spontaneity promoter, carrier, emulsifier, dispersant, frost protectant, thickener, and/or adjuvant is non-natural or synthetic.

Examples of typical formulations include water-soluble liquids (SL), emulsifiable concentrates (EC), emulsions in water (EW), suspension concentrates (SC, SE, FS, OD), water-dispersible granules (WG), granules (GR) and capsule concentrates (CS); these and other possible types of formulations are described, for example, by Crop Life International and in Pesticide Specifications, Manual on development and use of FAO and WHO specifications for pesticides, FAO Plant Production and Protection Papers—173, prepared by the FAO/WHO Joint Meeting on Pesticide Specifications, 2004, ISBN: 9251048576. The formulations may comprise additional active agrochemical compounds other than the one or more chemical fungicides and/or one or more of the bacterial strains recited herein or an active variant thereof.

The formulations or application forms of the chemical fungicide(s) and/or a bacterial strain or a fungal strain recited herein, or an active variant thereof, can comprise, but are not limited to, auxiliaries, such as extenders, solvents, spontaneity promoters, carriers, emulsifiers, dispersants, frost protectants, biocides, solid carriers, surfactants, thickeners and/or other auxiliaries, such as adjuvants. An adjuvant in this context is a component which enhances the biological effect of the formulation, without the component itself having a biological effect. Examples of adjuvants are agents which promote the retention, spreading, attachment to the leaf surface, or penetration.

Non-limiting extenders are, for example, water, polar and nonpolar organic chemical liquids, for example from the classes of the aromatic and non-aromatic hydrocarbons (such as paraffins, alkyl benzenes, alkylnaphthalenes, chlorobenzenes), the alcohols and polyols (which, if appropriate, may also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulphones and sulphoxides (such as dimethyl sulphoxide). If the extender used is water, it is also possible to employ, for example, organic solvents as auxiliary solvents. Essentially, non-limiting liquid solvents are: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and also their ethers and esters, ketones such as acetone, methyl ethyl ketone, methyl isobutyl ketone or cyclohexanone, strongly polar solvents such as dimethylformamide and dimethyl sulphoxide, and also water. In principle it is possible to use any suitable solvent. Non-limiting solvents are, for example, aromatic hydrocarbons, such as xylene, toluene or alkylnaphthalenes, for example, chlorinated aromatic or aliphatic hydrocarbons, such as chlorobenzene, chloroethylene or methylene chloride, for example, aliphatic hydrocarbons, such as cyclohexane, for example, paraffins, petroleum fractions, mineral and vegetable oils, alcohols, such as methanol, ethanol, isopropanol, butanol or glycol, for example, and also their ethers and esters, ketones such as acetone, methyl ethyl ketone, methyl isobutyl ketone or cyclohexanone, for example, strongly polar solvents, such as dimethyl sulphoxide, and water.

Non-limiting examples of suitable carriers include, for example, ammonium salts and ground natural minerals such as kaolins, clays, talc, chalk, quartz, attapulgite, montmorillonite or diatomaceous earth, and ground synthetic minerals, such as finely divided silica, alumina and natural or synthetic silicates, resins, waxes and/or solid fertilizers. Mixtures of such carriers may likewise be used. Carriers suitable for granules include the following: for example, crushed and fractionated natural minerals such as calcite, marble, pumice, sepiolite, dolomite, and also synthetic granules of inorganic and organic meals, and also granules of organic material such as sawdust, paper, coconut shells, maize cobs, and tobacco stalks.

Liquefied gaseous extenders or solvents may also be used. Non-limiting examples are those extenders or carriers which at standard temperature and under standard pressure are gaseous, examples being aerosol propellants, such as halogenated hydrocarbons, and also butane, propane, nitrogen and carbon dioxide. Examples of emulsifiers and/or foam-formers, dispersants or wetting agents having ionic or nonionic properties, or mixtures of these surface-active substances, are salts of polyacrylic acid, salts of lignosulphonic acid, salts of phenolsulphonic acid or naphthalenesulphonic acid, polycondensates of ethylene oxide with fatty alcohols or with fatty acids or with fatty amines, with substituted phenols (preferably alkylphenols or arylphenols), salts of sulphosuccinic esters, taurine derivatives (preferably alkylta urates), phosphoric esters of polyethoxylated alcohols or phenols, fatty acid esters of polyols, and derivatives of the compounds containing sulphates, sulphonates and phosphates, examples being alkylaryl polyglycol ethers, alkylsulphonates, alkyl sulphates, arylsulphonates, protein hydrolysates, lignin-sulphite waste liquors and methylcellulose. The presence of a surface-active substance is advantageous if one of the active compounds and/or one of the inert carriers is not soluble in water and if application takes place in water.

Further auxiliaries that may be present in the formulations and in the application forms derived from them include colorants such as inorganic pigments, examples being iron oxide, titanium oxide, Prussian Blue, and organic dyes, such as alizarin dyes, azo dyes and metal phthalocyanine dyes, and nutrients and trace nutrients, such as salts of iron, manganese, boron, copper, cobalt, molybdenum, and zinc.

Stabilizers, such as low-temperature stabilizers, preservatives, antioxidants, light stabilizers or other agents which improve chemical and/or physical stability may also be present. Additionally present may be foam-formers or defoamers.

Furthermore, the formulations and application forms derived from them may also comprise, as additional auxiliaries, stickers such as carboxymethylcellulose, natural and synthetic polymers in powder, granule or latex form, such as gum arabic, polyvinyl alcohol, polyvinyl acetate, and also natural phospholipids, such as cephalins and lecithins, and synthetic phospholipids. Further possible auxiliaries include mineral and vegetable oils.

There may possibly be further auxiliaries present in the formulations and the application forms derived from them. Examples of such additives include fragrances, protective colloids, binders, adhesives, thickeners, thixotropic substances, penetrants, retention promoters, stabilizers, sequestrants, complexing agents, humectants and spreaders. Generally speaking, the active compounds may be combined with any solid or liquid additive commonly used for formulation purposes.

Suitable retention promoters include all those substances which reduce the dynamic surface tension, such as dioctyl sulphosuccinate, or increase the viscoelasticity, such as hydroxypropylguar polymers, for example.

Suitable penetrants in the present context include all those substances which are typically used in order to enhance the penetration of active agrochemical compounds into plants. Penetrants in this context are defined in that, from the (generally aqueous) application liquid and/or from the spray coating, they are able to penetrate the cuticle of the plant and thereby increase the mobility of the active compounds in the cuticle. This property can be determined using the method described in the literature (Baur et al., 1997, Pesticide Science 51: 131-152). Examples include alcohol alkoxylates such as coconut fatty ethoxylate (10) or isotridecyl ethoxylate (12), fatty acid esters such as rapeseed or soybean oil methyl esters, fatty amine alkoxylates such as tallowamine ethoxylate (15), or ammonium and/or phosphonium salts such as ammonium sulphate or diammonium hydrogen phosphate, for example.

The various compositions and formulations disclosed herein can comprise an amount of a recited bacterial or fungal strain of interest or active variant thereof. Such an amount can comprise a concentration of the bacterial strain of at least about 10³ to about 10¹¹, at least about 10³ CFU/gram to about 10¹¹ CFU/gram, about 10³ CFU/gram to about 10¹⁰ CFU/gram, about 10³ CFU/gram to about 10¹² CFU/gram, about 10³ CFU/gram to about 10⁶ CFU/gram, about 10³ CFU/gram to about 10⁵ CFU/gram, about 10³ CFU/gram to about 10⁴ CFU/gram, about 10⁴ CFU/gram to about 10⁵ CFU/gram, about 10⁶ CFU/gram to about 10⁷ CFU/gram, about 10⁷ CFU/gram to about 10⁸ CFU/gram, about 10⁸ CFU/gram to about 10⁹ CFU/gram, about 10⁹ CFU/gram to about 10¹⁰ CFU/gram, about 10¹⁰ CFU/gram to about 10¹¹ CFU/gram, or about 10¹¹ CFU/gram to about 10¹² CFU/gram. In other embodiments, the concentration of the bacterial strain comprises at least about 10³ CFU/gram, at least about 10⁴ CFU/gram, at least about 10⁵ CFU/gram, at least about 10⁶ CFU/gram, at least about 10⁷ CFU/gram, at least about 10⁸ CFU/gram, at least about 10⁹ CFU/gram, at least about 10¹⁰ CFU/gram, at least about 10¹¹ CFU/gram, or at least about 10¹² CFU/gram. In particular embodiments, the concentration of the bacterial strain comprises at least about 5×10¹⁰ CFU/gram. Such concentrations of the bacterial strain can occur in any formulation type of interest, including, for example in a liquid formulation, a wettable power, spray dried formulation, wettable granule, freeze dried formulation, or in a cell paste.

In some embodiments, the chemical fungicide(s) and/or a recited bacterial or fungal strain of interest or active variant thereof, can occur in a liquid formulation. In liquid formulations, the amount of the bacterial strain can comprise a concentration of at least about 10³ to about 10¹¹ CFU/mL, at least about 10³ CFU/mL to about 10¹¹ CFU/mL, about 10³ CFU/mL to about 10¹⁰ CFU/mL, about 10³ CFU/mL to about 10¹² CFU/mL, about 10³ CFU/mL to about 10⁶ CFU/mL, about 10³ CFU/mL to about 10⁵ CFU/mL, about 10³ CFU/mL to about 10⁴ CFU/mL, about 10⁴ CFU/mL to about 10⁵ CFU/mL, about 10⁵ CFU/mL to about 10⁶ CFU/mL, about 10⁶ CFU/mL to about 10⁷ CFU/mL, about 10⁷ CFU/mL to about 10⁸ CFU/mL, about 10⁸ CFU/mL to about 10⁹ CFU/mL, about 10⁹ CFU/mL to about 10¹⁰ CFU/mL, about 10¹⁰ CFU/mL to about 10¹¹ CFU/mL, or about 10¹¹ CFU/mL to about 10¹² CFU/mL or at least about 10⁴ CFU/mL, at least about 10⁵ CFU/mL, at least about 10⁶ CFU/mL, at least about 10⁷ CFU/mL, at least about 10⁸ CFU/mL, at least about 10⁹ CFU/mL, at least about 10¹⁰ CFU/mL, at least about 10¹¹ CFU/mL, at least about 10¹² CFU/mL.

Dry formulations, such as cell pastes, wettable powders, and spray dried formulations, can comprise chemical fungicide(s) and/or a recited bacterial or fungal strain of interest or active variant thereof. The amount of the bacterial strain can comprise a concentration of at least about 10³ CFU/gram to about 10¹¹ CFU/gram, at least about 10⁴ CFU/gram to about 10¹¹ CFU/gram, about 10⁷ CFU/gram to about 10¹⁰ CFU/gram, about 10⁷ CFU/gram to about 10¹¹ CFU/gram, about 10⁶ CFU/gram to about 10¹⁰ CFU/gram, about 10⁶ CFU/gram to about 10¹¹ CFU/gram, about 10³ CFU/gram to about 10¹⁰ CFU/gram, about 10³ CFU/gram to about 10¹⁰ CFU/gram, about 10³ CFU/gram to about 10¹² CFU/gram, about 10³ CFU/gram to about 10⁴ CFU/gram, about 10⁴ CFU/gram to about 10⁵ CFU/gram, about 10⁵ CFU/gram to about 10⁶ CFU/gram, about 10⁶ CFU/gram to about 10⁷ CFU/gram, about 10⁷ CFU/gram to about 10⁸ CFU/gram, about 10⁸ CFU/gram to about 10⁹ CFU/gram, about 10⁹ CFU/gram to about 10¹⁰ CFU/gram, about 10¹⁰ CFU/gram to about 10¹¹ CFU/gram, or about 10¹¹ CFU/gram to about 10¹² CFU/gram. In some embodiments, the concentration of the bacterial strain comprises at least about 10³ CFU/gram, at least about 10⁴ CFU/gram, at least about 10⁵ CFU/gram, at least about 10⁶ CFU/gram, at least about 10⁷ CFU/gram, at least about 10⁸ CFU/gram, at least about 10⁹ CFU/gram, at least about 10¹⁰ CFU/gram, at least about 10¹¹ CFU/gram, at least about 10¹² CFU/gram, or at least about 10¹³ CFU/gram. In particular embodiments, the concentration of the bacterial strain comprises at least about 5×10¹⁰ CFU/gram.

As used herein, a “cell paste” comprises a population of cells that has been centrifuged and/or filtered or otherwise concentrated.

Further provided is a coated seed which comprises a seed and a coating on the seed, wherein the coating comprises chemical fungicide(s) and/or a recited bacterial or fungal strain of interest or active variant thereof. In some embodiments, the bacterial strain or the active variant thereof is present on the seed at about 10⁵ CFU/seed to about 10⁷ CFU/seed, at about 10³ CFU/seed to about 10⁸ CFU/seed, at about 10³ CFU/seed to about 10⁵ CFU/seed, at about 10³ CFU/seed to about 10⁴ CFU/seed, at about 10⁴ CFU/seed to about 10⁵ CFU/seed, at about 10⁵ CFU/seed to about 10⁶ CFU/seed, at about 10⁶ CFU/seed to about 10⁷ CFU/seed, or at about 10⁷ CFU/seed to about 10⁸ CFU/seed. Various plants of interest are disclosed elsewhere herein.

In particular embodiments, seeds are provided which comprise a heterolous coating on the seed, wherein the heterologous coating comprises chemical fungicide(s) and/or a recited bacterial or fungal strain of interest or active variant thereof, wherein the bacterial strain or the active variant thereof is present on the seed at about 10³ CFU/seed to about 10⁷ CFU/seed, at about 10⁴ CFU/seed to about 10⁸ CFU/seed, at about 10³ CFU/seed to about 10⁴ CFU/seed, at about 10⁴ CFU/seed to about 10⁵ CFU/seed, at about 10⁵ CFU/seed to about 10⁶ CFU/seed, at about 10⁶ CFU/seed to about 10⁷ CFU/seed, or at about 10⁷ CFU/seed to about 10⁸ CFU/seed. As used herein, “heterologous” in reference to a coating can refer to a seed coating comprising chemical fungicide(s) and/or bacterial strain that is not found in nature on the seed, or, if found in nature on the seed, is substantially modified from its native form in composition and/or concentration by deliberate human intervention. In particular embodiments, “heterologous” in reference to a coating can refer to a seed coating comprising chemical fungicide(s) and/or a bacterial strain suspended in a solution in which the chemical fungicide(s) and/or bacterial strain are not naturally found. The suspension solution for heterologous coatings can be natural or non-natural and can provide the chemical fungicide(s) and/or bacterial strain with properties that the chemical fungicide and/or strain would not normally possess. For example, the suspension solution of a heterologous coating can permit the chemical fungicide(s) and/or bacterial strain to adhere to the seed in such as a manner that the chemical fungicide(s) and/or bacteria retain activity during seed storage and germination.

A seed coating can further comprise at least one nutrient, or at least one additional biocide (e.g., herbicide or pesticide). See, for example, US App Pub. 20040336049, 20140173979, and 20150033811.

The methods of the present invention include the following application methods, namely both of the at least one bacterial strain and the at least one pesticide described above may be formulated into a single, stable composition with an agriculturally acceptable shelf life (a “solo formulation”) or may be combined before or at the time of use (a “combined formulation”). The formulation may be a combination of at least one bacterial strain and at least one pesticide in a solo formulation, in a single “ready-mix” form, in a combined spray mixture composed from solo-formulations, such as a “tank mix”, and/or in a combined use of the single active ingredient when applied in a sequential manner, i.e. one after the other within a reasonably short period, such as a few hours or days, e.g. 2 hours to 7 days. The order of applying the composition of the invention may not be essential for working the present invention. The combination of the at least one bacterial strain and the at least one pesticide may be applied simultaneously or in consecutatively to a plant, its surroundings, its habitat, or storage space.

The various formulations disclosed herein can be stable for at least 30, 40, 50, 60, 70, 80, 90, 100, 125, 150, 200, 225, 250, 275, 300, 325, 350 days, 1.5 years, 2 years or longer. By stable is intended that the formulation retains an effective amount of pesticidal activity. In one embodiment, the stable formulation retains at least about 1%, about 10%, about 20%, about 30% about 40%, about 50%, about 60%, about 70%, about 80%, or about 90% of CFU/gram of a recited bacterial or fungal strain of interest or active variant thereof, in the formulation at a given storage time point when compared to the CFU/gram produced after immediate preparation of the formulation. In another embodiment, the stable formulation retains at least about 30% to 80%, about 50% to about 80%, about 60% to about 70%, about 70% to about 80%, about 40% to about 50%, about 50% to about 60%, about 60% to about 70% of pesticidal activity in the formulation at a given storage time point when compared to the pesticidal activity found in the formulation immediately after production. In another embodiment, the stable formulation at a given storage time point retains at least about 30%, 45%, 50%, 60%, 70%, 80%, 90% of pesticidal activity when compared to the pesticidal activity found in the formulation immediately after production. In still another embodiment, the stable formation retains any combination of the viability and pesticidal activity noted above.

The formulations preferably comprise between 0.00000001% and 98% by weight of active compound(s) or, with particular preference, between 0.01% and 95% by weight of active compound(s), more preferably between 0.5% and 90% by weight of active compound(s), based on the weight of the formulation.

The content of the active compound(s) of the application forms prepared from the formulations may vary within wide ranges. The active compound(s) concentration of the application forms may be situated typically between 0.00000001% and 95% by weight of active compound(s), preferably between 0.00001% and 1% by weight, based on the weight of the application form. Application takes place in a customary manner adapted to the application forms.

Moreover, one or more chemical pesticides and/or a recited bacterial or fungal strain of interest or active variant thereof can be mixed with an additional biocide, such as an additional fungicide, insecticide, or herbicide. In certain embodiments, the one or more chemical pesticides and/or a recited bacterial or fungal strain of interest or active variant thereof can be mixed with other biocontrol agents.

In specific embodiments, a recited bacterial or fungal strain of interest or active variant thereof is compatible with agricultural chemicals used to improve the performance of biocides. Such agricultural chemicals include safeners, surfactants, stickers, spreaders, UV protectants, and suspension and dispersal aids. Safeners are chemicals that improve or modify the performance of herbicides. Surfactants, spreaders, and stickers are chemicals included in agricultural spray preparations that change the mechanical properties of the spray (for example, by altering surface tension or improving leaf cuticle penetration). UV protectants improve the performance of agricultural biocides by reducing degradation by ultraviolet light. Suspension and dispersal aids improve the performance of biocides by altering their behavior in a spray tank. In instances where a recited bacterial or fungal strain of interest or active variant thereof is not compatible with an agricultural chemical of interest, if desired, methods can be undertaken to modify the bacterial strain to impart the compatibility of interest. Such methods to produce modified bacterial strains include both selection techniques and/or transformation techniques.

Non-limiting examples of compounds and compositions that can be added to the formulation, include but are not limited to, Acetyl tributyl citrate [Citric acid, 2-(acetyloxy)-, tributyl ester]; Agar; Almond hulls; Almond shells; alpha-Cyclodextrin; Aluminatesilicate; Aluminum magnesium silicate [Silicic acid, aluminum magnesium salt]; Aluminum potassium sodium silicate [Silicic acid, aluminum potassium sodium salt]; Aluminum silicate; Aluminum sodium silicate [Silicic acid, aluminum sodium salt]; Aluminum sodium silicate (1:1:1)[Silicic acid (H4SiO4), aluminum sodium salt (1:1:1)]; Ammonium benzoate [Benzoic acid, ammonium salt]; Ammonium stearate [Octadecanoic acid, ammonium salt]; Amylopectin, acid-hydrolyzed, 1-octenylbutanedioate; Amylopectin, hydrogen 1-octadecenylbutanedioate; Animal glue; Ascorbyl palmitate; Attapulgite-type clay; Beeswax; Bentonite; Bentonite, sodian; beta-Cyclodextrin; Bone meal; Bran; Bread crumbs; (+)-Butyl lactate; [Lactic acid, n-butyl ester, (S)]; Butyl lactate [Lactic acid, n-butyl ester]; Butyl stearate [Octadecanoic acid, butyl ester]; Calcareous shale; Calcite (Ca(Co₃)); Calcium acetate; Calcium acetate monohydrate [Acetic acid, calcium salt, monohydrate]; Calcium benzoate [Benzoic acid, calcium salt]; Calcium carbonate; Calcium citrate [Citric acid, calcium salt]; Calcium octanoate; Calcium oxide silicate (Ca₃O(SiO₄)); Calcium silicate [Silicic acid, calcium salt]; Calcium stearate [Octadecanoic acid, calcium salt]; Calcium sulfate; Calcium sulfate dehydrate; Calcium sulfate hemihydrate; Canary seed; Carbon; Carbon dioxide; Carboxymethyl cellulose [Cellulose, carboxymethyl ether]; Cardboard; Carnauba wax; Carob gum [Locust bean gum]; Carrageenan; Caseins; Castor oil; Castor oil, hydrogenated; Cat food; Cellulose; Cellulose acetate; Cellulose, mixture with cellulose carboxymethyl ether, sodium salt; Cellulose, pulp; Cellulose, regenerated; Cheese; Chlorophyll a; Chlorophyll b; Citrus meal; Citric acid; Citric acid, monohydrate; Citrus pectin; Citrus pulp; Clam shells; Cocoa; Cocoa shell flour; Cocoa shells; Cod-liver oil; Coffee grounds; Cookies; Cork; Corn cobs; Cotton; Cottonseed meal; Cracked wheat; Decanoic acid, monoester with 1,2,3-propanetriol; Dextrins; Diglyceryl monooleate [9-Octadecenoic acid, ester with 1,2,3-propanetriol]; Diglyceryl monostearate [9-Octadecanoic acid, monoester with xybis(propanediol)]; Dilaurin [Dodecanoic acid, diester with 1,2,3-propanetriol]; Dipalmitin [Hexadecanoic acid, diester with 1,2,3-propanetriol]; Dipotassium citrate [Citric acid, dipotassium salt]; Disodium citrate [Citric acid, disodium salt]; Disodium sulfate decahydrate; Diatomaceous earth (less than 1% crystalline silica); Dodecanoic acid, monoester with 1,2,3-propanetriol; Dolomite; Douglas fir bark; Egg shells; Eggs; (+)-Ethyl lactate [Lactic acid, ethyl ester, (S)]; Ethyl lactate [Lactic acid, ethyl ester]; Feldspar; Fish meal; Fish oil (not conforming to 40 CFR 180.950); Fuller's earth; Fumaric acid; gamma-Cyclodextrin; Gelatins; Gellan gum; Glue (as depolymd animal collagen); Glycerin [1,2,3-Propanetriol]; Glycerol monooleate [9-Octadecenoic acid (Z)-, 2,3-dihydroxypropyl ester]; Glyceryl dicaprylate [Octanoic acid, diester with 1,2,3-propanetriol]; Glyceryl dimyristate [Tetradecanoic acid, diester with 1,2,3-propanetriol]; Glyceryl dioleate [9-Octadecenoic acid (9Z)-, diester with 1,2,3-propanetriol]; Glyceryl distearate; Glyceryl monomyristate [Tetradecanoic acid, monoester with 1,2,3-propanetriol]; Glyceryl monooctanoate [Octanoic acid, monoester with 1,2,3-propanetriol]; Glyceryl monooleate [9-Octadecenoic acid (9Z)-, monoester with 1,2,3-propanetriol]; Glyceryl monostearate [Octadecanoic acid, monoester with 1,2,3-propanetriol]; Glyceryl stearate [Octadecanoic acid, ester with 1,2,3-propanetriol]; Granite; Graphite; Guar gum; Gum Arabic; Gum tragacanth; Gypsum; Hematite (Fe₂O₃); Humic acid; Hydrogenated cottonseed oil; Hydrogenated rapeseed oil; Hydrogenated soybean oil; Hydroxyethyl cellulose [Cellulose, 2-hydroxyethyl ether]; Hydroxypropyl cellulose [Cellulose, 2-hydroxypropyl ether]; Hydroxypropyl methyl cellulose [Cellulose, 2-hydroxypropyl methyl ether]; Iron magnesium oxide (Fe₂MgO₄); Iron oxide (Fe₂O₃); Iron oxide (Fe₂O₃); Iron oxide (Fe₃O₄); Iron oxide (FeO); Isopropyl alcohol [2-Propanol]; Isopropyl myristate; Kaolin; Lactose; Lactose monohydrate; Lanolin; Latex rubber; Lauric acid; Lecithins; Licorice extract; Lime (chemical) dolomitic; Limestone; Linseed oil; Magnesium carbonate [Carbonic acid, magnesium salt (1:1); Magnesium benzoate; Magnesium oxide; Magnesium oxide silicate (Mg₃O(Si₂O₅)₂), monohydrate; Magnesium silicate; Magnesium silicate hydrate; Magnesium silicon oxide (Mg₂Si₃O₈); Magnesium stearate [Octadecanoic acid, magnesium salt]; Magnesium sulfate; Magnesium sulfate heptahydrate; Malic acid; Malt extract; Malt flavor; Maltodextrin; Methylcellulose [Cellulose, methyl ether]; Mica; Mica-group minerals; Milk; N/A Millet seed; Mineral oil (U.S.P.); 1-Monolaurin [Dodecanoic acid, 2,3-dihydroxypropyl ester]; 1-Monomyristin [Tetradecanoic acid, 2,3-dihydroxypropyl ester]; Monomyristin [Decanoic acid, diester with 1,2,3-propanetriol]; Monopalmitin [Hexadecanoic acid, monoester with 1,2,3-propanetriol]; Monopotassium citrate [Citric acid, monopotassium salt; Monosodium citrate [Citric acid, monosodium salt]; Montmorillonite; Myristic acid; Nepheline syenite; Nitrogen; Nutria meat; Nylon; Octanoic acid, potassium salt; Octanoic acid, sodium salt; Oils, almond; Oils, wheat; Oleic acid; Oyster shells; Palm oil; Palm oil, hydrogenated; Palmitic acid [Hexadecanoic acid]; Paraffin wax; Peanut butter; Peanut shells; Peanuts; Peat moss; Pectin; Perlite; Perlite, expanded; Plaster of paris; Polyethylene; Polyglyceryl oleate; Polyglyceryl stearate; Potassium acetate [Acetic acid, potassium salt]; Potassium aluminum silicate, anhydrous; Potassium benzoate [Benzoic acid, potassium salt]; Potassium bicarbonate [Carbonic acid, monopotassium salt]; Potassium chloride; Potassium citrate [Citric acid, potassium salt]; Potassium humate [Humic acids, potassium salts]; Potassium myristate [Tetradecanoic acid, potassium salt]; Potassium oleate [9-Octadecenoic acid (9Z)-, potassium salt; Potassium ricinoleate [9-Octadecenoic acid, 12-hydroxy-, monopotassium salt, (9Z,12R)-]; Potassium sorbate [Sorbic acid, potassium salt]; Potassium stearate [Octadecanoic acid, potassium salt]; Potassium sulfate; Potassium sulfate [Sulfuric acid, monopotassium salt]; 1,2-Propylene carbonate [1,3-Dioxolan-2-one, 4-methyl-]; Pumice; Red cabbage color (expressed from edible red cabbage heads via a pressing process using only acidified water); Red cedar chips; Red dog flour; Rubber; Sawdust; Shale; Silica, amorphous, fumed (crystalline free); Silica, amorphous, precipated and gel; Silica (crystalline free); Silica gel; Silica gel, precipitated, crystalline-free; Silica, hydrate; Silica, vitreous; Silicic acid (H₂SiO₃), magnesium salt (1:1); Soap (The water soluble sodium or potassium salts of fatty acids produced by either the saponification of fats and oils, or the neutralization of fatty acid); Soapbark [Quillaja saponin]; Soapstone; Sodium acetate [Acetic acid, sodium salt]; Sodium alginate; Sodium benzoate [Benzoic acid, sodium salt]; Sodium bicarbonate; Sodium carboxymethyl cellulose [Cellulose, carboxymethyl ether, sodium salt]; Sodium chloride; Sodium citrate; Sodium humate [Humic acids, sodium salts]; Sodium oleate; Sodium ricinoleate [9-Octadecenoic acid, 12-hydroxy-, monosodium salt, (9Z,12R)-]; Sodium stearate [Octadecanoic acid, sodium salt]; Sodium sulfate; Sorbitol [D-glucitol]; Soy protein; Soya lecithins [Lecithins, soya]; Soybean hulls; Soybean meal; Soybean, flour; Stearic acid [Octadecanoic acid]; Sulfur; Syrups, hydrolyzed starch, hydrogenated; Tetragylceryl monooleate [9-Octadecenoic acid (9Z)-, monoester with tetraglycerol]; Tricalcium citrate [Citric acid, calcium salt (2:3)]; Triethyl citrate [Citric acid, triethyl ester; Tripotassium citrate [Citric acid, tripotassium salt]; Tripotassium citrate monohydrate [Citric acid, tripotassium salt, monohydrate]; Trisodium citrate [Citric acid, trisodium salt]; Trisodium citrate dehydrate [Citric acid, trisodium salt, dehydrate]; Trisodium citrate pentahydrate [Citric acid, trisodium salt, pentahydrate]; Ultramarine blue [C.I. Pigment Blue 29]; Urea; Vanillia; Vermiculite; Vinegar (maximum 8% acetic acid in solution); Vitamin C [L-Ascorbic acid]; Vitamin; Walnut flour; Walnut shells; Wheat; Wheat flour; Wheat germ oil; Whey; White mineral oil (petroleum); Wintergreen oil; Wollastonite (Ca(SiO3)); Wool; Xanthan gum; Yeast; Zeolites (excluding erionite (CAS Reg. No. 66733-21-9)); Zeolites, NaA; Zinc iron oxide; Zinc oxide (ZnO); and Zinc stearate [Octadecanoic acid, zinc salt].

### V. Methods of Use

A combination of one or more chemical fungicides and a recited bacterial or fungal strain of interest or active variant thereof can be employed with any plant species to control a fungal plant pathogen. In one non-limiting embodiment, a combination of one or more chemical fungicides and a recited bacterial or fungal strain of interest or active variant thereof can be employed with any plant species susceptible to a fungal plant disease. By “a plant susceptible to a fungal plant disease” is meant that the causative fungal pathogen(s) of the fungal plant disease are able to infect the plant.

Examples of plant species of interest include, but are not limited to, corn (Zea mays), Brassica sp. (e.g., B. napus, B. rapa, B. juncea), particularly those Brassica species useful as sources of seed oil, alfalfa (Medicago sativa), rice (Oryza sativa), rye (Secale cereale), Sorghum (Sorghum bicolor, Sorghum vulgare), millet (e.g., pearl millet (Pennisetum glaucum), proso millet (Panicum miliaceum), foxtail millet (Setaria italica), finger millet (Eleusine coracana)), sunflower (Helianthus annuus), safflower (Carthamus tinctorius), wheat (Triticum aestivum), soybean (Glycine max), tobacco (Nicotiana tabacum), potato (Solanum tuberosum), peanuts (Arachis hypogaea), cotton (Gossypium barbadense, Gossypium hirsutum), sweet potato (Ipomoea batatus), cassava (Manihot esculenta), coffee (Coffea spp.), coconut (Cocos nucifera), pineapple (Ananas comosus), Citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), grape (Vitus spp.), strawberry (Fragaria x ananassa), cherry (Prunus spp.), apple (Malus domestica), orange (Citrus x sinensis), cashew (Anacardium occidentale), Macadamia (Macadamia integrifolia), almond (Prunus amygdalus), sugar beets (Beta vulgaris), sugarcane (Saccharum spp.), oats, barley, vegetables, ornamentals, and conifers.

Vegetables include tomatoes (Lycopersicon esculentum), lettuce (e.g., Lactuca sativa), green beans (Phaseolus vulgaris), lima beans (Phaseolus limensis), peas (Lathyrus spp.), and members of the genus Cucumis such as cucumber (C. sativus), cantaloupe (C. cantalupensis), and musk melon (C. melo). Ornamentals include azalea (Rhododendron spp.), hydrangea (Macrophylla hydrangea), Hibiscus (Hibiscus rosasanensis), roses (Rosa spp.), tulips (Tulipa spp.), daffodils (Narcissus spp.), petunias (Petunia hybrida), carnation (Dianthus caryophyllus), poinsettia (Euphorbia pulcherrima), and Chrysanthemum.

Conifers that may be employed in practicing the present invention include, for example, pines such as loblolly pine (Pinus taeda), slash pine (Pinus elliotii), ponderosa pine (Pinus ponderosa), lodgepole pine (Pinus contorta), and Monterey pine (Pinus radiata); Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and Alaska yellow-cedar (Chamaecyparis nootkatensis). In specific embodiments, plants that can be employed in practicing the present invention are crop plants (for example, corn, alfalfa, sunflower, Brassica, soybean, cotton, safflower, peanut, Sorghum, wheat, millet, tobacco, etc.). In particular embodiments, the crop plant is a corn or soybean plant.

Other plants of interest include grain plants that provide seeds of interest, oil-seed plants, and leguminous plants. Seeds of interest include grain seeds, such as corn, wheat, barley, rice, Sorghum, rye, etc. Oil-seed plants include cotton, soybean, safflower, sunflower, Brassica, maize, alfalfa, palm, coconut, etc. Leguminous plants include beans, peas, and dry pulses. Beans include guar, locust bean, fenugreek, soybean, garden beans, cowpea, mungbean, lima bean, fava bean, lentils, chickpea, etc.

A. Non-Limiting Fungal Plant Pathogens

Examples of fungal plant diseases which can be treated or reduced or prevented with the presently disclosed compositions and methods include, but are not limited to, anthracnose, bacterial blights, bacterial canker, bacterial leaf blight, bacterial pustule, bacterial speck, bacterial spot, barn spot/frogeye leaf spot, berry blotch, bitter rot, black eye, black leg/bacterial soft rot, black root/crown rot, black scurf, black shank, black spot of roses, blue mold, bot rot/white rot, Botrytis blight, bottom rot, brooks spot, brown patch, brown rot, brown rot blossom blight, brown spot, cavity spot, charcoal rot, Citrus canker, coffee berry disease, collar rot, “damping off”, dollar spot, downy mildew, early blight, Eutypa, fire blight, flyspeck, fruit rot, Fusarium wilt, gray mold, greasy spot, gummy stem blight, head and leaf drop, late blight, leaf blight, leaf spots (e.g., angular leaf spot, gray leaf spot), melanose, mummy berry, neck rot, peach leaf curl, Phomopsis, pin rot complex, pink rot, pod and stem blights, postbloom fruit drop, powdery mildew, purple blotch, rice blast, root or crown diseases, root rot, rust (e.g., Asian soybean rust, cedar apple rust, coffee rust, common rust), rusty spot, scab (e.g., pecan scab), Sclerotinia, seedling blights, sheath spot/blight, shot hole, sigatoka, smut, sooty blotch disease complex, sour rot complex, Southern blight, stem rot, target spot, vine decline, walnut blight, and white mold, to name a few.

In specific embodiments, a combination of one or more chemical fungicides and/or a recited bacterial or fungal strain of interest or active variant thereof employed in the present invention targets one or more fungal plant pathogens. For example, a combination of one or more chemical fungicides and/or a recited bacterial or fungal strain of interest or active variant thereof can have antifungal activity against one, two, three, four, five, or more fungal pathogens and/or fungal diseases described herein.

Thus, the methods and compositions disclosed herein can be used to control one or more fungal pathogens. A fungal pathogen can be, but is not limited to, a fungus selected from the group consisting of Alternaria spp., Alternaria alternate, Alternaria solani, Aspergillus spp., Bipolaris maydis, Botryosphaeria dothidea, Botrytis spp., Botrytis cinerea, Bremia lactucae, Ceratobasidium spp., Cercospora spp., Cercospora nicotianae, Cercosporidium spp., Cladosprium caryigenum, Cochliobolus spp., Cochliobolus heterostrophus, Colletotrichum spp., Colletotrichum acutatum, Colletotrichum coffeanum, Colletotrichum graminicola, Diaporthe spp., Diaporthe citri, Didymella bryoniae, Diplocarpon rosae, Dreschlera spp., Elsinoe fawcetti, Entomosporium spp., Entyloma spp., Erisyphe spp., Erisyphe cichoracearum, Erisyphe graminis, Erisyphe (formerly Uncinula) necator, Erisyphe polygoni, Erwinia spp., Erwinia amylovora, Erwinia carotovora, Eutypa lata, Fusarium spp., Gloeosporium spp., Glomerella spp., Golovinomyces spp., Golovinomyces (Erisyphe) cichoracearum, Gymnosporangium juniperi-virginianae, Helminthosporium spp., Helminthosporium maydis, Hemileia vastatrix, Lanzia spp., Leveillula spp., Macrophomina phaseoli, Macrophomina phaseolina, Magnaporthe spp., Microsphaera diffusa, Moellerodiscus spp., Monilinia spp., Monilinia fructicola, Monilinia laxa, Monilinia vaccinia-corymbosi, Monosporascus cannonballus, Mycosphaerella citri, Mycosphaerella fijiensis, Mycosphaerella pomi, Myrothecium spp., Oidium spp., Oidiopsis spp., Olpidium spp., Peronospora spp., Peronospora mansherica, Pestalotia spp., Phayospora pachyrhizi, Phoma cucurbitacearum, Phomopsis spp., Phomopsis viticola, Phytophthora spp., Phytopthora infestans, Plasmopara viticola, Podosphaera spp., Podosphaera leucotricha, Pseudomonas spp., Pseudomonas syringae, Pseudomonas syringae pv. glycinea, Pseudomonas syringae pv. tomato, Pseudoperonospora spp., Puccinia spp., Puccinia pori, Puccinia sorghi, Pyricularia grisea, Pyricularia oryzae, Pythium spp., Ramularia spp., Rhizoctonia spp., Rhizoctonia solani, Sclerotinia spp., Sclerotinia sclerotiorum, Sclerotium spp., Sclerotium rolfsii, Sclerotium cepivorum, Septoria spp., Septoria glycines, Sphaceloma perseae, Sphaerotheca spp., Sphaerotheca macularis, Sphaerotheca pannosa, Taphrina deformans, Thanatephorus spp., Thielaviopsis basicola, Tilleha barclayana, Uromyces appendiculatus, Uromyces betae, Venturia spp., Verticillium spp., Wilsonomyces carpophilus, Xanthomonas spp., Xanthomonas arbicola pv. pruni, Xanthomonas campestris, Xanthomonas campestris pv. citri, Xanthomonas fragariae, and Zygophiala jamaicensis.

In further embodiments, a combination of one or more chemical fungicides and/or a recited pesticidal microbial strain or active variant thereof employed in the present invention controls at least one, two, three, four, five, or more fungal diseases selected from the group consisting of anthracnose, bacterial blights, bacterial canker, bacterial leaf blight, bacterial pustule, bacterial speck, bacterial spot, barn spot/frogeye leaf spot, berry blotch, bitter rot, black eye, black leg/bacterial soft rot, black root/crown rot, black scurf, black shank, black spot of roses, blue mold, bot rot/white rot, Botrytis blight, bottom rot, brooks spot, brown patch, brown rot, brown rot blossom blight, brown spot, cavity spot, charcoal rot, Citrus canker, coffee berry disease, collar rot, “damping off”, dollar spot, downy mildew, early blight, Eutypa, fire blight, flyspeck, fruit rot, Fusarium wilt, gray mold, greasy spot, gummy stem blight, head and leaf drop, late blight, leaf blight, leaf spots (e.g., angular leaf spot, gray leaf spot), melanose, mummy berry, neck rot, peach leaf curl, Phomopsis, pin rot complex, pink rot, pod and stem blights, postbloom fruit drop, powdery mildew, purple blotch, rice blast, root or crown diseases, root rot, rust (e.g., Asian soybean rust, cedar apple rust, coffee rust, common rust), rusty spot, scab (e.g., pecan scab), Sclerotinia, seedling blights, sheath spot/blight, shot hole, sigatoka, smut, sooty blotch disease complex, sour rot complex, Southern blight, stem rot, target spot, vine decline, walnut blight, and white mold. In further embodiments, a combination of one or more chemical fungicides and/or a recited bacterial or fungal strain of interest or active variant thereof employed in the present invention controls at least one, two, three, four, five, or more plant pathogens selected from the group consisting of Alternaria spp., Alternaria alternate, Alternaria solani, Aspergillus spp., Bipolaris maydis, Botryosphaeria dothidea, Botrytis spp., Botrytis cinerea, Bremia lactucae, Ceratobasidium spp., Cercospora spp., Cercospora nicotianae, Cercosporidium spp., Cladosprium caryigenum, Cochliobolus spp., Cochliobolus heterostrophus, Colletotrichum spp., Colletotrichum acutatum, Colletotrichum coffeanum, Colletotrichum graminicola, Diaporthe spp., Diaporthe citri, Didymella bryoniae, Diplocarpon rosae, Dreschlera spp., Elsinoe fawcetti, Entomosporium spp., Entyloma spp., Erisyphe spp., Erisyphe cichoracearum, Erisyphe graminis, Erisyphe (formerly Uncinula) necator, Erisyphe polygoni, Erwinia spp., Erwinia amylovora, Erwinia carotovora, Eutypa lata, Fusarium spp., Gloeosporium spp., Glomerella spp., Golovinomyces spp., Golovinomyces (Erisyphe) cichoracearum, Gymnosporangium juniperi-virginianae, Helminthosporium spp., Helminthosporium maydis, Hemileia vastatrix, Lanzia spp., Leveillula spp., Macrophomina phaseoli, Macrophomina phaseolina, Magnaporthe spp., Microsphaera diffusa, Moellerodiscus spp., Monilinia spp., Monilinia fructicola, Monilinia laxa, Monilinia vaccinia-corymbosi, Monosporascus cannonballus, Mycosphaerella citri, Mycosphaerella fijiensis, Mycosphaerella Myrothecium spp., Oidium spp., Oidiopsis spp., Olpidium spp., Peronospora spp., Peronospora mansherica, Pestalofia spp., Phayospora pachyrhizi, Phoma cucurbitacearum, Phomopsis spp., Phomopsis vificola, Phytophthora spp., Phytopthora infestans, Plasmopara vificola, Podosphaera spp., Podosphaera leucotricha, Pseudomonas spp., Pseudomonas syringae, Pseudomonas syringae pv. glycinea, Pseudomonas syringae pv. tomato, Pseudoperonospora spp., Puccinia spp., Puccinia pori, Puccinia sorghi, Pyricularia grisea, Pyricularia oryzae, Pythium spp., Ramularia spp., Rhizoctonia spp., Rhizoctonia solani, Sclerotinia spp., Sclerotinia sclerofiorum, Sclerotium spp., Sclerotium Sclerotium cepivorum, Septoria spp., Septoria glycines, Sphaceloma perseae, Sphaerotheca spp., Sphaerotheca macularis, Sphaerotheca pannosa, Taphrina deformans, Thanatephorus spp., Thielaviopsis basicola, Tillefia barclayana, Uromyces appendiculatus, Uromyces betae, Venturia spp., Verticillium spp., Wilsonomyces carpophilus, Xanthomonas spp., Xanthomonas arbicola pv. pruni, Xanthomonas campestris, Xanthomonas campestris pv. citri, Xanthomonas fragariae, and Zygophiala jamaicensis.

In specific embodiments, the pesticidal microbial strains provided herein are those that target one or more insect or insect pests. The term “insects” or “insect pests” as used herein refers to insects and other similar pests. The term “insect” encompasses eggs, larvae, juvenile and mature forms of insects. Insects can be targeted at any stage of development. For example, insects can be targeted after the first instar, during the second instar, third instar, fourth instar, fifth instar, or any other developmental or adult growth stage. As used herein, the term “instar” is used to denote the developmental stage of the larval or nymphal forms of insects. Insect pests include insects selected from the orders Coleoptera, Lepidoptera, Hemiptera, Diptera, Hymenoptera, Lepidoptera, Mallophaga, Homoptera, Hemiptera, Orthroptera, Thysanoptera, Trombidiformes, Dermaptera, Isoptera, Anoplura, Siphonaptera, Trichoptera, etc.

Insect pests of the order Coleoptera include, but are not limited to, Agriotes spp., Anthonomus spp., Atomaria linearis, Chaetocnema tibialis, Cosmopolites spp., Curculio spp., Dermestes spp., Epilachna spp., Eremnus spp., Lepfinotarsa decemlineata, Lissorhoptrus spp., Melolontha spp., Orycaephilus spp., Ofiorhynchus spp., Phlycfinus spp., Popillia spp., Psylliodes spp., Rhizopertha spp., Scarabeidae, Sitophilus spp., Sitotroga spp., Tenebrio spp., Tribolium spp., and Trogoderma spp. In specific embodiments, Coleoptera insects include, but are not limited to weevils from the families Anthribidae, Bruchidae, and Curculionidae (e.g., sweetpotato weevil (Cylas formicarius (Fabricius)), boll weevil (Anthonomus grandis Boheman), rice water weevil (Lissorhoptrus oryzophilus Kuschel), rice weevil (Sitophilus oryzae L.)); flea beetles, cucumber beetles, rootworms, leaf beetles, potato beetles, and leafminers in the family Chrysomelidae (e.g., Colorado potato beetle (Leptinotarsa decemlineata Say), Diabrofica spp. including western corn rootworm (Diabrofica virgifera virgifera LeConte)); chafers and other beetles from the family Scaribaeidae (e.g., Japanese beetle (Popillia japonica Newman) and European chafer (Rhizotrogus majalis Razoumowsky)); wireworms from the family Elateridae and bark beetles from the family Scolytidae.

As disclosed herein, insect pests include Coleoptera pests of the corn rootworm complex: Western corn rootworm, Diabrofica virgifera virgifera; northern corn rootworm, D. barberi; Southern corn rootworm or spotted cucumber beetle, Diabrofica undecimpunctata howardi; and the Mexican corn rootworm, D. virgifera zeae. In specific embodiments, the insect pest is Western corn rootworm, Diabrofica virgifera virgifera.

Insect pests that can be controlled with the compositions and methods disclosed herein further include insects of the order Lepidoptera, e.g. Achoroia grisella, Acleris gloverana, Acleris variana, Adoxophyes orana, Agrotis ipsilon, Alabama argillacea, Alsophila pometaria, Amyelois transitella, Anagasta kuehniella, Anarsia lineatella, Anisota senatoria, Antheraea pernyi, Anficarsia gemmatalis, Archips spp., Argyrotaenia spp., Athetis mindara, Bombyx mori, Bucculatrix thurberiella, Cadra cautella, Choristoneura sp., Cochylls hospes, Colias eurytheme, Corcyra cephalonica, Cydia latiferreanus, Cydia pomonella, Datana integerrima, Dendrolimus sibericus, Desmiafeneralis spp., Diaphania hyalinata, Diaphania nifidalis, Diatraea grandiosella, Diatraea saccharalis, Ennomos subsignaria, Eoreuma loftini, Esphestia elutella, Erannis Maria, Estigmene acrea, Eulia salubricola, Eupocoellia ambiguella, Eupoecilia ambiguella, Euproctis chrysorrhoea, Euxoa messoria, Galleria mellonella, Grapholita molesta, Harrisina americana, Helicoverpa subflexa, Helicoverpa zea, Heliothis virescens, Hemileuca oliviae, Homoeosoma electellum, Hyphanfia cunea, Keiferia lycopersicella, Lambdina fiscellaria fiscellaria, Lambdina fiscellaria lugubrosa, Leucoma salicis, Lobesia botrana, Loxostege sficficalis, Lymantria dispar, Macalla thyrisalis, Malacosoma spp., Mamestra brassicae, Mamestra configurata, Manduca quinquemaculata, Manduca sexta, Maruca testulalis, Melanchra picta, Operophtera brumata, Orgyia spp., Ostrinia nubilalis, Paleacrita vernata, Papilio cresphontes, Pectinophora gossypiella, Phryganidia californica, Phyllonorycter blancardella, Pieris napi, Pieris rapae, Plathypena scabra, Platynota flouendana, Platynota stultana, Platypfilia carduidactyla, Plodia interpunctella, Plutella xylostella, Ponfia protodice, Pseudalefia umpuncta, Pseudoplasia includens, Sabulodes aegrotata, Schizura concinna, Sitotroga cerealella, Spilonta ocellana, Spodoptera spp., Thaurnstopoea pityocampa, Tinsola bisselliella, Trichoplusia hi, Tuta absoluta, Udea rubigalis, Xylomyges curiails, and Yponomeuta padella.

The methods and compositions provided herein can also be used against insect pests of the order Hemiptera including, but not limited to, Lygus spp., including Lygus spp. including Lygus hesperus, Lygus lineolaris, Lygus pratensis, Lygus rugulipennis, and Lygus pabulinus, Calocoris norvegicus, Orthops compestris, Plesiocoris rugicollis, Cyrtopeltis modestus, Cyrtopeltis notatus, Spanagonicus albofasciatus, Diaphnocoris chlorinonis, Labopidicola allii, Pseudatomoscelis seriatus, Adelphocoris rapidus, Poecilocapsus lineatus, Blissus leucopterus, Nysius spp. including Nysius ericae and Nysius raphanus, Nezara viridula, Acrosternum hilare, Euschistus spp. including Euschistus servus and Euschistus heros, Dichelops spp. including Dichelops melacantus and Dichelops furcatus, Halyomorpha halys, Lipaphis erysimi, Aphis gossypii, Macrosiphum avenae, Myzus persicae, Acyrthosiphon pisum, Aphidoidea spp, Eurygaster spp., Coreidae spp., Pyrrhocoridae spp., Blostomatidae spp., Reduviidae spp., Cimicidae spp. Aleurocanthus woglumi, Aleyrodes proletella, Bemisia spp. including Bemisia argentifolii and Bemisia tabaci, and Trialeurodes vaporariorum

The methods and compositions provided herein can also be used against insect pests of the order Thysenoptera including, but not limited to, Thrips species, including Frankliniella spp., for example Western Flower Thrips (Frankliniella occidentalis (Pergande)); Thrips spp., for example Thrips tabaci; Scirtothrips spp., for example Scirtothrips dorsalis; Klambothrips spp., for example Klambothrips myopori; Echinothrips spp., for example Echinothrips americanus; and Megalurothrips spp., for example Megalurothrips usitatus.

The methods and compositions provided herein can also be used against insect pests of the order Trombidiformes including, but are not limited to, plant feeding mites, including six-spooted spider mite (Eutetranychus sexmaculatus), Texas Citrus mite (Eutetranychus banksi), Citrus red mite (Panonychus citri), European red mite (Panonychus ulmi), McDaniel mite (Tetranychus mcdanieli), Pacific spider mite (Tetranychus pacificus), Strawberry spider mite (Tetranychus urticae), Spruce spider mite (Oligonychus ununguis), Sugi spider mite (Oligonychus nondonensisi), and Tetranychus evansi.

Insect pests of interest also include Araecerus fasciculatus, coffee bean weevil; Acanthoscelides obtectus, bean weevil; Bruchus rufmanus, broadbean weevil; Bruchus pisorum, pea weevil; Zabrotes subfasciatus, Mexican bean weevil; Diabrotica balteata, banded cucumber beetle; Cerotoma trifurcata, bean leaf beetle; Diabrotica virgifera, Mexican corn rootworm; Epitrix cucumeris, potato flea beetle; Chaetocnema confinis, sweet potato flea beetle; Hypera postica, alfalfa weevil; Anthonomus quadrigibbus, apple Curculio; Sternechus paludatus, bean stalk weevil; Hypera brunnipennis, Egyptian alfalfa weevil; Sitophilus granaries, granary weevil; Craponius inaequalis, grape Curculio; Sitophilus zeamais, maize weevil; Conotrachelus nenuphar, plum Curculio; Euscepes postfaciatus, West Indian sweet potato weevil; Maladera castanea, Asiatic garden beetle; Rhizotrogus majalis, European chafer; Macrodactylus subspinosus, rose chafer; Tribolium confusum, confused flour beetle; Tenebrio obscurus, dark mealworm; Tribolium castaneum, red flour beetle; Tenebrio molitor, yellow mealworm and the family Drosophilidae including Drosophila suzukii, spotted wing Drosophila.

Insect pests also include insects selected from the orders Diptera, Hymenoptera, Mallophaga, Homoptera, Hemiptera, Orthroptera, Thysanoptera, Dermaptera, Isoptera, Anoplura, Siphonaptera, and Trichoptera. Insect pests of the present invention can further include those of the order Acari including, but not limited to, mites and ticks. In specific embodiments, coleopteran pests include Western corn rootworm, Colorado potato beetle, and/or sweet potato weevil.

Insect pests that can be controlled with the compositions and methods of the invention for the major crops include, but are not limited to: Maize: Ostrinia nubilalis, European corn borer; Agrotis ipsilon, black cutworm; Helicoverpa zeae, corn earworm; Spodoptera frugiperda, fall armyworm; Diatraea grandiosella, southwestern corn borer; Elasmopalpus lignosellus, lesser cornstalk borer; Diatraea saccharalis, surgarcane borer; western corn rootworm, e.g., Diabrotica virgifera virgifera; northern corn rootworm, e.g., Diabrotica longicomis barberi; southern corn rootworm, e.g., Diabrotica undecimpunctata howardi; Melanotus spp., wireworms; Cyclocephala borealis, northern masked chafer (white grub); Cyclocephala immaculata, southern masked chafer (white grub); Popillia japonica, Japanese beetle; Chaetocnema pulicaria, corn flea beetle; Sphenophorus maidis, maize billbug; Rhopalosiphum maidis, corn leaf aphid; Anuraphis maidiradicis, corn root aphid; Myzus persicae, green peach aphid; Nezara viridula, southern green stink bug; Blissus leucopterus leucopterus, chinch bug; Melanoplus femurrubrum, redlegged grasshopper; Melanoplus sanguinipes, migratory grasshopper; Hylemya platura, seedcorn maggot; Agromyza parvicornis, corn blotch leafminer; Anaphothrips obscrurus, grass Thrips; Solenopsis milesta, thief ant; Tetranychus urticae, two spotted spider mite; Sorghum: Chilo partellus, Sorghum borer; Spodoptera frugiperda, fall armyworm; Helicoverpa zea, corn earworm; Elasmopalpus lignosellus, lesser cornstalk borer; Feltia subterranea, granulate cutworm; Phyllophaga crinita, white grub; Eleodes, Conoderus, and Aeolus spp., wireworms; Oulema melanopus, cereal leaf beetle; Chaetocnema pulicaria, corn flea beetle; Sphenophorus maidis, maize billbug; Rhopalosiphum maidis; corn leaf aphid; Sipha flava, yellow sugarcane aphid; chinch bug, e.g., Blissus leucopterus leucopterus; Contarinia sorghicola, Sorghum midge; Tetranychus cinnabarinus, carmine spider mite; Tetranychus urticae, two-spotted spider mite; Wheat: Pseudaletia unipunctata, armyworm; Spodoptera frugiperda, fall armyworm; Elasmopalpus lignosellus, lesser cornstalk borer; Agrotis orthogonia, pale western cutworm; Elasmopalpus lignosellus, lesser cornstalk borer; Oulema melanopus, cereal leaf beetle; Hypera punctata, clover leaf weevil; southern corn rootworm, e.g., Diabrotica undecimpunctata howardi; Russian wheat aphid; Schizaphis graminum, greenbug; Macrosiphum avenae, English grain aphid; Melanoplus femurrubrum, redlegged grasshopper; Melanoplus differentialis, differential grasshopper; Melanoplus sanguinipes, migratory grasshopper; Mayetiola destructor, Hessian fly; Sitodiplosis mosellana, wheat midge; Meromyza americana, wheat stem maggot; Hylemya coarctata, wheat bulb fly; Frankliniella fusca, tobacco Thrips; Cephus cinctus, wheat stem sawfly; Aceria tulipae, wheat curl mite; Sunflower: Cylindrocupturus adspersus, sunflower stem weevil; Smicronyx fulus, red sunflower seed weevil; Smicronyx sordidus, gray sunflower seed weevil; Suleima helianthana, sunflower bud moth; Homoeosoma electellum, sunflower moth; Zygogramma exclamationis, sunflower beetle; Bothyrus gibbosus, carrot beetle; Neolasioptera murtfeldtiana, sunflower seed midge; Cotton: Heliothis virescens, tobacco budworm; Helicoverpa zea, cotton bollworm; Spodoptera exigua, beet armyworm; Pectinophora gossypiella, pink bollworm; boll weevil, e.g., Anthonomus grandis; Aphis gossypii, cotton aphid; Pseudatomoscelis seriatus, cotton fleahopper; Trialeurodes abutilonea, banded winged whitefly; Lygus lineolaris, tarnished plant bug; Melanoplus femurrubrum, redlegged grasshopper; Melanoplus differentialis, differential grasshopper; Thrips tabaci, onion Thrips; Frankliniella fusca, tobacco Thrips; Tetranychus cinnabarinus, carmine spider mite; Tetranychus urticae, two-spotted spider mite; Rice: Diatraea saccharalis, sugarcane borer; Spodoptera frugiperda, fall armyworm; Helicoverpa zea, corn earworm; Colaspis brunnea, grape Colaspis; Lissorhoptrus oryzophilus, rice water weevil; Sitophilus oryzae, rice weevil; Nephotettix nigropictus, rice leafhopper; chinch bug, e.g., Blissus leucopterus leucopterus; Acrosternum hilare, green stink bug; Soybean: Pseudoplusia includens, soybean looper; Anficarsia gemmatalis, velvetbean caterpillar; Plathypena scabra, green cloverworm; Ostrinia nubilalis, European corn borer; Agrotis ipsilon, black cutworm; Spodoptera exigua, beet armyworm; Heliothis virescens, tobacco budworm; Helicoverpa zea, cotton bollworm; Epilachna varivestis, Mexican bean beetle; Myzus persicae, green peach aphid; Empoasca fabae, potato leafhopper; Acrosternum hilare, green stink bug; Melanoplus femurrubrum, redlegged grasshopper; Melanoplus differentialis, differential grasshopper; Hylemya platura, seedcorn maggot; Sericothrips variabilis, soybean Thrips; Thrips tabaci, onion Thrips; Tetranychus turkestani, strawberry spider mite; Tetranychus urticae, two-spotted spider mite; Barley: Ostrinia nubilalis, European corn borer; Agrotis ipsilon, black cutworm; Schizaphis graminum, greenbug; chinch bug, e.g., Blissus leucopterus leucopterus; Acrosternum hilare, green stink bug; Euschistus servus, brown stink bug; Jylemya platura, seedcorn maggot; Mayetiola destructor, Hessian fly; Petrobia latens, brown wheat mite; Oil Seed Rape: Vrevicoryne brassicae, cabbage aphid; Phyllotreta cruciferae, crucifer flea beetle; Phyllotreta striolata, striped flea beetle; Phyllotreta nemorum, striped turnip flea beetle; Meligethes aeneus, rapeseed beetle; and the pollen beetles Meligethes rufimanus, Meligethes nigrescens, Meligethes canadianus, and Meligethes viridescens; Potato: Leptinotarsa decemlineata, Colorado potato beetle; Sweet potato: Spartocera batatas, giant sweet potato bug; Charidotella (=Metriona) bicolor, golden tortoise beetle; Cylas formicarius, sweet potato weevil; Cylas puncficollis, sweet potato weevil; Cylas brunneus, sweet potato weevil Naupactus (=Graphognathus) spp., whitefringed beetles; Conoderus rudis, wireworm; Conoderus scissus, peanut wireworm; Blosyrus spp., rough sweet potato weevil; Acraea acerata, sweet potato butterfly; Agrius convolvuli, sweet potato hornworm; Spodoptera exigua, armyworm; Spodoptera eridania, armyworm; Synanthedon spp., clearwing moth; Hairiness and eriophyid mites; Euscepes postfasciatus, West Indian sweetpotato weevil; Peloropus batatae, Peloropus weevil; Omphisia anastomasalis, sweet potato stemborer, and white grubs—larvae of various species of scarabid beetles.

In some embodiments, the compositions and methods provided herein control nematode plant pests. Nematodes include parasitic nematodes such as root-knot, cyst, and lesion nematodes, including of the species Meloidogyne such as the Southern Root-Knot nematode (Meloidogyne incognita), Javanese Root-Knot nematode (Meloidogyne javanica), Northern Root-Knot Nematode (Meloidogyne hapla) and Peanut Root-Knot Nematode (Meloidogyne arenaria); nematodes of the species Ditylenchus such as Ditylenchus destructor and Ditylenchus dipsaci; nematodes of the species Pratylenchus such as the Cob Root-Lesion Nematode (Pratylenchus penetrans), Chrysanthemum Root-Lesion Nematode (Pratylenchus fallax), Pratylenchus coffeae, Pratylenchus loosi and Walnut Root-Lesion Nematode (Pratylenchus vulnus); Nematodes of the species Globodera such as Globodera rostochiensis and Globodera pallida; Nematodes of the species Heterodera such as Heterodera glycines (soybean cyst nematode); Heterodera schachtii (beet cyst nematode); Heterodera avenae (cereal cyst nematode); Nematodes of the species Aphelenchoides such as the Rice White-tip Nematode (Aphelenchoides besseyi), Aphelenchoides ritzemabosi and Aphelenchoides fragariae; Nematodes of the species Aphelenchus such as Aphelenchus avenae; Nematodes of the species Radopholus, such as the Burrowing-Nematode (Radopholus similis); Nematodes of the species Tylenchulus such as Tylenchulus semipenetrans; Nematodes of the species Rotylenchulus such as Rotylenchulus reniformis; Nematodes living in trees such as Bursaphelenchus xylophilus and the Red Ring Nematode (Bursaphelenchus cocophilus) etc. and Globodera spp.; particularly members of the cyst nematodes, including, but not limited to Globodera rostochiensis and Globodera pailida (potato cyst nematodes); Spiral (Helicotylenchus spp.); Burrowing (Radopholus similis); Bulb and stem (Ditylenchus dipsaci); Reniform (Rotylenchulus reniformis); Dagger (Xiphinema spp.); Bud and leaf (Aphelenchoides spp.); and Pine Wilt Disease (Bursaphelenchus xylophilus). Lesion nematodes include Pratylenchus spp. The term “nematode” encompasses eggs, larvae, juvenile and mature forms of nematodes.

B. Methods of Controlling Plant Pathogens and Plant Pests and Treating or Preventing Plant Disease and Plant Pest Infestation

Provided herein are methods for controlling plant pathogens comprising applying to a population of the plant pathogens, an area of cultivation, or a plant an effective amount of a combination of one or more chemical pesticides and a recited pesticidal microbial strain or an active variant thereof; wherein an effective amount controls the plant pathogen. Also provided herein are methods for treating or preventing a plant disease comprising applying to a plant having a plant disease or at risk of developing a plant disease an effective amount of a combination of one or more chemical fungicides and a recited bacterial or fungal strain of interest or an active variant thereof; wherein an effective amount controls a plant pathogen that causes the plant disease. In some embodiments, the amount of the pesticidal microbial strain or active variant thereof applied to the population of plant pathogens, an area of cultivation, or a plant comprises at least about 10³ to 10¹⁰ CFU per acre, at least about 10³ to 10¹⁶ CFU per acre, at least about 10⁸ to 10¹⁶ CFU per acre, at least about 10¹² to 10¹⁶ CFU per acre, least about 10⁴ to 10¹⁶ CFU per acre, or least about 10⁵ to 10¹¹ CFU per acre, or at least about 10¹² to 10¹⁴ CFU per acre.

In some methods, a combination of one or more chemical pesticides and a recited pesticidal microbial strain or an active variant thereof has pesticidal activity capable of treating or preventing one, two, three, four, five or more plant diseases. The combination of one or more chemical pesticides and a recited pesticidal microbial strain or an active variant thereof can be employed with any plant species susceptible to a plant disease of interest.

In some embodiments, the plant pathogen is a fungal plant pathogen, responsible for a fungal plant disease, an a recited pesticidal microbial strains is applied in combination with a chemical fungicide. Examples of diseases caused by fungal pathogens that can be treated or prevented with the compositions and methods described herein are provided in Table 1. Also provided are non-limiting exemplary crop species that are susceptible to the fungal plant diseases caused by the fungal pathogens. For example, Table 1 shows that Pythium spp., Rhizoctonia spp., Fusarium spp., Phytophthora spp., or Verticillium spp. cause “damping off”, seedling blights, and root or crown diseases on at least one type of Brassica vegetables, cucurbits, fruiting vegetables, leafy vegetables, legume vegetables, root, tuber, and corm vegetables, and other vegetables, including sweet corn, popcorn, asparagus, peanut, and watercress. Therefore, a combination of one or more chemical fungicides and a recited bacterial or fungal strain of interest or an active variant thereof that controls Pythium spp., Rhizoctonia spp., Fusarium spp., Phytophthora spp., or Verticillium spp. can be applied to a Brassica vegetable plant, a cucurbit plant, a fruiting vegetable plant, a leafy vegetable plant, a legume vegetable plant, a root, tuber, or corm vegetable plant having “damping off”, seedling blights, and/or root or crown diseases or at risk of developing “damping off”, seedling blights, and/pr root or crown diseases in order to treat or prevent “damping off”, seedling blights, and/or root or crown diseases in the plant. Similarly, Table 1 shows that Pythium spp., Rhizoctonia spp., Fusarium spp., Phytophthora spp., or Verticillium spp. cause “damping off” and root or crown diseases in at least one type of strawberry, herbs and spices, coffee, and tobacco. Therefore, a combination of one or more chemical fungicides and a recited bacterial or fungal strain of interest or an active variant thereof that controls Pythium spp., Rhizoctonia spp., Fusarium spp., Phytophthora spp., or Verticillium spp. can be applied to a a strawberry plant, an herb or spice plant, a coffee plant, or a tobacco plant having “damping off” and/or root or crown diseases or at risk of developing “damping off” and/or root or crown diseases in order to treat or prevent “damping off” and/or root or crown diseases in the plant. In another example, Table 1 shows that Mycosphaerella citri causes greasy spot in at least one type of Citrus tree. Therefore, a combination of one or more chemical fungicides and a recited bacterial or fungal strain of interest or an active variant thereof that controls Mycosphaerella citri can be applied to a Citrus tree plant having greasy spot or at risk of developing greasy spot in order to treat or prevent greasy spot in the plant.

TABLE 1

| Crop-species | Causal Fungal Pathogen | Fungal Disease |
|---|---|---|
| Vegetables and melons | | |
| Brassica vegetables (e.g., | Alternaria spp., Xanthomonas spp. | pin rot complex |
| broccoli, cabbage, | Alternaria spp., Xanthomonas spp. | Leaf Spots |
| cauliflower, Brussels | Peronospora spp. | Downy mildew |
| sprouts, kohlrabi, and other | Erisyphe polygoni | Powdery mildew |
| cole crops) | Pythium, Rhizoctonia, Fusarium, | “Damping off”, seedling blights, |
| | Phytophthora, or Verticillium spp. | and root or crown diseases |
| Bulb vegetables (e.g., | Botrytis spp. | Neck rot, leaf blight |
| onions, garlic, shallots) | Alternaria spp. | Purple blotch |
| | Peronospora spp. | Downy mildew |
| | Erisyphe spp. | Powdery mildew |
| | Puccinia pori | Rust |
| | Sclerotium cepivorum | White rot |
| | Pythium, Rhizoctonia, Fusarium, | “Damping off”, seedling blights, |
| | Phytophthora, or Verticillium spp. | and root or crown diseases |
| Cucurbits (e.g., cucumbers, | Erisyphe and Sphaerotheca spp. | Powdery mildew |
| squash, cantaloupes, | Pseudoperonospora spp. | Downy mildew |
| muskmelons, watermelons, | Didymella bryoniae and Phoma | Gummy stem blight |
| and other melons) | cucurbitacearum | |
| | Monosporascus cannonballus | Vine decline |
| | Macrophomina phaseoil | Charcoal rot |
| | Pythium, Rhizoctonia, Fusarium, | “Damping off”, seedling blights, |
| | Phytophthora, or Verticillium spp. | and root or crown diseases |
| Fruiting vegetables (e.g., | Xanthomonas spp. | Bacterial spot |
| tomatoes, peppers, eggplant, | Pseudomonas syringae pv. tomato | Bacterial speck |
| tomatillo, okra) | Botrytis cinerea | Gray mold |
| | Leveillula, Oidiopsis, Erisyphe, and | Powdery mildew |
| | Sphaerotheca spp. | |
| | Alternaria solani | Early blight |
| | Phytophthora infestans | Late blight |
| | Pythium, Rhizoctonia, Fusarium, | “Damping off”, seedling blights, |
| | Phytophthora, or Verticillium spp. | and root or crown diseases |
| | Sclerotium rolfsii | Southern blight |
| Leafy vegetables (e.g., head | Bremia lactucae, Peronospora | Downy Mildew |
| and leaf lettuce, celery, | spp. | |
| spinach, radicchio, arugula, | Golovinomyces (Erisyphe) | Powdery mildew |
| watercress, mustard and | cichoracearum | |
| collard greens, kale, bok | | Bacterial blights |
| choi) | Sclerotinia spp. | Head and leaf drop |
| | Sclerotinia sclerotiorum | Pink rot |
| | Cercospora spp. | Leaf spots |
| | Pythium, Rhizoctonia, Fusarium, | “Damping off”, seedling blights, |
| | Phytophthora, or Verticillium spp. | and root or crown diseases |
| | Rhizoctonia solani | Bottom rot |
| Legume vegetables (e.g., | Sclerotinia sclerotiorum | White mold |
| succulent and dried beans | Botrytis cinerea | Gray mold |
| and peas such as green, | Microsphaera diffusa | Powdery mildew |
| snap, shell, and Lima beans, | Various including Uromyces | Rusts, including Asian soybean |
| garbanzo beans, chickpeas, | appendiculatus, Puccinia spp., and | rust |
| soybeans, dry beans, peas, | Phayospora pachyrhizi (Asian | |
| split peas, lentils) | soybean rust) | |
| | Pythium, Rhizoctonia, Fusarium, | “Damping off”, seedling blights, |
| | Phytophthora, or Verticillium spp. | and root or crown diseases |
| Root, tuber, and corm | Alternaria spp. | Black root/crown rot |
| vegetables (e.g., potato, | Xanthomonas campestri | Bacterial leaf blight |
| sweet potato, carrot, | Peronospora spp. | Downy mildew |
| cassava, beets, ginger, | Erisyphe spp. | Powdery mildew |
| radish, horseradish, ginseng, | Botrytis spp. | Gray mold |
| turnip) | Sclerotinia sclerotiorum | White mold |
| | Erwinia carotovora | Black leg/bacterial soft rot |
| | Alternaria solani | Early blight |
| | Phytophthora infestans | Late blight |
| | Rhizoctonia solani | Black scurf |
| | Pythium spp. | Cavity spot |
| | Pythium, Rhizoctonia, Fusarium, | “Damping off”, seedling blights, |
| | Phytophthora, or Verticillium spp. | and root or crown diseases |
| Other vegetables (e.g., | Botrytis spp. | |
| sweet corn, popcorn, | Puccinia spp. | Rusts |
| asparagus, peanut, | Sclerotinia sclerotiorum | White mold |
| watercress) | Cercospora and Cercosporidium | Leaf spots |
| | spp. | |
| | Pythium, Rhizoctonia, Fusarium, | “Damping off”, seedling blights, |
| | Phytophthora, or Verticillium spp. | and root or crown diseases |
| Tree fruits and nuts | | |
| Citrus (e.g., orange, lemon, | Alternaria alternata | Alternaria leaf spot |
| lime, grapefruit, tangerine, | Colletotrichum acutatum | Postbloom fruit drop |
| tangelo, pummelo) | Mycosphaerella citri | Greasy spot |
| | Xanthomonas campestris pv. citri | Citrus canker |
| | Elsinoe fawcetti | Scab |
| | Diaporthe citri | Melanose |
| Pome fruits (e.g., apple, | Podosphaera leucotricha | Powdery mildew |
| pear, crabapple, quince) | Venturia spp. | Scab |
| | Zygophiala jamaicensis | Flyspeck |
| | | Sooty blotch disease complex |
| | Mycosphaerella pomi | Brooks spot |
| | Botryosphaeria dothidea | Bot rot/white rot |
| | Colletotrichum spp. | Bitter rot |
| | Gymnosporangium juniperi- | Cedar apple rust |
| | virginianae | |
| | Erwinia amylovora | Fire blight |
| Stone fruits (e.g., apricot, | Sphaerotheca and Podosphaera | Powdery mildew |
| cherry, nectarine, peach, | spp. | |
| plum, prune, pluot) | Pseudomonas spp. | Bacterial canker |
| | Monilinia laxa | Brown rot blossom blight |
| | Monilinia fructicola | Brown rot |
| | Botrytis cinerea | Gray mold |
| | Taphrina deformans | Peach leaf curl |
| | Xanthomonas arbicola pv. pruni | Bacterial leaf spot |
| | Podosphaera leucotricha | Rusty spot |
| Tree nuts (e.g., almond, | Xanthomonas campestris | Walnut blight |
| pistachio, pecan, walnut, | Colletotrichum acutatum | Anthracnose |
| filbert, hazelnut, chestnut, | Pseudomonas syringae | Bacterial canker |
| macadamia) | Wilsonomyces carpophilus | Shot hole |
| | Monilinia spp. | Brown rot |
| | Cladosprium caryigenum | Pecan scab |
| Pomegranates | Cercospora, Gloeosporium and | Leaf and fruit spots |
| | Pestalotia spp. | |
| | Alternaria, Botrytis, and other spp. | Fruit rots |
| | Sphaerotheca pannosa | Powdery mildew |
| Other fruits | | |
| Strawberry | Sphaerotheca macularis, Erisyphe | Powdery mildew |
| | spp. | |
| | Botrytis cinerea | Gray mold |
| | Colletotrichum acutatum | Anthracnose |
| | Xanthomonas fragariae | Angular leaf spot |
| | Pythium, Rhizoctonia, Fusarium, | “Damping off” and root or |
| | Phytophthora, or Verticillium spp. | crown diseases |
| | Macrophomina phaseolina | Charcoal rot |
| Berries (e.g., blueberry, | Monilinia vaccinia-corymbosi | Mummy berry |
| blackberry, raspberry, | Botrytis cinerea | Botrytis blight |
| loganberry, huckleberry, | Pseudomonas spp. | Bacterial canker |
| kiwifruit, gooseberry, | Colletotrichum acutatum | Anthracnose fruit rot |
| elderberry, cranberry, | Sclerotinia sclerotiorum | Sclerotinia |
| currant) | | |
| Grapes (e.g., wine grapes, | Erisyphe (formerly Uncinula) | Powdery mildew |
| table grapes, raisins) | necator | |
| | Botrytis cinerea | Gray mold |
| | | Sour rot complex |
| | Plasmopara viticola | Downy mildew |
| | Phomopsis viticola | Phomopsis |
| | Eutypa lata | Eutypa |
| Tropical fruits (e.g., | Colletotrichum spp. | Anthracnose |
| avocado, mango, papaya, | Sphaceloma perseae | Scab |
| pineapple, banana, plantain) | Xanthomonas campestris | Bacterial canker |
| | Mycosphaerella fijiensis | Sigatoka |
| Other crops | | |
| Herbs and spices (e.g., basil, | Oidium spp. and others | Powdery mildews |
| thyme, coriander, dill, | Peronospora spp. and others | Downy mildews |
| cilantro, parsley, mint) | Rhizoctonia, Pythium, Alternaria, | Damping off diseases |
| | and Fusarium spp. | |
| | Alternaria, Septoria, | Leaf spots |
| | Colletotrichum, and Cercospora | |
| | spp. | |
| | Erwinia, Xanthomonas, and | Bacterial diseases |
| | Pseudomonas spp. | |
| | Puccinia spp. and others | Rusts |
| | Pythium, Rhizoctonia, Fusarium, | “Damping off” and root or |
| | Phytophthora, or Verticillium spp. | crown diseases |
| Coffee | Colletotrichum coffeanum | Coffee berry disease |
| | Hemileia vastatrix | Coffee rust |
| | Colletotrichum spp. | Anthracnose |
| | Botrytis spp. | Botrytis flower blight |
| | Cercospora spp. | Cercospora leaf spot and berry |
| | | blotch |
| | Pythium, Rhizoctonia, Fusarium, | “Damping off” and root or |
| | Phytophthora, or Verticillium spp. | crown diseases |
| Tobacco | Pseudomonas spp. | Angular leaf spot |
| | Colletotrichum and Glomerella | Anthracnose |
| | spp. | |
| | Peronospora spp. | Blue mold or downy mildew |
| | Alternaria | Brown spot |
| | Cerrcospora nicotianae | Barn spot/frogeye leaf spot |
| | Sclerotinia slcerotiorum | Collar rot |
| | Botrytis cinerea | Gray mold |
| | Erysiphe cichoracearum | Powdery mildew |
| | Rhizoctonia solani | Target spot |
| | Pythium, Rhizoctonia, Fusarium, | “Damping off”, seedling blights, |
| | Phytophthora, Olpidium, or | and root or crown diseases |
| | Verticillium spp. | |
| | Macrophomina phaseolina | Charcoal rot |
| | Thielaviopsis basicola | Black root rot |
| | Phytophthora spp. | Black shank |
| | Sclerotium rolfsii | Southern blight/southern stem |
| | | rot |
| Corn (e.g., field corn, sweet | Puccinia sorghi | Common rust |
| corn, popcorn, sileage corn, | Bipolaris maydis, Cochliobolus | Southern leaf blight |
| seed corn) | heterostrophus, Helminthosporium | |
| | maydis | |
| Cereal grains (e.g., barley, | Erysiphe graminis | Powdery mildew |
| millet, oats, rice, rye, | Puccinia spp. | Rust |
| sorghum, triticale, wheat) | Pyricularia oryzae | Rice blast |
| | Rhizoctonia and Thanatephorus | Sheath spot/blight |
| | spp. | |
| | Tilletia barclayana | Smut |
| | Xanthomonas spp. | Bacterial blight/streak |
| | Magnaporthe and Sclerotium spp. | Stem rots |
| | Cercospora spp. | Cercospora leaf spot |
| | Ceratobasidium, Cochliobolus, | Brown rot/leaf spots/smuts |
| | Dreschlera, and Entyloma spp. | |
| Oilseed crops (e.g., canola, | Sclerotinia sclerotiorum | White mold/stem rot |
| castor, coconut, cotton, flax, | Various including Uromyces | Rusts, including Asian soybean |
| oil palm, olive, peanut, | appendiculatus, Puccinia spp., and | rust |
| rapeseed, safflower, sesame, | Phayospora pachyrhizi (Asian | |
| sunflower, soybeans) | soybean rust) | |
| | Pseudomonas syringae pv. glycinea | Bacterial speck |
| | Xanthamonas spp. | Bacterial pustule |
| | Septoria glycines | Brown spot |
| | Cercospora spp. | Cercospora leaf spot |
| | Diaporthe and Phomopsis spp. | Pod and stem blights |
| | Peronospora mansherica | Downy mildew |
| Mint | Puccini spp. | Rust |
| Hops | Sphaerotheca macularis | Powdery mildew |
| Sugar beets | Cercospora and Ramularia spp. | Leaf spots |
| | Erysiphe spp. | Powdery mildew |
| | Uromyces betae | Rust |
| Indoor, outdoor, and shade- | Erisyphe, Podosphaera, | Powdery mildew |
| or other cover-grown | Sphaerotheca, Oidium, and | |
| ornamental trees and shrubs, | Golovinomyces spp. | |
| flowering plants, foliage | Colletotrichum spp. | Anthracnose |
| plants, tropical plants, | Erwinia, Pseudomonas, and | Bacterial leaf spots |
| potted plants, potted or cut | Xanthomonas spp. | |
| flowers, bedding plants, | Rhizoctonia, Pythium, Fusarium | Damping-off disease |
| forestry seedlings, conifer | spp. | |
| production for reforestation, | Phytophthora spp. | Late blight, blackeye, and root |
| fruit trees, vegetables and | | rots |
| other crops grown in | Botrytis cinerea | Gray mold and blight |
| greenhouses or nurseries | Aspergillus spp. | Black root rot |
| | Diplocarpon rosae | Black spot of roses |
| | Peronospora spp. | Downy mildew |
| | Alternaria, Septoria, Cercospora, | Leaf spots |
| | Entomosporium, | |
| | Helminthosporium, and | |
| | Myrothecium spp. | |
| | Puccinia spp. | Rust |
| | Venturia spp. | Scab |
| | Rhizoctonia solani | Root rot, bottom rot, or stem rot |
| | Sclerotinia spp. | Sclerotinia blight |
| | Fusarium spp. | Fusarium wilts |
| Turf, sod, lawns, golf course | Colletotrichum graminicola | Anthracnose |
| (fairways, roughs, greens, | Rhizoctonia solani | Brown patch |
| tees), grass seed production | Lanzia and Moellerodiscus spp., | Dollar spot |
| including but not limited to: | formerly Sclerotinia homeocarpa | |
| Bluegrass Bentgrass, | Erisyphe graminis | Powdery mildew |
| Bermudagrass (common & | Puccinia spp. | Rust |
| hybrid), Dichondra, Fescue, | Pyricularia grisea | Gray leaf spot |
| Orchardgrass, Poa annua, | Pythium spp. | “Damping off” or seedling |
| St. Augustine grass, | | blights |
| Ryegrass, Zoysia, mixture, | | |
| and other grasses or | | |
| oranamental turf | | |

The term “treat” or “treating” or its derivatives includes substantially inhibiting, slowing, or reversing the progression of a condition, substantially ameliorating symptoms of a condition or substantially preventing the appearance of symptoms or conditions brought about by the insect pest, or the pathogen or pest that causes the plant disease.

The terms “controlling” a plant pest refers to one or more of inhibiting or reducing the growth, feeding, fecundity, reproduction, and/or proliferation of a plant pest or killing (e.g., causing the morbidity or mortality, or reduced fecundity) of a plant pest. As such, a plant treated with the bacterial strain provided herein and/or a composition derived therefrom may show a reduced infestation of pests, or reduced damage caused by pests by a statistically significant amount. In particular embodiments, “controlling” and “protecting” a plant from a pest refers to one or more of inhibiting or reducing the growth, germination, reproduction, and/or proliferation of a pest; and/or killing, removing, destroying, or otherwise diminishing the occurrence, and/or activity of a pest. As such, a plant treated with a recited pesticidal microbial strain and/or a composition derived therefrom may show a reduced severity or reduced development of disease or damage in the presence of plant pests by a statistically significant amount.

The term “prevent” and its variations means the countering in advance of bacterial, fungal, viral, insect or other pest growth, proliferation, infestation, spore germination, and hyphae growth. In some instances, the composition may be applied before exposure to the plant pests. In other instances, the composition may be applied to treat an infected or infested plant or plants.

The term “ameliorate” and “amelioration” relate to the improvement in the treated plant condition brought about by the compositions and methods provided herein. The improvement can be manifested in the forms of a decrease in pest growth and/or an improvement in the damaged or diseased plant height, weight, number of leaves, root system, or yield. In general, the term refers to the improvement in a damaged or diseased plant's physiological state.

The term “inhibit” and all variations of this term is intended to encompass the restriction or prohibition of bacterial, fungal, viral, nematode, insect, or any other pest growth, as well as spore germination.

The term “eliminate” relates to the substantial eradication or removal of bacteria, fungi, viruses, nematodes, insects, or any other pests by contacting them with the composition of the invention, optionally, according to the methods of the invention described below.

The terms “delay”, “retard” and all variations thereof are intended to encompass the slowing of the progress of bacterial, fungal, viral, nematode, insect, or any other pest growth, and spore germination. The expression “delaying the onset” is interpreted as preventing or slowing the progression of bacterial, fungal, viral, nematodes, insect, or any other pest growth, infestation, infection, spore germination and hyphae growth for a period of time, such that said bacterial, fungal, viral, nematode, insect, or any other pest growth, infestation, infection, spore germination and hyphae growth do not progress as far along in development, or appear later than in the absence of the treatment according to the invention.

A plant, plant part, or area of cultivation treated with a combination of one or more chemical fungicides and a recited pesticidal microbial strain or an active variant thereof may show a reduced disease severity or reduced disease development in the presence of plant pathogens by a statistically significant amount. A reduced disease severity or reduced disease development can be a reduction of about 10% to about 20%, about 20% to about 30%, about 30% to about 40%, about 40% to about 50%, about 50% to about 60%, about 60% to about 70%, about 70% to about 80%, about 80% to about 90%, or about 90% to about 100% when compared to non-treated control plants. In other instances, the plant treated with a combination of one or more chemical pesticides and a recited pesticidal microbial strain or an active variant thereof may show a reduced disease severity or reduced disease development in the presence of a plant pathogen at least about 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or about 100% greater when compared to non-treated control plants. In some embodiments, the plant pathogen is a fungus. In other embodiments, the plant pathogen is bacterial. Methods for assessing plant disease severity are known, and include, measuring percentage of diseased leaf area (Godoy et al. (2006) Fitopatol. Bras. 31(1) 63-68 or by measuring uredinia counts.

By “antifungal compositions” or “antifungal” is intended that a combination of one or more chemical fungicides and a recited bacterial or fungal strain of interest or an active variant thereof is capable of suppressing, controlling, preventing and/or killing the invading pathogenic fungus. In specific embodiments, an antifungal combination reduces the disease symptoms resulting from fungal pathogen challenge by a statistically significant amount, including for example, at least about 10% to at least about 20%, at least about 20% to about 50%, at least about 10% to about 60%, at least about 30% to about 70%, at least about 40% to about 80%, or at least about 50% to about 90% or greater. Hence, the methods of the invention can be utilized to protect plants from fungal disease.

Assays that measure antifungal activity are commonly known in the art, as are methods to quantitate fungal disease resistance in plants following fungal pathogen infection. See, for example, U.S. Pat. No. 5,614,395, herein incorporated by reference. Such techniques include, measuring over time, the average lesion diameter, the fungal pathogen biomass, and the overall percentage of decayed plant tissues. For example, a plant having an antifungal composition applied to its surface shows a decrease in tissue necrosis (i.e., lesion diameter) or a decrease in plant death following fungal pathogen challenge when compared to a control plant that was not exposed to the antifungal composition. Alternatively, antifungal activity can be measured by a decrease in fungal pathogen biomass. For example, a plant exposed to an antifungal composition is challenged with a fungal pathogen of interest. Over time, tissue samples from the pathogen-inoculated tissues are obtained and RNA is extracted. The percent of a specific fungal pathogen RNA transcript relative to the level of a plant specific transcript allows the level of fungal pathogen biomass to be determined. See, for example, Thomma et al. (1998) Plant Biology 95:15107-15111, herein incorporated by reference.

Furthermore, in vitro antifungal assays include, for example, the addition of varying concentrations of the antifungal composition to paper disks and placing the disks on agar containing a suspension of the fungal pathogen of interest. Following incubation, clear inhibition zones develop around the discs that contain an effective concentration of the antifungal composition (Liu et al. (1994) Plant Biology 91:1888-1892, herein incorporated by reference). Additionally, microspectrophotometrical analysis can be used to measure the in vitro antifungal properties of a composition (Hu et al. (1997) Plant Mol. Biol. 34:949-959 and Cammue et al. (1992) J. Biol. Chem. 267: 2228-2233, both of which are herein incorporated by reference).

C. Methods of Inducing Disease Resistance in Plants

Compositions and methods for inducing fungal disease resistance in a plant to fungal plant pathogens are also provided. Accordingly, the compositions and methods are also useful in protecting plants against fungal pathogens. Provided herein are methods of inducing disease resistance against a fungal plant pathogen comprising applying to a plant that is susceptible to a fungal plant disease caused by the fungal plant pathogen an effective amount of a combination of one or more chemical fungicides and a recited bacterial or fungal strain of interest or an active variant thereof. In certain embodiments, a combination of one or more chemical fungicides and a recited bacterial or fungal strain of interest or an active variant thereof promotes a defensive response to the fungal pathogen that causes the fungal plant disease. In some embodiments, the amount of a recited bacterial or fungal strain of interest or an active variant thereof applied to a plant comprises at least about 10¹² to 10¹⁶ CFU per acre.

A defensive response in the plant can be triggered after applying a combination of one or more chemical fungicides and a recited bacterial or fungal strain of interest or an active variant thereof to the plant, but prior to fungal pathogen challenge and/or after fungal pathogen challenge of the plant treated with a combination of one or more chemical fungicides and a recited bacterial or fungal strain of interest or an active variant thereof.

In some methods, a combination of one or more chemical fungicides and a recited bacterial or fungal strain of interest or an active variant thereof induces resistance to one, two, three, four, five or more fungal plant pathogens described herein.

By “disease resistance” is intended that the plants avoid the disease symptoms that result from plant-pathogen interactions. That is, pathogens are prevented from causing plant diseases and the associated disease symptoms, or alternatively, the disease symptoms caused by the pathogen are minimized or lessened as compared to a control.

D. Methods of Application to a Plant or Plant Part

The combinations of one or more chemical pesticides and at least one recited pesticidal microbial strain or an active variant thereof are applied in an effective amount. An effective amount of a combination of one or more chemical pesticides and at least one recited pesticidal microbial strain or an active variant thereof is an amount sufficient to control, treat, prevent, or inhibit an insect pest or a fungal pathogen that causes a fungal plant disease, or reduce fungal plant disease severity or reduce fungal plant disease development. The rate of application of a combination of one or more chemical pesticides and a recited pesticidal microbial strain or an active variant thereof may vary according to the fungal pathogen being targeted, the crop to be protected, the severity of the fungal disease, the climate conditions, and the like.

Generally, the rate of application of the recited pesticidal microbial strain or an active variant thereof applied to an area of cultivation or a plant is 10³ to 10¹⁶ colony forming units (CFU) per acre. In other embodiments, for a field inoculation, the rate of application of a recited pesticidal microbial strain or an active variant thereof is 1×10³ to 1×10¹⁴ colony forming units (CFU) per acre. In other embodiments, for a field inoculation, the rate of application of a recited pesticidal microbial strain or an active variant thereof is 1×10⁸ to 1×10¹⁴ colony forming units (CFU) per acre; about 1×10⁸ to about 1×10¹³ colony forming units (CFU) per acre, about 1×10⁸ to about 1×10¹⁴ colony forming units (CFU) per acre, about 1×10⁸ to about 1×10¹⁵ colony forming units (CFU) per acre, about 1×10¹⁵ to about 1×10¹⁶ colony forming units (CFU) per acre, about 1×10⁸ to about 1×10¹⁷ colony forming units (CFU) per acre; about 1×10⁴ to about 1×10¹⁴ colony forming units (CFU) per acre; about 1×10⁵ to about 1×10¹³ colony forming units (CFU) per acre; about 1×10⁶ to about 1×10¹² colony forming units (CFU) per acre; about 1×10⁹ to about 1×10¹¹ colony forming units (CFU) per acre; or about 1×10⁹ to about 1×10¹¹ colony forming units (CFU) per acre. In other embodiments, for a field inoculation, the rate of application of a recited bacterial or fungal strain or an active variant thereof is at least about 1×10³, 1×10⁴, about 1×10⁵, about 1×10⁶, about 1×10⁷, about 1×10⁸, about 1×10⁹, about 1×10¹⁰, about 1×10¹¹, about 1×10¹², about 1×10¹³, about 1×10¹⁴, 1×10¹⁵, about 1×10¹⁶, or about 1×10¹⁷ colony forming units (CFU) per acre. In other embodiments, for a field inoculation, the rate of application of a recited pesticidal microbial strain or an active variant thereof is at least 1×10⁷ to at least about 1×10¹² CFU/acre.

Any appropriate agricultural application rate for a chemical pesticide, such as a chemical fungicide or a chemical insecticide, can be applied in combination with a recited pesticidal microbial strain or an active variant thereof. Methods to assay for the effective amount of a combination of one or more chemical fungicides and a recited pesticidal microbial strain or an active variant thereof include, for example, any statistically significant increase in the control of the fungal pathogen targeted by the fungicide. Methods to assay for such control are known.

The combinations of one or more chemical pesticides and at least one recited pesticidal microbial strain or an active variant thereof may be used or employed in a synergistic weight ratio. The skilled person is able to determine the synergistic weight ratio for the present invention by routine methods. The skilled person understands that these ratios refer to the ratio within a combined-formulation as well as to the calculative ratio of the recited pesticidal microbial strain and the chemical pesticide when both components are applied as mono-formulations to a plant to be treated. The skilled person can calculate this ratio by simple mathematics since the volume and the amount of the bacterial strain and the chemical pesticide, respectively, in a mono-formulation are known to the skilled person.

The ratio can be calculated based on the amount of the chemical pesticide at the time point of applying said component of a combination according to the invention to a plant or plant part and the amount of the bacterial or fungal strain shortly prior (e.g., 48 h, 24 h, 12 h, 6 h, 2 h, 1 h) or at the time point of applying said component of a combination according to the invention to a plant or plant part.

The application of one or more pesticidal microbial strains and one or chemical pesticides to a plant or a plant part can take place simultaneously or at different times as long as both components are present on or in the plant after the application(s). In cases where the pesticidal microbial strain and chemical pesticide are applied at different times and the chemical pesticide is applied noticeable prior to the pesticidal microbial strain, the skilled person can determine the concentration of chemical pesticide on/in a plant by chemical analysis known in the art, at the time point or shortly before the time point of applying the pesticidal microbial strain. Similarly, when the pesticidal microbial strain is applied to a plant first, the concentration of the pesticidal microbial strain can be determined using methods which are also known in the art, at the time point or shortly before the time point of applying the chemical pesticide.

In particular, in one embodiment the synergistic weight ratio of the pesticidal microbe preparation and the chemical pesticide lies in the range of 1:500 to 1000:1, preferably in the range of 1:500 to 500:1, more preferably in the range of 1:500 to 300:1. The pesticidal microbe preparation may comprise cells, spores, mycelium, hypae, forespores, or a combination thereof derived from the pesticidal microbial strain. It has to be noted that these ratio ranges refer to the pesticidal microbe preparation (to be combined with at least one chemical pesticide or a preparation of at least one chemical pesticide) of around 10¹⁰ cells/spores per gram preparation of said cells/spores. For example, a ratio of 100:1 means 100 weight parts of a bacterial strain/spore preparation having a cell/spore concentration of 10¹⁰ cells/spores per gram preparation and 1 weight part of chemical pesticide are combined (either as a solo formulation, a combined formulation or by separate applications to plants so that the combination is formed on the plant). In another embodiment, the synergistic weight ratio of one or more microbial strain/spore preparation to chemical pesticide is in the range of 1:100 to 20.000:1, preferably in the range of 1:50 to 10.000:1 or even in the range of 1:50 to 1000:1. Once again the mentioned ratios ranges refer to a bacterial strain/spore preparations of a bacterial strains of around 10¹⁰ cells or spores per gram preparation of said a bacterial strain. In a particular embodiment, the bacterial strain is selected from the group consisting of SONATA® (Bayer CropScience LP, comprising Bacillus pumilus, strain QST2808, Accession No. NRRL B-30087; aqueous suspension that contains a minimum of 1×10⁹ CFU/gram), DOUBLE NICKEL55™ (Certis USA, LLC, comprising Bacillus amyloliquefaciens strain D747; WDG that contains a minimum of 5×10¹⁰ CFU/gram), and CEASE® (BioWorks®, comprising Bacillus subtilis strain QST713; aqueous suspension that contains a minimum of 1×10⁹ CFU/gram). Still in another embodiment, the synergistic weight ratio of one or more bacterial strain/spore preparation to the chemical pesticide is in the range of 1:0.001 to 1:5, preferably in the range of 1:0.01 to 1:1 or even in the range of 1:0.1 to 1:0.9. Here the mentioned ratio ranges refer to the amount in ppm of the bacterial strain/spore preparation and the chemical pesticide, wherein the amount of the a bacterial strain refers to the dried content of the bacterial solution. In particular, in this embodiment the bacterial strain preferably is Bacillus subtilis strain QST713. In particular a solution comprising Bacillus subtilis strain QST713 is preferred which contains 1.34% of the bacterial strain which refers to 8.5·10⁸ CFU/g.

The cell/spore concentration of preparations can be determined by applying methods known in the art. To compare weight ratios of a bacterial strain/spore preparation to a chemical pesticide, the skilled person can easily determine the factor between a preparation having a bacterial strain/spore concentration different from 10¹⁰ cells/spores per gram cell/spore preparation and a preparation having a bacterial strain/spore concentration of 10¹⁰ cells/spores per gram preparation to calculate whether a ratio of a bacterial strain/spore preparation to chemical pesticide is within the scope of the above listed ratio ranges. In one embodiment of the present invention, the concentration of the a bacterial strain after dispersal is at least 50 g/ha, such as 50-7500 g/ha, 50-2500 g/ha, 50-1500 g/ha; at least 250 g/ha (hectare), at least 500 g/ha or at least 800 g/ha.

The application rate of composition to be employed or used according to the present invention may vary. The skilled person is able to find the appropriate application rate by way of routine experiments.

Further provided is a method for controlling or inhibiting the growth of a fungal plant pathogen that causes fungal plant disease by applying a combination of one or more chemical fungicides and a recited pesticidal microbial strain or an active variant thereof. By “applying” is intended contacting an effective amount of the combination with a plant, area of cultivation, seed and/or weed with one or more of the combinations provided herein so that a desired effect is achieved. Furthermore, the application of one or more chemical fungicides and/or a recited pesticidal microbial strain or an active variant thereof can occur prior to the planting of the crop (for example, to the soil, the seed, or the plant). In a specific embodiment, the application of one or more chemical fungicides and/or a recited pesticidal microbial strain or an active variant thereof is a foliar application. Therefore, a further embodiment of the invention provides a method for controlling or inhibiting the growth of a fungal plant pathogen by applying one or more chemical fungicides and/or a recited pesticidal microbial strain or an active variant thereof to an environment in which the fungal plant pathogen may grow. The application may be to the plant, to parts of the plant, to the seeds of the plants to be protected, or to the soil in which the plant to be protected is growing or will grow. Application to the plant or plant parts may be before or after harvest. Application to the seeds will be prior to planting of the seeds.

In other embodiments, an effective amount of a combination of one or more chemical fungicides and a recited pesticidal microbial strain or an active variant thereof is applied to the soil in which the plant to be protected are growing or will grow to control or inhibit growth of one or more fungal pathogens selected from the group consisting of Fusarium spp., Macrophomina phaseoli, Macrophomina phaseolina, Monosporascus cannonballus, Phytophthora spp., Pythium spp., Rhizoctonia spp., Rhizoctonia solani, Sclerotium rolfsii, Thielaviopsis basicola, and Verticillium spp.

As used herein, the term plant includes plant cells, plant protoplasts, plant cell tissue cultures from which plants can be regenerated, plant calli, plant clumps, and plant cells that are intact in plants or parts of plants such as embryos, pollen, ovules, seeds, leaves, flowers, branches, fruit, kernels, ears, cobs, husks, stalks, roots, root tips, anthers, and the like. Grain is intended to mean the mature seed produced by commercial growers for purposes other than growing or reproducing the species.

In specific embodiments, a combination of one or more chemical fungicides and a recited pesticidal microbial strain or an active variant thereof is applied to the leaves of a soybean plant. The timing of application can vary depending on the conditions and geographical location.

Various methods are provided for controlling a fungal plant pathogen that causes a fungal plant disease in an area of cultivation containing a plant susceptible to the fungal plant disease. The method comprises planting the area of cultivation with seeds or plants susceptible to the fungal plant disease; and applying to the plant susceptible to the disease, the seed or the area of cultivation of the plant susceptible to the fungal plant disease an effective amount of a combination of one or more chemical fungicides and a recited pesticidal microbial strain or an active variant thereof, wherein the effective amount controls the fungal plant disease without significantly affecting the crop. In specific embodiments, the effective amount comprises an amount of a recited pesticidal microbial strain or an active variant thereof of at least about 10⁸ to 10¹⁶ colony forming units (CFU) per acre.

Further provided is a method for growing a plant susceptible to a fungal plant disease. The method comprises applying to a plant susceptible to the fungal disease, a seed, or an area of cultivation of the plant susceptible to the fungal disease an effective amount of a combination of one or more chemical fungicides and a recited pesticidal microbial strain or an active variant thereof. In some embodiments, the effective amount comprises an amount of a recited pesticidal microbial strain of interest or an active variant thereof of at least about 10¹² to 10¹⁶ colony forming units (CFU) per acre.

As used herein, an “area of cultivation” comprises any region in which one desires to grow a plant. Such areas of cultivations include, but are not limited to, a field in which a plant is cultivated (such as a crop field, a sod field, a tree field, a managed forest, a field for culturing fruits and vegetables, etc.), a greenhouse, a growth chamber, etc.

Further provided is a coated seed which comprises a seed and a coating on the seed, wherein the coating comprises a combination of one or more chemical fungicides and a recited pesticidal microbial strain or an active variant thereof. In certain embodiments, a recited pesticidal microbial strain or an active variant thereof is present on the seed at about 10³ CFU/seed to about 10⁶ CFU/seed, at about 10⁵ CFU/seed to about 10⁷ CFU/seed, at about 10⁴ CFU/seed to about 10⁸ CFU/seed, at about 10³ CFU/seed to about 10⁴ CFU/seed, at about 10⁴ CFU/seed to about 10⁵ CFU/seed, at about 10⁵ CFU/seed to about 10⁶ CFU/seed, at about 10⁶ CFU/seed to about 10⁷ CFU/seed, or at about 10⁷ CFU/seed to about 10⁸ CFU/seed. The seed coating can be applied to any seed of interest (i.e., for a monocot or a dicot). Various plants of interest are disclosed elsewhere herein.

A seed coating can further comprise at least one additional biocide (other than a chemical fungicide). See, for example, US App Pub. 20040336049, 20140173979, and 20150033811.

According to the methods provided herein, a plant of interest (i.e., plant susceptible to the fungal plant disease) and/or the area of cultivation comprising the plant, is treated with a combination of one or more chemical fungicides and a recited pesticidal microbial strain or an active variant thereof. By “treated with a combination of” or “applying a combination of” one or more chemical fungicides and a recited pesticidal microbial strain or an active variant thereof to a plant, area of cultivation or field, it is intended that one or more of a particular field, plant, and/or weed is treated with an effective amount of a combination of one or more chemical fungicides and a recited pesticidal microbial strain or an active variant thereof so that a desired effect is achieved (e.g., synergistic fungicidal activity). Furthermore, the application of one or both of the one or more chemical fungicides and a recited pesticidal microbial strain or an active variant thereof can occur prior to the planting of the crop (for example, to the soil, or the plant). Moreover, the application of one or more chemical fungicides and a recited pesticidal microbial strain or an active variant thereof may be simultaneous or the applications may be at different times (sequential), so long as the desired effect is achieved (e.g., synergistic fungicidal activity).

### VI. Additional Biocides for Use

As discussed elsewhere herein, in addition to the one or more chemical fungicides, a recited pesticidal microbial strain or an active variant thereof can be used in combination with an additional biocide (i.e., a herbicide, fungicide (other than chemical fungicide), pesticide, or other crop protection chemical). In such instances, the bacterial strain provided herein or active variant thereof is compatible with the biocide of interest.

Herbicides that can be used in the various methods and compositions disclosed herein include glyphosate, ACCase inhibitors (Arloxyphenoxy propionate (FOPS)); ALS inhibitors (Sulfonylurea (SU)), Imidazonlinone (IMI), Pyrimidines (PM)); microtubule protein inhibitor (Dinitroaniline (DNA)); synthetic auxins (Phenoxy (P)), Benzoic Acid (BA), Carboxylic acid (CA)); Photosystem II inhibitor (Triazine (TZ)), Triazinone (TN), Nitriles (NT), Benzothiadiazinones (BZ), Ureas (US)); EPSP Synthase inhibitor (glycines (GC)); Glutamine Synthesis inhibitor (Phosphinic Acid (PA)); DOXP synthase inhibitor (Isoxazolidinone (IA)); HPPD inhibitor (Pyrazole (PA)), Triketone (TE)); PPO inhibitors (Diphenylether (DE), N-phenylphthalimide (NP) (Ary triazinone (AT)); VLFA inhibitors (chloroacetamide (CA)), Oxyacetamide (OA)); Photosystem I inhibitor (Bipyridyliums (BP)); and the like.

Pesticides that can be used in the various methods and compositions disclosed herein include imidacloprid clothianidin, arylpyrazole compounds (WO2007103076); organophosphates, phenyl pyrazole, pyrethoids caramoyloximes, pyrazoles, amidines, halogenated hydrocarbons, carbamates and derivatives thereof, terbufos, chloropyrifos, fipronil, chlorethoxyfos, telfuthrin, carbofuran, imidacloprid, tebupirimfos (U.S. Pat. No. 5,849,320).

Non-limiting embodiments of the invention include:

1. A composition comprising:

(a) a biocontrol agent, wherein the biocontrol agent comprises:
(i) a cell, a spore, a forespore, or a combination of cells, spores, and/or forespores of one or more of the following bacterial strains: Bacillus amyloliquefaciens D747, Bacillus subtilis strain QST 713, Bacillus subtilis strain AQ30002, Bacillus subtilis strain AQ30004, Bacillus amyloliquefaciens strain GB03, Bacillus pumilus strain QST 2808, Bacillus pumilus strain GB34, Bacillus finnus strain CNMC 1-1582, Streptomyces lydicus strain WYEC108, Streptomyces griseoviridis strain K61, Agrobacterium radiobacter strain 1026, Agrobacterium radiobacter strain K84, Pseudomonas fluorescens strain A506, Bacillus thuringiensis subspecies aizawai strain GC-91, Bacillus thuringiensis subspecies kurstaki, Bacillus thuringiensis subspecies kurstaki strain EG7841, Bacillus thuringiensis subspecies kurstaki strain SA-12, Bacillus thuringiensis subspecies kurstaki strain ABTS-351, Bacillus thuringiensis subspecies kurstaki strain SA-11, Bacillus thuringiensis subspecies tenebrionis strain SA-10, Chromobacterium subtsugae strain PRAA4-1, Isaria fumosorosea Apopka Strain 97, Burkholderia spp. strain A396, and Bacillus thuringiensis subspecies aizawai strain ABTS-1857, or an active variant thereof, wherein the active variant comprises a cell, spore, forespore, or a combination of cells, spores, and/or forespores having a genome within a Mash distance of about 0.015, and/or
(ii) a cell, a spore, or a fungal part such as a piece of mycelium or hyphae, or a combination of cells, spores, and mycelia of one or more of the following fungal strains: Trichoderma harzianum strain KRL-AG2, Trichoderma harzianum strain T-22, Gliochladium vierns, aka Trichoderma vixens, strain GL-21, Coniothyrium minitans strain CON/M/91-8, Purpureocilium lilacinum, Ulocladium oudemansii U3 strain, Ulocladium oudemansii HRU3 strain, Beauveria bassiana strain GHA, or an active variant thereof wherein the active variant comprises a cell, spore, forespore, or a combination of cells, spores, and/or forespores having a genome within a Mash distance of about 0.015, and/or
(iii) a virus or virus isolate of one or more of the following viruses: Cydia pomonella granulovirus, Cydia pomonella granulovirus isolate V22, or polyhedral occlusion bodies of the nuclear polyhedrosis virus of Helicoverpa zea, and/or
(iii) a plant extract derived from Chenopodium ambrosioides or Reynoutria sachalinensis; and

(b) at least one chemical pesticide selected from the group consisting of a triazole fungicide, a strobilurin fungicide, an anilide fungicide, a pyridine fungicide, an aromatic fungicide, an organophosphorus fungicide, an aryl phenyl ketone fungicide, and a neonicotinoid insecticide;

wherein an effective amount of said composition controls a plant pathogen and/or plant pest.

2. The composition of embodiment 1, wherein said biocontrol agent is a bacterial or fungal strain or an active variant thereof, present at about 10³ CFU/gram to about 10¹² CFU/gram or at about 10³ CFU/ml to about 10¹² CFU/ml.

3. The composition of embodiment 2, wherein said bacterial or fungal strain or active variant thereof is present at about 10³ CFU/gram to about 10¹¹ CFU/gram or at about 10³ CFU/ml to about 10¹¹ CFU/ml.

4. The composition of any of embodiments 1-3, wherein said composition comprises a cell paste.

5. The composition of any one of embodiments 1-3, wherein said composition comprises a wettable powder.

6. The composition of any one of embodiments 1-5, wherein said plant pathogen is selected from the group consisting of Alternaria spp., Alternaria alternate, Alternaria solani, Aspergillus spp., Bipolaris maydis, Botryosphaeria dothidea, Botrytis spp., Botrytis cinerea, Bremia lactucae, Ceratobasidium spp., Cercospora spp., Cercospora nicotianae, Cercosporidium spp., Cladosprium caryigenum, Cochliobolus spp., Cochliobolus heterostrophus, Colletotrichum spp., Colletotrichum acutatum, Colletotrichum coffeanum, Colletotrichum graminicola, Diaporthe spp., Diaporthe citri, Didymella bryoniae, Diplocarpon rosae, Dreschlera spp., Elsinoe fawcetti, Entomosporium spp., Entyloma spp., Erisyphe spp., Erisyphe cichoracearum, Erisyphe graminis, Erisyphe (formerly Uncinula) necator, Erisyphe polygoni, Erwinia spp., Erwinia amylovora, Erwinia carotovora, Eutypa lata, Fusarium spp., Gloeosporium spp., Glomerella spp., Golovinomyces spp., Golovinomyces (Erisyphe) cichoracearum, Gymnosporangium juniperi-virginianae, Helminthosporium spp., Helminthosporium maydis, Hemileia vastatrix, Lanzia spp., Leveillula spp., Macrophomina phaseoli, Macrophomina phaseolina, Magnaporthe spp., Microsphaera diffusa, Moellerodiscus spp., Monilinia spp., Monilinia fructicola, Monilinia laxa, Monilinia vaccinia-corymbosi, Monosporascus cannonballus, Mycosphaerella citri, Mycosphaerella fijiensis, Mycosphaerella pomi, Myrothecium spp., Oidium spp., Oidiopsis spp., Olpidium spp., Peronospora spp., Peronospora mansherica, Pestalotia spp., Phayospora pachyrhizi, Phoma cucurbitacearum, Phomopsis spp., Phomopsis viticola, Phytophthora spp., Phytopthora infestans, Plasmopara viticola, Podosphaera spp., Podosphaera leucotricha, Pseudomonas spp., Pseudomonas syringae, Pseudomonas syringae pv. glycinea, Pseudomonas syringae pv. tomato, Pseudoperonospora spp., Puccinia spp., Puccinia pori, Puccinia sorghi, Pyricularia grisea, Pyricularia oryzae, Pythium spp., Ramularia spp., Rhizoctonia spp., Rhizoctonia solani, Sclerotinia spp., Sclerotinia sclerotiorum, Sclerotium spp., Sclerotium rolfsii, Sclerotium cepivorum, Septoria spp., Septoria glycines, Sphaceloma perseae, Sphaerotheca spp., Sphaerotheca macularis, Sphaerotheca pannosa, Taphrina deformans, Thanatephorus spp., Thielaviopsis basicola, Tillefia barclayana, Uromyces appendiculatus, Uromyces betae, Venturia spp., Verticillium spp., Wilsonomyces carpophilus, Xanthomonas spp., Xanthomonas arbicola pv. pruni, Xanthomonas campestris, Xanthomonas campestris pv. citri, Xanthomonas fragariae, and Zygophiala jamaicensis.

7. The composition of any one of embodiments 1-5, wherein said plant pest is selected from the group consisting of Ostrinia nubilalis, Agrotis spp., Agrotis orthogonia, Agrotis Helicoverpa spp., Helicoverpa zeae, Spodoptera spp., Spodoptera frugiperda, Spodoptera exigua, Spodoptera eridania, Diatraea spp., Diatraea grandiosella, Elasmopalpus lignosellus, Diatraea saccharalis, Diabrotica spp., Diabrotica virgifera virgifera, Diabrotica longicornis barberi, Diabrotica undecimpunctata howardi, Melanotus spp., Cyclocephala spp., Cyclocephala borealis, Cyclocephala immaculata, Popillia japonica, Chaetocnema spp., Chaetocnema pulicaria, Sphenophorus maidis, Rhopalosiphum maidis, Anuraphis maidiradicis, Myzus persicae, Nezara viridula, Blissus leucopterus leucopterus, Melanoplus spp., Melanoplus femurrubrum, Melanoplus sanguinipes, Melanoplus differentialis, Hylemya spp., Hylemya platura, Hylemya coarctata, Agromyza parvicornis, Anaphothrips obscrurus, Solenopsis milesta, Tetranychus spp., Tetranychus turkestani, Tetranychus urticae, Chilo partellus, Elasmopalpus lignosellus, Feltia subterranea, Phyllophaga crinita, Eleodes spp., Conoderus spp., Aeolus spp., Oulema melanopus, Sphenophorus maidis, Sipha flava, Blissus leucopterus leucopterus; Contarinia sorghicola, Tetranychus spp., Tetranychus cinnabarinus, Tetranychus urticae, Pseudalefia unipunctata, Hypera punctata, Schizaphis graminum, Macrosiphum avenae, Mayetiola destructor, Sitodiplosis mosellana, Meromyza americana, Frankliniella spp., Frankliniella fusca, Cephus cinctus, Aceria tulipae, Cylindrocupturus adspersus, Smicronyx spp., Smicronyx fulus, Smicronyx sordidus, Suleima helianthana, Homoeosoma electellum, Zygogramma exclamationis, Bothyrus gibbosus, Neolasioptera murtfeldtiana, Heliothis virescens, Pectinophora gossypiella, Anthonomus grandis; Aphis spp., Aphis gossypii, Pseudatomoscelis seriatus, Trialeurodes abufilonea, Lygus spp, Lygus lineolaris, Thrips spp., Thrips tabaci, Colaspis brunnea, Lissorhoptrus oryzophilus, Sitophilus oryzae, Nephotettix nigropictus, Acrosternum hilare, Pseudoplusia includens, Anficarsia gemmatalis, Plathypena scabra, Epilachna varivestis, Empoasca fabae, Acrosternum hilare, Sericothrips variabilis, Schizaphis graminum, Euschistus servus, Jylemya platura, Mayetiola destructor, Petrobia latens, Vrevicoryne brassicae, Phyllotreta spp., Phyllotreta cruciferae, Phyllotreta striolata, Phyllotreta nemorum, Meligethes spp. Meligethes aeneus, Meligethes rufimanus, Meligethes nigrescens, Meligethes canadianus, Meligethes viridescens, Lepfinotarsa spp., Leptinotarsa decemlineata, Spartocera batatas, Charidotella (=Metriona) bicolor, Cylas spp., Cylas formicarius, Cylas puncficollis, Cylas brunneus, Naupactus (=Graphognathus) spp., Conoderus spp., Conoderus rudis, Conoderus scissus, Blosyrus spp., Acraea acerata, Agrius convolvuli, Synanthedon spp., Euscepes postfasciatus, Peloropus batatae, Omphisia anastomasalis, and white grubs—larvae of various species of scarabid beetles.

8. The composition of any one of embodiments 1-7, wherein said triazole fungicide comprises at least one of propiconazole, tebuconazole, difenoconazole, tetraconazole, triflumizole, prothioconazole, metconazole, and flutriafol.

9. The composition of any one of embodiments 1-7, wherein said strobilurin fungicide comprises at least one of azoxystrobin, pyraclostrobin, fluoxastrobin, and trifloxystrobin.

10. The composition of any one of embodiments 1-7, wherein said anilide fungicide comprises at least one of fenhexamid, flutolanil, penflufen, and boscalid.

11. The composition of any one of embodiments 1-7, wherein said aromatic fungicide comprises chlorothalonil.

12. The composition of any one of embodiments 1-7, wherein said aryl phenyl ketone fungicide comprises metrafenone.

13. The composition of any one of embodiments 1-7, wherein said organophosphorus fungicide comprises fosetyl-aluminum.

14. The composition of any one of embodiments 1-7, wherein said pyridine fungicide comprises fluazinam.

15. The composition of any one of embodiments 1-7, wherein said neonicotinoid insecticide comprises acetamiprid.

16. A composition comprising a cell paste comprising

(a) a biocontrol agent, wherein the biocontrol agent comprises:
(i) a cell, a spore, a forespore, or a combination of cells, spores, and/or forespores of one or more of the following bacterial strains: Bacillus amyloliquefaciens D747, Bacillus subtilis strain QST 713, Bacillus subtilis strain AQ30002, Bacillus subtilis strain AQ30004, Bacillus amyloliquefaciens strain GB03, Bacillus pumilus strain QST 2808, Bacillus pumilus strain GB34, Bacillus finnus strain CNMC 1-1582, Streptomyces lydicus strain WYEC108, Streptomyces griseoviridis strain K61, Agrobacterium radiobacter strain 1026, Agrobacterium radiobacter strain K84, Pseudomonas fluorescens strain A506, Bacillus thuringiensis subspecies aizawai strain GC-91, Bacillus thuringiensis subspecies kurstaki, Bacillus thuringiensis subspecies kurstaki strain EG7841, Bacillus thuringiensis subspecies kurstaki strain SA-12, Bacillus thuringiensis subspecies kurstaki strain ABTS-351, Bacillus thuringiensis subspecies kurstaki strain SA-11, Bacillus thuringiensis subspecies tenebrionis strain SA-10, Chromobacterium subtsugae strain PRAA4-1, Isaria fumosorosea Apopka Strain 97, Burkholderia spp. strain A396, and Bacillus thuringiensis subspecies aizawai strain ABTS-1857, or an active variant thereof, wherein the active variant comprises a cell, spore, forespore, or a combination of cells, spores, and/or forespores having a genome within a Mash distance of about 0.015, and/or

(ii) a cell, a spore, or a fungal part such as a piece of mycelium or hyphae, or a combination of cells, spores, and mycelia of one or more of the following fungal strains: Trichoderma harzianum strain KRL-AG2, Trichoderma harzianum strain T-22, Gliochladium vierns, aka Trichoderma virens, strain GL-21, Coniothyrium minitans strain CON/M/91-8, Purpureocilium lilacinum, Ulocladium oudemansii U3 strain, Ulocladium oudemansii HRU3 strain, Beauveria bassiana strain GHA, or an active variant thereof wherein the active variant comprises a cell, spore, forespore, or a combination of cells, spores, and/or forespores having a genome within a Mash distance of about 0.015, and/or

(b) at least one chemical pesticide selected from the group consisting of a triazole fungicide, a strobilurin fungicide, an anilide fungicide, a pyridine fungicide, an aromatic fungicide, an organophosphorus fungicide, an aryl phenyl ketone fungicide, and a neonicotinoid insecticide;

wherein an effective amount of said composition controls a plant pathogen and/or plant pest.

17. The composition of embodiment 16, wherein said plant pathogen is selected from the group consisting of Alternaria spp., Alternaria alternate, Alternaria solani, Aspergillus spp., Bipolaris maydis, Botryosphaeria dothidea, Botrytis spp., Botrytis cinerea, Bremia lactucae, Ceratobasidium spp., Cercospora spp., Cercospora nicotianae, Cercosporidium spp., Cladosprium caryigenum, Cochliobolus spp., Cochliobolus heterostrophus, Colletotrichum spp., Colletotrichum acutatum, Colletotrichum coffeanum, Colletotrichum graminicola, Diaporthe spp., Diaporthe citri, Didymella bryoniae, Diplocarpon rosae, Dreschlera spp., Elsinoe fawcetti, Entomosporium spp., Entyloma spp., Erisyphe spp., Erisyphe cichoracearum, Erisyphe graminis, Erisyphe (formerly Uncinula) necator, Erisyphe polygoni, Erwinia spp., Erwinia amylovora, Erwinia carotovora, Eutypa lata, Fusarium spp., Gloeosporium spp., Glomerella spp., Golovinomyces spp., Golovinomyces (Erisyphe) cichoracearum, Gymnosporangium juniperi-virginianae, Helminthosporium spp., Helminthosporium maydis, Hemileia vastatrix, Lanzia spp., Leveillula spp., Macrophomina phaseoli, Macrophomina phaseolina, Magnaporthe spp., Microsphaera diffusa, Moellerodiscus spp., Monilinia spp., Monilinia fructicola, Monilinia laxa, Monilinia vaccinia-corymbosi, Monosporascus cannonballus, Mycosphaerella citri, Mycosphaerella fijiensis, Mycosphaerella pomi, Myrothecium spp., Oidium spp., Oidiopsis spp., Olpidium spp., Peronospora spp., Peronospora mansherica, Pestalotia spp., Phayospora pachyrhizi, Phoma cucurbitacearum, Phomopsis spp., Phomopsis viticola, Phytophthora spp., Phytopthora infestans, Plasmopara viticola, Podosphaera spp., Podosphaera leucotricha, Pseudomonas spp., Pseudomonas syringae, Pseudomonas syringae pv. glycinea, Pseudomonas syringae pv. tomato, Pseudoperonospora spp., Puccinia spp., Puccinia pori, Puccinia sorghi, Pyricularia grisea, Pyricularia oryzae, Pythium spp., Ramularia spp., Rhizoctonia spp., Rhizoctonia solani, Sclerotinia spp., Sclerotinia sclerotiorum, Sclerotium spp., Sclerotium Sclerotium cepivorum, Septoria spp., Septoria glycines, Sphaceloma perseae, Sphaerotheca spp., Sphaerotheca macularis, Sphaerotheca pannosa, Taphrina deformans, Thanatephorus spp., Thielaviopsis basicola, Tillefia barclayana, Uromyces appendiculatus, Uromyces betae, Venturia spp., Verticillium spp., Wilsonomyces carpophilus, Xanthomonas spp., Xanthomonas arbicola pv. pruni, Xanthomonas campestris, Xanthomonas campestris pv. citri, Xanthomonas fragariae, and Zygophiala jamaicensis.

18. The composition of embodiment 16, wherein said plant pest is selected from the group consisting of Ostrinia nubilalis, Agrotis spp., Agrotis orthogonia, Agrotis Ipsilon, Helicoverpa spp., Helicoverpa zeae, Spodoptera spp., Spodoptera frugiperda, Spodoptera exigua, Spodoptera eridania, Diatraea spp., Diatraea grandiosella, Elasmopalpus lignosellus, Diatraea saccharalis, Diabrofica spp., Diabrofica virgifera virgifera, Diabrofica longicornis barberi, Diabrofica undecimpunctata howardi, Melanotus spp., Cyclocephala spp., Cyclocephala borealis, Cyclocephala immaculata, Popillia japonica, Chaetocnema spp., Chaetocnema pulicaria, Sphenophorus maidis, Rhopalosiphum maidis, Anuraphis maidiradicis, Myzus persicae, Nezara viridula, Blissus leucopterus leucopterus, Melanoplus spp., Melanoplus femurrubrum, Melanoplus sanguinipes, Melanoplus differentialis, Hylemya spp., Hylemya platura, Hylemya coarctata, Agromyza parvicornis, Anaphothrips obscrurus, Solenopsis milesta, Tetranychus spp., Tetranychus turkestani, Tetranychus urticae, Chilo partellus, Elasmopalpus lignosellus, Feltia subterranea, Phyllophaga crinita, Eleodes spp., Conoderus spp., Aeolus spp., Oulema melanopus, Sphenophorus maidis, Sipha flava, Blissus leucopterus leucopterus; Contarinia sorghicola, Tetranychus spp., Tetranychus cinnabarinus, Tetranychus urticae, Pseudalefia umpunctata, Hypera punctata, Schizaphis graminum, Macrosiphum avenae, Mayetiola destructor, Sitodiplosis mosellana, Meromyza americana, Frankliniella spp., Frankliniella fusca, Cephus cinctus, Aceria tulipae, Cylindrocupturus adspersus, Smicronyx spp., Smicronyx fulus, Smicronyx sordidus, Suleima helianthana, Homoeosoma electellum, Zygogramma exclamationis, Bothyrus gibbosus, Neolasioptera murtfeldtiana, Heliothis virescens, Pectinophora gossypiella, Anthonomus grandis; Aphis spp., Aphis gossypii, Pseudatomoscelis seriatus, Trialeurodes abufilonea, Lygus spp, Lygus lineolaris, Thrips spp., Thrips tabaci, Colaspis brunnea, Lissorhoptrus oryzophilus, Sitophilus oryzae, Nephotettix nigropictus, Acrosternum hilare, Pseudoplusia includens, Anficarsia gemmatalis, Plathypena scabra, Epilachna varivestis, Empoasca fabae, Acrosternum hilare, Sericothrips variabilis, Schizaphis graminum, Euschistus servus, Jylemya platura, Mayetiola destructor, Petrobia latens, Vrevicoryne brassicae, Phyllotreta spp., Phyllotreta cruciferae, Phyllotreta striolata, Phyllotreta nemorum, Meligethes spp. Meligethes aeneus, Meligethes rufimanus, Meligethes nigrescens, Meligethes canadianus, Meligethes viridescens, Leptinotarsa spp., Leptinotarsa decemlineata, Spartocera batatas, Charidotella (=Metriona) bicolor, Cylas spp., Cylas formicarius, Cylas puncficollis, Cylas brunneus, Naupactus (=Graphognathus) spp., Conoderus spp., Conoderus rudis, Conoderus scissus, Blosyrus spp., Acraea acerata, Agrius convolvuli, Synanthedon spp., Euscepes postfasciatus, Peloropus batatae, Omphisia anastomasalis, and white grubs—larvae of various species of scarabid beetles.

19. The composition of any one of embodiments 16-18, wherein said triazole fungicide comprises at least one of propiconazole, tebuconazole, difenoconazole, tetraconazole, prothioconazole, metconazole, and flutriafol.

20. The composition of any one of embodiments 16-18, wherein said strobilurin fungicide comprises at least one of azoxystrobin, pyraclostrobin, fluoxastrobin, and trifloxystrobin.

21. The composition of any one of embodiments 16-18, wherein said anilide fungicide comprises at least one of fenhexamid, fluotolanil, penflufen, and boscalid.

22. The composition of any one of embodiments 16-18, wherein said aromatic fungicide comprises chlorothalonil. 23. The composition of any one of embodiments 16-18, wherein said aryl phenyl ketone fungicide comprises metrafenone.

24. The composition of any one of embodiments 16-18, wherein said organophosphorus fungicide comprises fosetyl-aluminum.

25. The composition of any one of embodiments 16-18, wherein said pyridine fungicide comprises fluazinam.

26. The composition of any one of embodiments 16-18, wherein said neonicotinoid insecticide comprises acetamiprid.

27. A composition comprising a wettable power comprising

(a) a biocontrol agent, wherein the biocontrol agent comprises:
(i) a cell, a spore, a forespore, or a combination of cells, spores, and/or forespores of one or more of the following bacterial strains: Bacillus amyloliquefaciens D747, Bacillus subtilis strain QST 713, Bacillus subtilis strain AQ30002, Bacillus subtilis strain AQ30004, Bacillus amyloliquefaciens strain GB03, Bacillus pumilus strain QST 2808, Bacillus pumilus strain GB34, Bacillus finnus strain CNMC 1-1582, Streptomyces lydicus strain WYEC108, Streptomyces griseoviridis strain K61, Agrobacterium radiobacter strain 1026, Agrobacterium radiobacter strain K84, Pseudomonas fluorescens strain A506, Bacillus thuringiensis subspecies aizawai strain GC-91, Bacillus thuringiensis subspecies kurstaki, Bacillus thuringiensis subspecies kurstaki strain EG7841, Bacillus thuringiensis subspecies kurstaki strain SA-12, Bacillus thuringiensis subspecies kurstaki strain ABTS-351, Bacillus thuringiensis subspecies kurstaki strain SA-11, Bacillus thuringiensis subspecies tenebrionis strain SA-10, Chromobacterium subtsugae strain PRAA4-1, Isaria fumosorosea Apopka Strain 97, Burkholderia spp. strain A396, and Bacillus thuringiensis subspecies aizawai strain ABTS-1857, or an active variant thereof, wherein the active variant comprises a cell, spore, forespore, or a combination of cells, spores, and/or forespores having a genome within a Mash distance of about 0.015, and/or
(ii) a cell, a spore, or a fungal part such as a piece of mycelium or hyphae, or a combination of cells, spores, and mycelia of one or more of the following fungal strains: Trichoderma harzianum strain KRL-AG2, Trichoderma harzianum strain T-22, Gliochladium vierns, aka Trichoderma vixens, strain GL-21, Coniothyrium minitans strain CON/M/91-8, Purpureocilium lilacinum, Ulocladium oudemansii U3 strain, Ulocladium oudemansii HRU3 strain, Beauveria bassiana strain GHA, or an active variant thereof wherein the active variant comprises a cell, spore, forespore, or a combination of cells, spores, and/or forespores having a genome within a Mash distance of about 0.015, and/or
(iii) a virus or virus isolate of one or more of the following viruses: Cydia pomonella granulovirus, Cydia pomonella granulovirus isolate V22, or polyhedral occlusion bodies of the nuclear polyhedrosis virus of Helicoverpa zea, and/or
(iii) a plant extract derived from Chenopodium ambrosioides or Reynoutria sachalinensis; and

(b) at least one chemical pesticide selected from the group consisting of a triazole fungicide, a strobilurin fungicide, an anilide fungicide, a pyridine fungicide, an aromatic fungicide, an organophosphorus fungicide, an aryl phenyl ketone fungicide, and a neonicotinoid insecticide;

wherein an effective amount of said composition controls a plant pathogen or pest.

28. The composition of embodiment 27, wherein the plant pathogen is selected from the group consisting of Alternaria spp., Alternaria alternate, Alternaria solani, Aspergillus spp., Bipolaris maydis, Botryosphaeria dothidea, Botrytis spp., Botrytis cinerea, Bremia lactucae, Ceratobasidium spp., Cercospora spp., Cercospora nicotianae, Cercosporidium spp., Cladosprium caryigenum, Cochliobolus spp., Cochliobolus heterostrophus, Colletotrichum spp., Colletotrichum acutatum, Colletotrichum coffeanum, Colletotrichum graminicola, Diaporthe spp., Diaporthe citri, Didymella bryoniae, Diplocarpon rosae, Dreschlera spp., Elsinoe fawcetti, Entomosporium spp., Entyloma spp., Erisyphe spp., Erisyphe cichoracearum, Erisyphe graminis, Erisyphe (formerly Uncinula) necator, Erisyphe polygoni, Erwinia spp., Erwinia amylovora, Erwinia carotovora, Eutypa lata, Fusarium spp., Gloeosporium spp., Glomerella spp., Golovinomyces spp., Golovinomyces (Erisyphe) cichoracearum, Gymnosporangium juniperi-virginianae, Helminthosporium spp., Helminthosporium maydis, Hemileia vastatrix, Lanzia spp., Leveillula spp., Macrophomina phaseoli, Macrophomina phaseolina, Magnaporthe spp., Microsphaera diffusa, Moellerodiscus spp., Monilinia spp., Monilinia fructicola, Monilinia laxa, Monilinia vaccinia-corymbosi, Monosporascus cannonballus, Mycosphaerella citri, Mycosphaerella fijiensis, Mycosphaerella pomi, Myrothecium spp., Oidium spp., Oidiopsis spp., Olpidium spp., Peronospora spp., Peronospora mansherica, Pestalofia spp., Phayospora pachyrhizi, Phoma cucurbitacearum, Phomopsis spp., Phomopsis vificola, Phytophthora spp., Phytopthora infestans, Plasmopara vificola, Podosphaera spp., Podosphaera leucotricha, Pseudomonas spp., Pseudomonas syringae, Pseudomonas syringae pv. glycinea, Pseudomonas syringae pv. tomato, Pseudoperonospora spp., Puccinia spp., Puccinia pori, Puccinia sorghi, Pyricularia grisea, Pyricularia oryzae, Pythium spp., Ramularia spp., Rhizoctonia spp., Rhizoctonia solani, Sclerotinia spp., Sclerotinia sclerofiorum, Sclerotium spp., Sclerotium Sclerotium cepivorum, Septoria spp., Septoria glycines, Sphaceloma perseae, Sphaerotheca spp., Sphaerotheca macularis, Sphaerotheca pannosa, Taphrina deformans, Thanatephorus spp., Thielaviopsis basicola, Tillefia barclayana, Uromyces appendiculatus, Uromyces betae, Venturia spp., Verticillium spp., Wilsonomyces carpophilus, Xanthomonas spp., Xanthomonas arbicola pv. pruni, Xanthomonas campestris, Xanthomonas campestris pv. citri, Xanthomonas fragariae, and Zygophiala jamaicensis.

29. The composition of embodiment 27, wherein said plant pest is selected from the group consisting of Ostrinia nubilalis, Agrotis spp., Agrotis orthogonia, Agrotis Ipsilon, Helicoverpa spp., Helicoverpa zeae, Spodoptera spp., Spodoptera frugiperda, Spodoptera exigua, Spodoptera eridania, Diatraea spp., Diatraea grandiosella, Elasmopalpus lignosellus, Diatraea saccharalis, Diabrotica spp., Diabrofica virgifera virgifera, Diabrofica longicornis barberi, Diabrofica undecimpunctata howardi, Melanotus spp., Cyclocephala spp., Cyclocephala borealis, Cyclocephala immaculata, Popillia japonica, Chaetocnema spp., Chaetocnema pulicaria, Sphenophorus maidis, Rhopalosiphum maidis, Anuraphis maidiradicis, Myzus persicae, Nezara viridula, Blissus leucopterus leucopterus, Melanoplus spp., Melanoplus femurrubrum, Melanoplus sanguinipes, Melanoplus differentialis, Hylemya spp., Hylemya platura, Hylemya coarctata, Agromyza parvicornis, Anaphothrips obscrurus, Solenopsis milesta, Tetranychus spp., Tetranychus turkestani, Tetranychus urticae, Chilo partellus, Elasmopalpus lignosellus, Feltia subterranea, Phyllophaga crinita, Eleodes spp., Conoderus spp., Aeolus spp., Oulema melanopus, Sphenophorus maidis, Sipha flava, Blissus leucopterus leucopterus; Contarinia sorghicola, Tetranychus spp., Tetranychus cinnabarinus, Tetranychus urticae, Pseudalefia umpunctata, Hypera punctata, Schizaphis graminum, Macrosiphum avenae, Mayetiola destructor, Sitodiplosis mosellana, Meromyza americana, Frankliniella spp., Frankliniella fusca, Cephus cinctus, Aceria tulipae, Cylindrocupturus adspersus, Smicronyx spp., Smicronyx fulus, Smicronyx sordidus, Suleima helianthana, Homoeosoma electellum, Zygogramma exclamationis, Bothyrus gibbosus, Neolasioptera murtfeldtiana, Heliothis virescens, Pectinophora gossypiella, Anthonomus grandis; Aphis spp., Aphis gossypii, Pseudatomoscelis seriatus, Trialeurodes abufilonea, Lygus spp, Lygus lineolaris, Thrips spp., Thrips tabaci, Colaspis brunnea, Lissorhoptrus oryzophilus, Sitophilus oryzae, Nephotettix nigropictus, Acrosternum hilare, Pseudoplusia includens, Anficarsia gemmatalis, Plathypena scabra, Epilachna varivestis, Empoasca fabae, Acrosternum hilare, Sericothrips variabilis, Schizaphis graminum, Euschistus servus, Jylemya platura, Mayetiola destructor, Petrobia latens, Vrevicoryne brassicae, Phyllotreta spp., Phyllotreta cruciferae, Phyllotreta striolata, Phyllotreta nemorum, Meligethes spp. Meligethes aeneus, Meligethes rufimanus, Meligethes nigrescens, Meligethes canadianus, Meligethes viridescens, Leptinotarsa spp., Leptinotarsa decemlineata, Spartocera batatas, Charidotella (=Metriona) bicolor, Cylas spp., Cylas formicarius, Cylas puncficollis, Cylas brunneus, Naupactus (=Graphognathus) spp., Conoderus spp., Conoderus rudis, Conoderus scissus, Blosyrus spp., Acraea acerata, Agrius convolvuli, Synanthedon spp., Euscepes postfasciatus, Peloropus batatae, Omphisia anastomasalis, and white grubs—larvae of various species of scarabid beetles.

30. The composition of embodiment 27-29, wherein said triazole fungicide comprises at least one of propiconazole, tebuconazole, difenoconazole, tetraconazole, prothioconazole, metconazole, and flutriafol.

31. The composition of embodiment 27-29, wherein said strobilurin fungicide comprises at least one of azoxystrobin, pyraclostrobin, fluoxastrobin, and trifloxystrobin.

32. The composition of embodiment 27-29, wherein said anilide fungicide comprises at least one of fenhexamid, fluotolanil, and boscalid.

33. The composition of embodiment 27-29, wherein said aromatic fungicide comprises chlorothalonil.

34. The composition of embodiment 27-29, wherein said aryl phenyl ketone fungicide comprises metrafenone.

35. The composition of embodiment 27-29, wherein said organophosphorus fungicide comprises fosetyl-aluminum.

36. The composition of embodiment 27-29, wherein said pyridine fungicide comprises fluazinam.

37. The composition of embodiment 27-29, wherein said neonicotinoid insecticide comprises acetamiprid.

38. A method for growing a plant susceptible to a plant pest and/or to a plant disease caused by a plant pathogen, comprising applying to the plant an effective amount of:

(a) a biocontrol agent, wherein the biocontrol agent comprises:
(i) a cell, a spore, a forespore, or a combination of cells, spores, and/or forespores of one or more of the following bacterial strains: Bacillus amyloliquefaciens D747, Bacillus subtilis strain QST 713, Bacillus subtilis strain AQ30002, Bacillus subtilis strain AQ30004, Bacillus amyloliquefaciens strain GB03, Bacillus pumilus strain QST 2808, Bacillus pumilus strain GB34, Bacillus finnus strain CNMC 1-1582, Streptomyces lydicus strain WYEC108, Streptomyces griseoviridis strain K61, Agrobacterium radiobacter strain 1026, Agrobacterium radiobacter strain K84, Pseudomonas fluorescens strain A506, Bacillus thuringiensis subspecies aizawai strain GC-91, Bacillus thuringiensis subspecies kurstaki, Bacillus thuringiensis subspecies kurstaki strain EG7841, Bacillus thuringiensis subspecies kurstaki strain SA-12, Bacillus thuringiensis subspecies kurstaki strain ABTS-351, Bacillus thuringiensis subspecies kurstaki strain SA-11, Bacillus thuringiensis subspecies tenebrionis strain SA-10, Chromobacterium subtsugae strain PRAA4-1, Isaria fumosorosea Apopka Strain 97, Burkholderia spp. strain A396, and Bacillus thuringiensis subspecies aizawai strain ABTS-1857, or an active variant thereof, wherein the active variant comprises a cell, spore, forespore, or a combination of cells, spores, and/or forespores having a genome within a Mash distance of about 0.015, and/or
(ii) a cell, a spore, or a fungal part such as a piece of mycelium or hyphae, or a combination of cells, spores, and mycelia of one or more of the following fungal strains: Trichoderma harzianum strain KRL-AG2, Trichoderma harzianum strain T-22, Gliochladium vierns, aka Trichoderma vixens, strain GL-21, Coniothyrium minitans strain CON/M/91-8, Purpureocilium lilacinum, Ulocladium oudemansii U3 strain, Ulocladium oudemansii HRU3 strain, Beauveria bassiana strain GHA, or an active variant thereof wherein the active variant comprises a cell, spore, forespore, or a combination of cells, spores, and/or forespores having a genome within a Mash distance of about 0.015, and/or
(iii) a virus or virus isolate of one or more of the following viruses: Cydia pomonella granulovirus, Cydia pomonella granulovirus isolate V22, or polyhedral occlusion bodies of the nuclear polyhedrosis virus of Helicoverpa zea, and/or
(iv) a plant extract derived from Chenopodium ambrosioides or Reynoutria sachalinensis; and

(b) at least one chemical pesticide selected from the group consisting of a triazole fungicide, a strobilurin fungicide, an anilide fungicide, a pyridine fungicide, an aromatic fungicide, an organophosphorus fungicide, an aryl phenyl ketone fungicide, and a neonicotinoid insecticide;

wherein an effective amount of said composition controls the plant pathogen and/or plant pest.

39. The method of embodiment 38, wherein said plant pathogen is selected from the group consisting of Alternaria spp., Alternaria alternate, Alternaria solani, Aspergillus spp., Bipolaris maydis, Botryosphaeria dothidea, Botrytis spp., Botrytis cinerea, Bremia lactucae, Ceratobasidium spp., Cercospora spp., Cercospora nicotianae, Cercosporidium spp., Cladosprium caryigenum, Cochliobolus spp., Cochliobolus heterostrophus, Colletotrichum spp., Colletotrichum acutatum, Colletotrichum coffeanum, Colletotrichum graminicola, Diaporthe spp., Diaporthe citri, Didymella bryoniae, Diplocarpon rosae, Dreschlera spp., Elsinoe fawcetti, Entomosporium spp., Entyloma spp., Erisyphe spp., Erisyphe cichoracearum, Erisyphe graminis, Erisyphe (formerly Uncinula) necator, Erisyphe polygoni, Erwinia spp., Erwinia amylovora, Erwinia carotovora, Eutypa lata, Fusarium spp., Gloeosporium spp., Glomerella spp., Golovinomyces spp., Golovinomyces (Erisyphe) cichoracearum, Gymnosporangium juniperi-virginianae, Helminthosporium spp., Helminthosporium maydis, Hemileia vastatrix, Lanzia spp., Leveillula spp., Macrophomina phaseoli, Macrophomina phaseolina, Magnaporthe spp., Microsphaera diffusa, Moellerodiscus spp., Monilinia spp., Monilinia fructicola, Monilinia laxa, Monilinia vaccinia-corymbosi, Monosporascus cannonballus, Mycosphaerella citri, Mycosphaerella fijiensis, Mycosphaerella pomi, Myrothecium spp., Oidium spp., Oidiopsis spp., Olpidium spp., Peronospora spp., Peronospora mansherica, Pestalofia spp., Phayospora pachyrhizi, Phoma cucurbitacearum, Phomopsis spp., Phomopsis vificola, Phytophthora spp., Phytopthora infestans, Plasmopara vificola, Podosphaera spp., Podosphaera leucotricha, Pseudomonas spp., Pseudomonas syringae, Pseudomonas syringae pv. glycinea, Pseudomonas syringae pv. tomato, Pseudoperonospora spp., Puccinia spp., Puccinia pori, Puccinia sorghi, Pyricularia grisea, Pyricularia oryzae, Pythium spp., Ramularia spp., Rhizoctonia spp., Rhizoctonia solani, Sclerotinia spp., Sclerotinia sclerofiorum, Sclerotium spp., Sclerotium rolfsii, Sclerotium cepivorum, Septoria spp., Septoria glycines, Sphaceloma perseae, Sphaerotheca spp., Sphaerotheca macularis, Sphaerotheca pannosa, Taphrina deformans, Thanatephorus spp., Thielaviopsis basicola, Tillefia barclayana, Uromyces appendiculatus, Uromyces betae, Venturia spp., Verticillium spp., Wilsonomyces carpophilus, Xanthomonas spp., Xanthomonas arbicola pv. pruni, Xanthomonas campestris, Xanthomonas campestris pv. citri, Xanthomonas fragariae, and Zygophiala jamaicensis.

40. The method of embodiment 38, wherein said plant pest is selected from the group consisting of Ostrinia nubilalis, Agrotis spp., Agrotis orthogonia, Agrotis Ipsilon, Helicoverpa spp., Helicoverpa zeae, Spodoptera spp., Spodoptera frugiperda, Spodoptera exigua, Spodoptera eridania, Diatraea spp., Diatraea grandiosella, Elasmopalpus lignosellus, Diatraea saccharalis, Diabrotica spp., Diabrofica virgifera virgifera, Diabrofica longicornis barberi, Diabrofica undecimpunctata howardi, Melanotus spp., Cyclocephala spp., Cyclocephala borealis, Cyclocephala immaculata, Popillia japonica, Chaetocnema spp., Chaetocnema pulicaria, Sphenophorus maidis, Rhopalosiphum maidis, Anuraphis maidiradicis, Myzus persicae, Nezara viridula, Blissus leucopterus leucopterus, Melanoplus spp., Melanoplus femurrubrum, Melanoplus sanguinipes, Melanoplus differentialis, Hylemya spp., Hylemya platura, Hylemya coarctata, Agromyza parvicornis, Anaphothrips obscrurus, Solenopsis milesta, Tetranychus spp., Tetranychus turkestani, Tetranychus urticae, Chilo partellus, Elasmopalpus lignosellus, Feltia subterranea, Phyllophaga crinita, Eleodes spp., Conoderus spp., Aeolus spp., Oulema melanopus, Sphenophorus maidis, Sipha flava, Blissus leucopterus leucopterus; Contarinia sorghicola, Tetranychus spp., Tetranychus cinnabarinus, Tetranychus urticae, Pseudalefia umpunctata, Hypera punctata, Schizaphis graminum, Macrosiphum avenae, Mayetiola destructor, Sitodiplosis mosellana, Meromyza americana, Frankliniella spp., Frankliniella fusca, Cephus cinctus, Aceria tulipae, Cylindrocupturus adspersus, Smicronyx spp., Smicronyx fulus, Smicronyx sordidus, Suleima helianthana, Homoeosoma electellum, Zygogramma exclamationis, Bothyrus gibbosus, Neolasioptera murtfeldtiana, Heliothis virescens, Pectinophora gossypiella, Anthonomus grandis; Aphis spp., Aphis gossypii, Pseudatomoscelis seriatus, Trialeurodes abutilonea, Lygus spp, Lygus lineolaris, Thrips spp., Thrips tabaci, Colaspis brunnea, Lissorhoptrus oryzophilus, Sitophilus oryzae, Nephotettix nigropictus, Acrosternum hilare, Pseudoplusia includens, Anficarsia gemmatalis, Plathypena scabra, Epilachna varivestis, Empoasca fabae, Acrosternum hilare, Sericothrips variabilis, Schizaphis graminum, Euschistus servus, Jylemya platura, Mayetiola destructor, Petrobia latens, Vrevicoryne brassicae, Phyllotreta spp., Phyllotreta cruciferae, Phyllotreta striolata, Phyllotreta nemorum, Meligethes spp. Meligethes aeneus, Meligethes rufimanus, Meligethes nigrescens, Meligethes canadianus, Meligethes viridescens, Leptinotarsa spp., Leptinotarsa decemlineata, Spartocera batatas, Charidotella (=Metriona) bicolor, Cylas spp., Cylas formicarius, Cylas puncticollis, Cylas brunneus, Naupactus (=Graphognathus) spp., Conoderus spp., Conoderus rudis, Conoderus scissus, Blosyrus spp., Acraea acerata, Agrius convolvuli, Synanthedon spp., Euscepes postfasciatus, Peloropus batatae, Omphisia anastomasalis, and white grubs—larvae of various species of scarabid beetles.

41. The method of any one of embodiments 38-40, wherein said method increases yield of the plant susceptible to the plant disease and/or the plant pest.

42. The method of any one of embodiments 38-40, wherein the biocontrol agent and the at least one pesticide are applied simultaneously.

43. The method of any one of embodiments 38-40, wherein the biocontrol agent and the at least one pesticide are applied sequentially.

44. The method of any one of embodiments 38-43, wherein said triazole fungicide comprises at least one of propiconazole, tebuconazole, difenoconazole, tetraconazole, prothioconazole, metconazole, and flutriafol.

45. The method of any one of embodiments 38-43, wherein said strobilurin fungicide comprises at least one of azoxystrobin, pyraclostrobin, fluoxastrobin, and trifloxystrobin.

46. The method of any one of embodiments 38-43, wherein said anilide fungicide comprises at least one of fenhexamid, fluotolanil, and boscalid.

47. The method of any one of embodiments 38-43, wherein said aromatic fungicide comprises chlorothalonil.

48. The method of any one of embodiments 38-43, wherein said aryl phenyl ketone fungicide comprises metrafenone.

49. The method of any one of embodiments 38-43, wherein said organophosphorus fungicide comprises fosetyl-aluminum.

50. The composition of any one of embodiments 38-43, wherein said pyridine fungicide comprises fluazinam.

51. The composition of any one of embodiments 38-43, wherein said neonicotinoid insecticide comprises acetamiprid.

52. A method of controlling a plant pathogen and/or plant pest in an area of cultivation comprising:

(a) planting the area of cultivation with seeds or plants susceptible to the plant pathogen and/or plant pest, and

(b) applying to the plant susceptible to the plant pathogen and/or pest an effective amount of:
(i) a biocontrol agent, wherein the biocontrol agent comprises:
   (1) a cell, a spore, a forespore, or a combination of cells, spores, and/or forespores of one or more of the following bacterial strains: Bacillus amyloliquefaciens D747, Bacillus subtilis strain QST 713, Bacillus subtilis strain AQ30002, Bacillus subtilis strain AQ30004, Bacillus amyloliquefaciens strain GB03, Bacillus pumilus strain QST 2808, Bacillus pumilus strain GB34, Bacillus finnus strain CNMC 1-1582, Streptomyces lydicus strain WYEC108, Streptomyces griseoviridis strain K61, Agrobacterium radiobacter strain 1026, Agrobacterium radiobacter strain K84, Pseudomonas fluorescens strain A506, Bacillus thuringiensis subspecies aizawai strain GC-91, Bacillus thuringiensis subspecies kurstaki, Bacillus thuringiensis subspecies kurstaki strain EG7841, Bacillus thuringiensis subspecies kurstaki strain SA-12, Bacillus thuringiensis subspecies kurstaki strain ABTS-351, Bacillus thuringiensis subspecies kurstaki strain SA-11, Bacillus thuringiensis subspecies tenebrionis strain SA-10, Chromobacterium subtsugae strain PRAA4-1, Isaria fumosorosea Apopka Strain 97, Burkholderia spp. strain A396, and Bacillus thuringiensis subspecies aizawai strain ABTS-1857, or an active variant thereof, wherein the active variant comprises a cell, spore, forespore, or a combination of cells, spores, and/or forespores having a genome within a Mash distance of about 0.015, and/or
   (2) a cell, a spore, or a fungal part such as a piece of mycelium or hyphae, or a combination of cells, spores, and mycelia of one or more of the following fungal strains: Trichoderma harzianum strain KRL-AG2, Trichoderma harzianum strain T-22, Gliochladium vierns, aka Trichoderma vixens, strain GL-21, Coniothyrium minitans strain CON/M/91-8, Purpureocilium lilacinum, Ulocladium oudemansii U3 strain, Ulocladium oudemansii HRU3 strain, Beauveria bassiana strain GHA, or an active variant thereof wherein the active variant comprises a cell, spore, forespore, or a combination of cells, spores, and/or forespores having a genome within a Mash distance of about 0.015, and/or
   (3) a virus or virus isolate of one or more of the following viruses: Cydia pomonella granulovirus, Cydia pomonella granulovirus isolate V22, or polyhedral occlusion bodies of the nuclear polyhedrosis virus of Helicoverpa zea, and/or
   (4) a plant extract derived from Chenopodium ambrosioides or Reynoutria sachalinensis; and
(ii) at least one chemical pesticide selected from the group consisting of a triazole fungicide, a strobilurin fungicide, an anilide fungicide, a pyridine fungicide, an aromatic fungicide, an organophosphorus fungicide, an aryl phenyl ketone fungicide, and a neonicotinoid insecticide;

wherein an effective amount of said composition controls a plant pathogen and/or plant pest.

53. The method of embodiment 52, wherein the plant pathogen is selected from the group consisting of Alternaria spp., Alternaria alternate, Alternaria solani, Aspergillus spp., Bipolaris maydis, Botryosphaeria dothidea, Botrytis spp., Botrytis cinerea, Bremia lactucae, Ceratobasidium spp., Cercospora spp., Cercospora nicotianae, Cercosporidium spp., Cladosprium caryigenum, Cochliobolus spp., Cochliobolus heterostrophus, Colletotrichum spp., Colletotrichum acutatum, Colletotrichum coffeanum, Colletotrichum graminicola, Diaporthe spp., Diaporthe citri, Didymella bryoniae, Diplocarpon rosae, Dreschlera spp., Elsinoe fawcetti, Entomosporium spp., Entyloma spp., Erisyphe spp., Erisyphe cichoracearum, Erisyphe graminis, Erisyphe (formerly Uncinula) necator, Erisyphe polygoni, Erwinia spp., Erwinia amylovora, Erwinia carotovora, Eutypa lata, Fusarium spp., Gloeosporium spp., Glomerella spp., Golovinomyces spp., Golovinomyces (Erisyphe) cichoracearum, Gymnosporangium juniperi-virginianae, Helminthosporium spp., Helminthosporium maydis, Hemileia vastatrix, Lanzia spp., Leveillula spp., Macrophomina phaseoli, Macrophomina phaseolina, Magnaporthe spp., Microsphaera diffusa, Moellerodiscus spp., Monilinia spp., Monilinia fructicola, Monilinia laxa, Monilinia vaccinia-corymbosi, Monosporascus cannonballus, Mycosphaerella citri, Mycosphaerella fijiensis, Mycosphaerella pomi, Myrothecium spp., Oidium spp., Oidiopsis spp., Olpidium spp., Peronospora spp., Peronospora mansherica, Pestalofia spp., Phayospora pachyrhizi, Phoma cucurbitacearum, Phomopsis spp., Phomopsis vificola, Phytophthora spp., Phytopthora infestans, Plasmopara viticola, Podosphaera spp., Podosphaera leucotricha, Pseudomonas spp., Pseudomonas syringae, Pseudomonas syringae pv. glycinea, Pseudomonas syringae pv. tomato, Pseudoperonospora spp., Puccinia spp., Puccinia pori, Puccinia sorghi, Pyricularia grisea, Pyricularia oryzae, Pythium spp., Ramularia spp., Rhizoctonia spp., Rhizoctonia solani, Sclerotinia spp., Sclerotinia sclerofiorum, Sclerotium spp., Sclerotium rolfsii, Sclerotium cepivorum, Septoria spp., Septoria glycines, Sphaceloma perseae, Sphaerotheca spp., Sphaerotheca macularis, Sphaerotheca pannosa, Taphrina deformans, Thanatephorus spp., Thielaviopsis basicola, Tillefia barclayana, Uromyces appendiculatus, Uromyces betae, Venturia spp., Verticillium spp., Wilsonomyces carpophilus, Xanthomonas spp., Xanthomonas arbicola pv. pruni, Xanthomonas campestris, Xanthomonas campestris pv. citri, Xanthomonas fragariae, and Zygophiala jamaicensis.

54. The method of embodiment 52, wherein said plant pest is selected from the group consisting of Ostrinia nubilalis, Agrotis spp., Agrotis orthogonia, Agrotis Ipsilon, Helicoverpa spp., Helicoverpa zeae, Spodoptera spp., Spodoptera frugiperda, Spodoptera exigua, Spodoptera eridania, Diatraea spp., Diatraea grandiosella, Elasmopalpus lignosellus, Diatraea saccharalis, Diabrotica spp., Diabrotica virgifera virgifera, Diabrotica longicornis barberi, Diabrotica undecimpunctata howardi, Melanotus spp., Cyclocephala spp., Cyclocephala borealis, Cyclocephala immaculata, Popillia japonica, Chaetocnema spp., Chaetocnema pulicaria, Sphenophorus maidis, Rhopalosiphum maidis, Anuraphis maidiradicis, Myzus persicae, Nezara viridula, Blissus leucopterus leucopterus, Melanoplus spp., Melanoplus femurrubrum, Melanoplus sanguinipes, Melanoplus differentialis, Hylemya spp., Hylemya platura, Hylemya coarctata, Agromyza parvicornis, Anaphothrips obscrurus, Solenopsis milesta, Tetranychus spp., Tetranychus turkestani, Tetranychus urticae, Chilo partellus, Elasmopalpus lignosellus, Feltia subterranea, Phyllophaga crinita, Eleodes spp., Conoderus spp., Aeolus spp., Oulema melanopus, Sphenophorus maidis, Sipha flava, Blissus leucopterus leucopterus; Contarinia sorghicola, Tetranychus spp., Tetranychus cinnabarinus, Tetranychus urticae, Pseudalefia unipunctata, Hypera punctata, Schizaphis graminum, Macrosiphum avenae, Mayetiola destructor, Sitodiplosis mosellana, Meromyza americana, Frankliniella spp., Frankliniella fusca, Cephus cinctus, Aceria tulipae, Cylindrocupturus adspersus, Smicronyx spp., Smicronyx fulus, Smicronyx sordidus, Suleima helianthana, Homoeosoma electellum, Zygogramma exclamationis, Bothyrus gibbosus, Neolasioptera murtfeldtiana, Heliothis virescens, Pectinophora gossypiella, Anthonomus grandis; Aphis spp., Aphis gossypii, Pseudatomoscelis seriatus, Trialeurodes abufilonea, Lygus spp, Lygus lineolaris, Thrips spp., Thrips tabaci, Colaspis brunnea, Lissorhoptrus oryzophilus, Sitophilus oryzae, Nephotettix nigropictus, Acrosternum hilare, Pseudoplusia includens, Anficarsia gemmatalis, Plathypena scabra, Epilachna varivestis, Empoasca fabae, Acrosternum hilare, Sericothrips variabilis, Schizaphis graminum, Euschistus servus, Jylemya platura, Mayetiola destructor, Petrobia latens, Vrevicoryne brassicae, Phyllotreta spp., Phyllotreta cruciferae, Phyllotreta striolata, Phyllotreta nemorum, Meligethes spp. Meligethes aeneus, Meligethes rufimanus, Meligethes nigrescens, Meligethes canadianus, Meligethes viridescens, Leptinotarsa spp., Leptinotarsa decemlineata, Spartocera batatas, Charidotella (=Metriona) bicolor, Cylas spp., Cylas formicarius, Cylas puncficollis, Cylas brunneus, Naupactus (=Graphognathus) spp., Conoderus spp., Conoderus rudis, Conoderus scissus, Blosyrus spp., Acraea acerata, Agrius convolvuli, Synanthedon spp., Euscepes postfasciatus, Peloropus batatae, Omphisia anastomasalis, and white grubs—larvae of various species of scarabid beetles.

55. The method of any one of embodiments 52-54, wherein the biocontrol agent and the at least one pesticide are applied simultaneously.

56. The method of any one of embodiments 52-54, wherein the biocontrol agent and the at least one pesticide are applied sequentially.

57. The method of any one of embodiments 52-56, wherein said triazole fungicide comprises at least one of propiconazole, tebuconazole, difenoconazole, tetraconazole, prothioconazole, metconazole, and flutriafol.

58. The method of any one of embodiments 52-56, wherein said strobilurin fungicide comprises at least one of azoxystrobin, pyraclostrobin, fluoxastrobin, and trifloxystrobin.

59. The method of any one of embodiments 52-56, wherein said anilide fungicide comprises at least one of fenhexamid, fluotolanil, and boscalid.

60. The method of any one of embodiments 52-56, wherein said aromatic fungicide comprises chlorothalonil.

61. The method of any one of embodiments 52-56, wherein said aryl phenyl ketone fungicide comprises metrafenone.

62. The method of any one of embodiments 52-56, wherein said organophosphorus fungicide comprises fosetyl-aluminum.

63. The composition of any one of embodiments 52-56, wherein said pyridine fungicide comprises fluazinam.

64. The composition of any one of embodiments 52-56, wherein said neonicotinoid insecticide comprises acetamiprid.

65. A method of treating or preventing a plant pest infestation and/or a plant disease caused by a plant pathogen, comprising applying to a plant having said infestation or disease, or to a plant at risk of developing said infestation or disease, an effective amount of:

(a) a biocontrol agent, wherein the biocontrol agent comprises:
(i) a cell, a spore, a forespore, or a combination of cells, spores, and/or forespores of one or more of the following bacterial strains: Bacillus amyloliquefaciens D747, Bacillus subtilis strain QST 713, Bacillus subtilis strain AQ30002, Bacillus subtilis strain AQ30004, Bacillus amyloliquefaciens strain GB03, Bacillus pumilus strain QST 2808, Bacillus pumilus strain GB34, Bacillus finnus strain CNMC 1-1582, Streptomyces lydicus strain WYEC108, Streptomyces griseoviridis strain K61, Agrobacterium radiobacter strain 1026, Agrobacterium radiobacter strain K84, Pseudomonas fluorescens strain A506, Bacillus thuringiensis subspecies aizawai strain GC-91, Bacillus thuringiensis subspecies kurstaki, Bacillus thuringiensis subspecies kurstaki strain EG7841, Bacillus thuringiensis subspecies kurstaki strain SA-12, Bacillus thuringiensis subspecies kurstaki strain ABTS-351, Bacillus thuringiensis subspecies kurstaki strain SA-11, Bacillus thuringiensis subspecies tenebrionis strain SA-10, Chromobacterium subtsugae strain PRAA4-1, Isaria fumosorosea Apopka Strain 97, Burkholderia spp. strain A396, and Bacillus thuringiensis subspecies aizawai strain ABTS-1857, or an active variant thereof, wherein the active variant comprises a cell, spore, forespore, or a combination of cells, spores, and/or forespores having a genome within a Mash distance of about 0.015, and/or
(ii) a cell, a spore, or a fungal part such as a piece of mycelium or hyphae, or a combination of cells, spores, and mycelia of one or more of the following fungal strains: Trichoderma harzianum strain KRL-AG2, Trichoderma harzianum strain T-22, Gliochladium vierns, aka Trichoderma virens, strain GL-21, Coniothyrium minitans strain CON/M/91-8, Purpureocilium lilacinum, Ulocladium oudemansii U3 strain, Ulocladium oudemansii HRU3 strain, Beauveria bassiana strain GHA, or an active variant thereof wherein the active variant comprises a cell, spore, forespore, or a combination of cells, spores, and/or forespores having a genome within a Mash distance of about 0.015, and/or
(iii) a virus or virus isolate of one or more of the following viruses: Cydia pomonella granulovirus, Cydia pomonella granulovirus isolate V22, or polyhedral occlusion bodies of the nuclear polyhedrosis virus of Helicoverpa zea, and/or
(iv) a plant extract derived from Chenopodium ambrosioides or Reynoutria sachalinensis; and

(b) at least one chemical pesticide selected from the group consisting of a triazole fungicide, a strobilurin fungicide, an anilide fungicide, a pyridine fungicide, an aromatic fungicide, an organophosphorus fungicide, an aryl phenyl ketone fungicide, and a neonicotinoid insecticide;

wherein an effective amount of said composition controls the plant pathogen and/or plant pest that causes the plant disease or infestation.

66. The method of embodiment 65, wherein the plant pathogen is selected from the group consisting of Alternaria spp., Alternaria alternate, Alternaria solani, Aspergillus spp., Bipolaris maydis, Botryosphaeria dothidea, Botrytis spp., Botrytis cinerea, Bremia lactucae, Ceratobasidium spp., Cercospora spp., Cercospora nicotianae, Cercosporidium spp., Cladosprium caryigenum, Cochliobolus spp., Cochliobolus heterostrophus, Colletotrichum spp., Colletotrichum acutatum, Colletotrichum coffeanum, Colletotrichum graminicola, Diaporthe spp., Diaporthe citri, Didymella bryoniae, Diplocarpon rosae, Dreschlera spp., Elsinoe fawcetti, Entomosporium spp., Entyloma spp., Erisyphe spp., Erisyphe cichoracearum, Erisyphe graminis, Erisyphe (formerly Uncinula) necator, Erisyphe polygoni, Erwinia spp., Erwinia amylovora, Erwinia carotovora, Eutypa lata, Fusarium spp., Gloeosporium spp., Glomerella spp., Golovinomyces spp., Golovinomyces (Erisyphe) cichoracearum, Gymnosporangium juniperi-virginianae, Helminthosporium spp., Helminthosporium maydis, Hemileia vastatrix, Lanzia spp., Leveillula spp., Macrophomina phaseoli, Macrophomina phaseolina, Magnaporthe spp., Microsphaera diffusa, Moellerodiscus spp., Monilinia spp., Monilinia fructicola, Monilinia laxa, Monilinia vaccinia-corymbosi, Monosporascus cannonballus, Mycosphaerella citri, Mycosphaerella fijiensis, Mycosphaerella pomi, Myrothecium spp., Oidium spp., Oidiopsis spp., Olpidium spp., Peronospora spp., Peronospora mansherica, Pestalofia spp., Phayospora pachyrhizi, Phoma cucurbitacearum, Phomopsis spp., Phomopsis vificola, Phytophthora spp., Phytopthora infestans, Plasmopara viticola, Podosphaera spp., Podosphaera leucotricha, Pseudomonas spp., Pseudomonas syringae, Pseudomonas syringae pv. glycinea, Pseudomonas syringae pv. tomato, Pseudoperonospora spp., Puccinia spp., Puccinia pori, Puccinia sorghi, Pyricularia grisea, Pyricularia oryzae, Pythium spp., Ramularia spp., Rhizoctonia spp., Rhizoctonia solani, Sclerotinia spp., Sclerotinia sclerofiorum, Sclerotium spp., Sclerotium rolfsii, Sclerotium cepivorum, Septoria spp., Septoria glycines, Sphaceloma perseae, Sphaerotheca spp., Sphaerotheca macularis, Sphaerotheca pannosa, Taphrina deformans, Thanatephorus spp., Thielaviopsis basicola, Tillefia barclayana, Uromyces appendiculatus, Uromyces betae, Venturia spp., Verticillium spp., Wilsonomyces carpophilus, Xanthomonas spp., Xanthomonas arbicola pv. pruni, Xanthomonas campestris, Xanthomonas campestris pv. citri, Xanthomonas fragariae, and Zygophiala jamaicensis.

67. The method of embodiment 65, wherein said plant pest is selected from the group consisting of Ostrinia nubilalis, Agrotis spp., Agrotis orthogonia, Agrotis Ipsilon, Helicoverpa spp., Helicoverpa zeae, Spodoptera spp., Spodoptera frugiperda, Spodoptera exigua, Spodoptera eridania, Diatraea spp., Diatraea grandiosella, Elasmopalpus lignosellus, Diatraea saccharalis, Diabrotica spp., Diabrofica virgifera virgifera, Diabrofica longicornis barberi, Diabrofica undecimpunctata howardi, Melanotus spp., Cyclocephala spp., Cyclocephala borealis, Cyclocephala immaculata, Popillia japonica, Chaetocnema spp., Chaetocnema pulicaria, Sphenophorus maidis, Rhopalosiphum maidis, Anuraphis maidiradicis, Myzus persicae, Nezara viridula, Blissus leucopterus leucopterus, Melanoplus spp., Melanoplus femurrubrum, Melanoplus sanguinipes, Melanoplus differentialis, Hylemya spp., Hylemya platura, Hylemya coarctata, Agromyza parvicornis, Anaphothrips obscrurus, Solenopsis milesta, Tetranychus spp., Tetranychus turkestani, Tetranychus urticae, Chilo partellus, Elasmopalpus lignosellus, Feltia subterranea, Phyllophaga crinita, Eleodes spp., Conoderus spp., Aeolus spp., Oulema melanopus, Sphenophorus maidis, Sipha flava, Blissus leucopterus leucopterus; Contarinia sorghicola, Tetranychus spp., Tetranychus cinnabarinus, Tetranychus urticae, Pseudalefia umpunctata, Hypera punctata, Schizaphis graminum, Macrosiphum avenae, Mayetiola destructor, Sitodiplosis mosellana, Meromyza americana, Frankliniella spp., Frankliniella fusca, Cephus cinctus, Aceria tulipae, Cylindrocupturus adspersus, Smicronyx spp., Smicronyx fulus, Smicronyx sordidus, Suleima helianthana, Homoeosoma electellum, Zygogramma exclamationis, Bothyrus gibbosus, Neolasioptera murtfeldtiana, Heliothis virescens, Pectinophora gossypiella, Anthonomus grandis; Aphis spp., Aphis gossypii, Pseudatomoscelis seriatus, Trialeurodes abufilonea, Lygus spp, Lygus lineolaris, Thrips spp., Thrips tabaci, Colaspis brunnea, Lissorhoptrus oryzophilus, Sitophilus oryzae, Nephotettix nigropictus, Acrosternum hilare, Pseudoplusia includens, Anficarsia gemmatalis, Plathypena scabra, Epilachna varivestis, Empoasca fabae, Acrosternum hilare, Sericothrips variabilis, Schizaphis graminum, Euschistus servus, Jylemya platura, Mayetiola destructor, Petrobia latens, Vrevicoryne brassicae, Phyllotreta spp., Phyllotreta cruciferae, Phyllotreta striolata, Phyllotreta nemorum, Meligethes spp. Meligethes aeneus, Meligethes rufimanus, Meligethes nigrescens, Meligethes canadianus, Meligethes viridescens, Leptinotarsa spp., Leptinotarsa decemlineata, Spartocera batatas, Charidotella (=Metriona) bicolor, Cylas spp., Cylas formicarius, Cylas puncficollis, Cylas brunneus, Naupactus (=Graphognathus) spp., Conoderus spp., Conoderus rudis, Conoderus scissus, Blosyrus spp., Acraea acerata, Agrius convolvuli, Synanthedon spp., Euscepes postfasciatus, Peloropus batatae, Omphisia anastomasalis, and white grubs—larvae of various species of scarabid beetles.

68. The method of any one of embodiments 65-67, wherein the biocontrol agent and the at least one fungicide are applied simultaneously.

69. The method of any one of embodiments 65-67, wherein the biocontrol agent and the at least one fungicide are applied sequentially.

70. The method of any one of embodiments 65-69, wherein said triazole fungicide comprises at least one of propiconazole, tebuconazole, difenoconazole, tetraconazole, prothioconazole, metconazole, and flutriafol.

71. The method of any one of embodiments 65-69, wherein said strobilurin fungicide comprises at least one of azoxystrobin, pyraclostrobin, fluoxastrobin, and trifloxystrobin.

72. The method of any one of embodiments 65-69, wherein said anilide fungicide comprises at least one of fenhexamid, fluotolanil, and boscalid.

73. The method of any one of embodiments 65-69, wherein said aromatic fungicide comprises chlorothalonil.

74. The method of any one of embodiments 65-69, wherein said aryl phenyl ketone fungicide comprises metrafenone.

75. The method of any one of embodiments 65-69, wherein said organophosphorus fungicide comprises fosetyl-aluminum.

76. The method of any one of embodiments 65-69, wherein said pyridine fungicide comprises fluazinam.

77. The method of any one of embodiments 65-69, wherein said neonicotinoid insecticide comprises acetamiprid.

78. A method for controlling a plant pathogen or plant pest population comprising contacting said population with an effective amount of:

(a) a biocontrol agent, wherein the biocontrol agent comprises:
(i) a cell, a spore, a forespore, or a combination of cells, spores, and/or forespores of one or more of the following bacterial strains: Bacillus amyloliquefaciens D747, Bacillus subtilis strain QST 713, Bacillus subtilis strain AQ30002, Bacillus subtilis strain AQ30004, Bacillus amyloliquefaciens strain GB03, Bacillus pumilus strain QST 2808, Bacillus pumilus strain GB34, Bacillus finnus strain CNMC 1-1582, Streptomyces lydicus strain WYEC108, Streptomyces griseoviridis strain K61, Agrobacterium radiobacter strain 1026, Agrobacterium radiobacter strain K84, Pseudomonas fluorescens strain A506, Bacillus thuringiensis subspecies aizawai strain GC-91, Bacillus thuringiensis subspecies kurstaki, Bacillus thuringiensis subspecies kurstaki strain EG7841, Bacillus thuringiensis subspecies kurstaki strain SA-12, Bacillus thuringiensis subspecies kurstaki strain ABTS-351, Bacillus thuringiensis subspecies kurstaki strain SA-11, Bacillus thuringiensis subspecies tenebrionis strain SA-10, Chromobacterium subtsugae strain PRAA4-1, Isaria fumosorosea Apopka Strain 97, Burkholderia spp. strain A396, and Bacillus thuringiensis subspecies aizawai strain ABTS-1857, or an active variant thereof, wherein the active variant comprises a cell, spore, forespore, or a combination of cells, spores, and/or forespores having a genome within a Mash distance of about 0.015, and/or
(ii) a cell, a spore, or a fungal part such as a piece of mycelium or hyphae, or a combination of cells, spores, and mycelia of one or more of the following fungal strains: Trichoderma harzianum strain KRL-AG2, Trichoderma harzianum strain T-22, Gliochladium vierns, aka Trichoderma vixens, strain GL-21, Coniothyrium minitans strain CON/M/91-8, Purpureocilium lilacinum, Ulocladium oudemansii U3 strain, Ulocladium oudemansii HRU3 strain, Beauveria bassiana strain GHA, or an active variant thereof wherein the active variant comprises a cell, spore, forespore, or a combination of cells, spores, and/or forespores having a genome within a Mash distance of about 0.015, and/or
(iii) a virus or virus isolate of one or more of the following viruses: Cydia pomonella granulovirus, Cydia pomonella granulovirus isolate V22, or polyhedral occlusion bodies of the nuclear polyhedrosis virus of Helicoverpa zea, and/or
(iv) a plant extract derived from Chenopodium ambrosioides or Reynoutria sachalinensis; and

(b) at least one chemical pesticide selected from the group consisting of a triazole fungicide, a strobilurin fungicide, an anilide fungicide, a pyridine fungicide, an aromatic fungicide, an organophosphorus fungicide, an aryl phenyl ketone fungicide, and a neonicotinoid insecticide;

wherein an effective amount of said composition controls the plant pathogen and/or plant pest population.

79. The method of embodiment 78, wherein the fungal plant pathogen is selected from the group consisting of Alternaria spp., Alternaria alternate, Alternaria solani, Aspergillus spp., Bipolaris maydis, Botryosphaeria dothidea, Botrytis spp., Botrytis cinerea, Bremia lactucae, Ceratobasidium spp., Cercospora spp., Cercospora nicotianae, Cercosporidium spp., Cladosprium caryigenum, Cochliobolus spp., Cochliobolus heterostrophus, Colletotrichum spp., Colletotrichum acutatum, Colletotrichum coffeanum, Colletotrichum graminicola, Diaporthe spp., Diaporthe citri, Didymella bryoniae, Diplocarpon rosae, Dreschlera spp., Elsinoe fawcetti, Entomosporium spp., Entyloma spp., Erisyphe spp., Erisyphe cichoracearum, Erisyphe graminis, Erisyphe (formerly Uncinula) necator, Erisyphe polygoni, Erwinia spp., Erwinia amylovora, Erwinia carotovora, Eutypa lata, Fusarium spp., Gloeosporium spp., Glomerella spp., Golovinomyces spp., Golovinomyces (Erisyphe) cichoracearum, Gymnosporangium juniperi-virginianae, Helminthosporium spp., Helminthosporium maydis, Hemileia vastatrix, Lanzia spp., Leveillula spp., Macrophomina phaseoli, Macrophomina phaseolina, Magnaporthe spp., Microsphaera diffusa, Moellerodiscus spp., Monilinia spp., Monilinia fructicola, Monilinia laxa, Monilinia vaccinia-corymbosi, Monosporascus cannonballus, Mycosphaerella citri, Mycosphaerella fijiensis, Mycosphaerella pomi, Myrothecium spp., Oidium spp., Oidiopsis spp., Olpidium spp., Peronospora spp., Peronospora mansherica, Pestalofia spp., Phayospora pachyrhizi, Phoma cucurbitacearum, Phomopsis spp., Phomopsis viticola, Phytophthora spp., Phytopthora infestans, Plasmopara vificola, Podosphaera spp., Podosphaera leucotricha, Pseudomonas spp., Pseudomonas syringae, Pseudomonas syringae pv. glycinea, Pseudomonas syringae pv. tomato, Pseudoperonospora spp., Puccinia spp., Puccinia pori, Puccinia sorghi, Pyricularia grisea, Pyricularia oryzae, Pythium spp., Ramularia spp., Rhizoctonia spp., Rhizoctonia solani, Sclerotinia spp., Sclerotinia sclerofiorum, Sclerotium spp., Sclerotium Sclerotium cepivorum, Septoria spp., Septoria glycines, Sphaceloma perseae, Sphaerotheca spp., Sphaerotheca macularis, Sphaerotheca pannosa, Taphrina deformans, Thanatephorus spp., Thielaviopsis basicola, Tillefia barclayana, Uromyces appendiculatus, Uromyces betae, Venturia spp., Verticillium spp., Wilsonomyces carpophilus, Xanthomonas spp., Xanthomonas arbicola pv. pruni, Xanthomonas campestris, Xanthomonas campestris pv. citri, Xanthomonas fragariae, and Zygophiala jamaicensis.

80. The method of embodiment 78, wherein said plant pest is selected from the group consisting of Ostrinia nubilalis, Agrotis spp., Agrotis orthogonia, Agrotis Ipsilon, Helicoverpa spp., Helicoverpa zeae, Spodoptera spp., Spodoptera frugiperda, Spodoptera exigua, Spodoptera eridania, Diatraea spp., Diatraea grandiosella, Elasmopalpus lignosellus, Diatraea saccharalis, Diabrotica spp., Diabrofica virgifera virgifera, Diabrofica longicornis barberi, Diabrofica undecimpunctata howardi, Melanotus spp., Cyclocephala spp., Cyclocephala borealis, Cyclocephala immaculata, Popillia japonica, Chaetocnema spp., Chaetocnema pulicaria, Sphenophorus maidis, Rhopalosiphum maidis, Anuraphis maidiradicis, Myzus persicae, Nezara viridula, Blissus leucopterus leucopterus, Melanoplus spp., Melanoplus femurrubrum, Melanoplus sanguinipes, Melanoplus differentialis, Hylemya spp., Hylemya platura, Hylemya coarctata, Agromyza parvicornis, Anaphothrips obscrurus, Solenopsis milesta, Tetranychus spp., Tetranychus turkestani, Tetranychus urticae, Chilo partellus, Elasmopalpus lignosellus, Feltia subterranea, Phyllophaga crinita, Eleodes spp., Conoderus spp., Aeolus spp., Oulema melanopus, Sphenophorus maidis, Sipha flava, Blissus leucopterus leucopterus; Contarinia sorghicola, Tetranychus spp., Tetranychus cinnabarinus, Tetranychus urticae, Pseudalefia umpunctata, Hypera punctata, Schizaphis graminum, Macrosiphum avenae, Mayetiola destructor, Sitodiplosis mosellana, Meromyza americana, Frankliniella spp., Frankliniella fusca, Cephus cinctus, Aceria tulipae, Cylindrocupturus adspersus, Smicronyx spp., Smicronyx fulus, Smicronyx sordidus, Suleima helianthana, Homoeosoma electellum, Zygogramma exclamationis, Bothyrus gibbosus, Neolasioptera murtfeldtiana, Heliothis virescens, Pectinophora gossypiella, Anthonomus grandis; Aphis spp., Aphis gossypii, Pseudatomoscelis seriatus, Trialeurodes abufilonea, Lygus spp, Lygus lineolaris, Thrips spp., Thrips tabaci, Colaspis brunnea, Lissorhoptrus oryzophilus, Sitophilus oryzae, Nephotettix nigropictus, Acrosternum hilare, Pseudoplusia includens, Anficarsia gemmatalis, Plathypena scabra, Epilachna varivestis, Empoasca fabae, Acrosternum hilare, Sericothrips variabilis, Schizaphis graminum, Euschistus servus, Jylemya platura, Mayetiola destructor, Petrobia latens, Vrevicoryne brassicae, Phyllotreta spp., Phyllotreta cruciferae, Phyllotreta striolata, Phyllotreta nemorum, Meligethes spp. Meligethes aeneus, Meligethes rufimanus, Meligethes nigrescens, Meligethes canadianus, Meligethes viridescens, Leptinotarsa spp., Leptinotarsa decemlineata, Spartocera batatas, Charidotella (=Metriona) bicolor, Cylas spp., Cylas formicarius, Cylas puncficollis, Cylas brunneus, Naupactus (=Graphognathus) spp., Conoderus spp., Conoderus rudis, Conoderus scissus, Blosyrus spp., Acraea acerata, Agrius convolvuli, Synanthedon spp., Euscepes postfasciatus, Peloropus batatae, Omphisia anastomasalis, and white grubs—larvae of various species of scarabid beetles.

81. The method of any one of embodiments 78-80, wherein said population is contacted with the biocontrol agent and the at least one pesticide simultaneously.

82. The method of any one of embodiments 78-80, wherein said population is contacted with the biocontrol agent and the at least one pesticide sequentially.

83. The method of any one of embodiments 78-82, wherein said triazole fungicide comprises at least one of propiconazole, tebuconazole, difenoconazole, tetraconazole, prothioconazole, metconazole, and flutriafol.

84. The method of any one of embodiments 78-82, wherein said strobilurin fungicide comprises at least one of azoxystrobin, pyraclostrobin, fluoxastrobin, and trifloxystrobin.

85. The method of any one of embodiments 78-82, wherein said anilide fungicide comprises at least one of fenhexamid, fluotolanil, and boscalid.

86. The method of any one of embodiments 78-82, wherein said aromatic fungicide comprises chlorothalonil.

87 The method of any one of embodiments 78-82, wherein said aryl phenyl ketone fungicide comprises metrafenone.

88. The method of any one of embodiments 78-82, wherein said organophosphorus fungicide comprises fosetyl-aluminum.

89. The method of any one of embodiments 78-82, wherein said pyridine fungicide comprises fluazinam.

90. The method of any one of embodiments 78-82, wherein said neonicotinoid insecticide comprises acetamiprid.

The following examples are offered by way of illustration and not by way of limitation.

### EXAMPLES

The present application discloses advanced pesticidal activity of the compositions and/or formulations according to the invention. Individual active compounds, such as the microbial strains or the chemical pesticides described herein, may have weaknesses with regard to pesticidal activity, for example either in terms of range of fungal pathogens the active compound is fungicidal against or in terms of the strength of fungicidal activity of the active compound against a particular fungal pathogen. However, combinations of a microbial strain plus a chemical pesticide may have an activity that exceeds that of the individual compounds, and further may have activity that exceeds a simple addition of activities. Similarly, the combination of a microbial strain described herein with a chemical insecticide may enhance the activity of the insecticide, either in terms of range or in insecticidal activity against a particular insect pest.

A synergistic effect is present when the pesticidal activity of the compositions and/or formulations exceeds the total of the activities of the active compounds when applied individually. The activity for a given combination can be calculated using Abbott's method for synergy calculation (Levy et al., 1986). Synergism between the mixtures of components is determined by calculating the ratio between the observed efficacy (E_{obs}) and the expected efficacy (Eₑₓₚ) where the expected efficacy is calculated using the equation: Eₑₓₚ=a+b−(ab/100). Here, a=percent disease control by chemical pesticide alone; and b=percent disease control of biological control agent (BCA) alone. A synergy ratio of >1 indicates a synergistic interaction.

### Example 1: Chemistries and Bacterial Strains to be Tested

The following table indicates the chemical fungicides to be tested. The FRAC (Fungicide Resistance Action Committee) code is also indicated. The chemical insecticide acetamiprid is also tested. Acetamiprid is a neonicotinoid in IRAC (Insect Resistance Actione Committee) group 4A.

TABLE 2
Fungicides tested

| | | | FRAC |
|---|---|---|---|
| Active ingredient^{a} | Chemical group | Group name^{b} | Code |
| Azoxystrobin | Strobilurines (methoxy- | QoI | 11 |
| | acrylates) | | |
| Fluoxastrobin | Strobilurines (dihydro- | QoI | 11 |
| | dioxazines) | | |
| Pyraclostrobin | Strobilurines (methoxy- | QoI | 11 |
| | carbamates) | | |
| Trifloxy strobin | Strobilurines (oximino | QoI | 11 |
| | acetates) | | |
| Boscalid | Carboxamides | SDHI | 7 |
| | (pyridine- | | |
| | carboxamides) | | |
| Flutolanil | Carboxamides (phenyl- | SDHI | 7 |
| | benzamides) | | |
| Penflufen | Pyrazole-carboxamides | SDHI | 7 |
| Chlorothalonil | Chloronitriles | multi-site contact | M05 |
| | (phthalonitriles) | activity | |
| Fenhexamid | Hydroxyanilides | KRI | 17 |
| Fluazinam | Pyridinamines (2,6- | multi-site contact | 29 |
| | dinitro-anilines) | activity | |
| Fosetyl- | Ethyl phosphonates | Phosphonates | P07 |
| Aluminum | Benzophenones | Aryl-phenyl- | 50 |
| Metrafenone | | ketones | |
| Difenoconazole | Triazoles | DMI | 3 |
| Flutriafol | Triazoles | DMI | 3 |
| Metconazole | Triazoles | DMI | 3 |
| Propiconazole | Triazoles | DMI | 3 |
| Prothioconazole | Triazoles | DMI | 3 |
| Tebuconazole | Triazoles | DMI | 3 |
| Tetraconazole | Triazoles | DMI | 3 |
| Triflumizole | Imidazoles | DMI | 3 |

^{a}Technical-grade of these fungicides were used, dissolved in the appropriate solvent
^{b}Group name: QoI = Quinone outside inhibitors; SDHI = Succinate-dehydrogenase inhibitors; KRI = KetoReductase inhibitors; DMI = Demethylation inhibitors

Bacterial strains known to have fungicidal activity are also tested. For these examples, the biological control agents SONATA® (Bayer CropScience LP, comprising Bacillus pumilus, strain QST2808, Accession No. NRRL B-30087; aqueous suspension that contains a minimum of 1×10⁹ CFU/gram), DOUBLE NICKEL55™ (Certis USA, LLC, comprising Bacillus amyloliquefaciens strain D747, Accession No. FERM BP-8234; WDG that contains a minimum of 5×10¹⁰ CFU/gram), and CEASE® (BioWorks®, comprising Bacillus subtilis strain QST713, Accession No. NRRL B-21661; aqueous suspension that contains a minimum of 1×10⁹ CFU/gram) are tested. It is known that similar assays may be performed using other commercially available pesticidal microbial strains recited herein.

### Example 2: Evaluation Against Fungal Pathogens

These bacterial strains and the diverse chemical fungicides of Table 1 are tested solo and in a mixture of both. They are tested for activity against Phakopsora pachyrhizi, the causal pathogen for Asian Soybean Rust (ASR), and against Podosphaera xanthii, the causal pathogen for powdery mildew on cucurbits.

### Example 2.1: Determination of Chemical Fungicide Concentrations for Fungal Pathogen Assays

To determine appropriate concentrations of chemical fungicide to test in combination with the bacteria strains described, fungicide dose-response curves are generated. Briefly, technical-grade of each fungicide is dissolved in an appropriate solvent (100 mg/mL) and subsequently in sterile water to make stock solutions of each at 100 μg AI/ml (“AI” is active ingredient). Fungicides are prepared by appropriate dilution of the stock solutions to obtain final concentrations of active ingredient within the range from 0.001 to 100 μg/ml. For example, a dilution of series of 0, 0.001, 0.01, 0.1, 1.0, 10.0, and 100.0 μg/ml may be prepared. A dilution series of each chemical fungicide is tested for activity against ASR by following the method described in Example 3.1 or for activity against Powdery mildew of curcurbits by following the method described in Example 3.2. Once the lowest concentration of chemical fungicide needed for activity is identified from that initial dilution series, additional assays with narrower ranges are subsequently performed. The minimal concentration of chemical fungicide needed for significant fungicidal activity for each fungal pathogen is thereby determined.

### Example 2.2: Determination of Bacterial Strain Concentrations for Fungal Pathogen Assays

Bacterial strains from SONATA®, DOUBLE NICKEL™, and CEASE® are each diluted with water to concentrations of 1×10⁸ CFU/ml, 1×10⁷ CFU/ml, 1×10⁶ CFU/ml, 1×10⁵ CFU/ml, 1×10⁴ CFU/ml, and 1×10³ CFU/ml. Each dilution of each bacterial strain is tested for activity against ASR by following the method described in Example 3.1 or for activity against Powdery mildew of curcurbits by following the method described in Example 3.2. Once the lowest concentration of the bacterial strain needed for activity is identified from that initial dilution series, additional assays with narrower ranges are subsequently performed. The minimal concentration of each strain needed for significant fungicidal activity for each fungal pathogen is thereby determined. Although these examples are directed toward these three bacterial strains, it will be appreciated that any of the pesticidal microbial strains described herein can be assayed in a similar manner.

### Example 2.3: Determination of Synergistic Interactions Between Chemical Fungicides and Bacterial Strains for Fungal Pathogen Assays

Once the minimal concentration of chemical fungicide or bacterial strain required for significant fungicidal activity is determined, the chemical fungicide and the bacterial strain are combined, each at concentrations at, near, and below the minimal concentration for activity. For example, prothioconazole at either 0.005 or 0.25 μg/ml may be combined with Bacillus amyloliquefaciens strain D747 at concentrations of 1×10⁵, 1×10⁶, or 1×10⁷ CFU/ml. In each example, the percent disease control is determined for each component acting independently or in combination in ASR or powdery mildew assays. An expected percent control for an additive interaction can be calculated using the Abbott method (described above). By comparing this calculated value with the experimentally observed disease control for each combination, those combinations that exhibit synergistic, rather than additive, interactions can be determined. It will be appreciated by one of skill in the art that similar assays may be performed between each of the chemical fungicides recited herein and each of the pesticidal microbial strains recited herein. Further, it will be appreciated by one of skill in the art that a similar assay may be performed between each of the chemical fungicides recited herein and a biostimulant, such as an plant extract derived from Reynoutria sachalinensis (e.g. REGALIA® from Marrone Biolnnovations).

### Example 3.1: Evaluation Against Asian Soybean Rust

Asian Soybean Rust (ASR), also referred to as Soybean Rust, is caused by the obligate fungal pathogen Phakopsora pachyrhizi Syd. The susceptible soybean cultivar Williams 82 is used to assay for fungicidal activity. Plants of Williams 82 are planted and placed inside a growth chamber (Percival Scientific, Inc., Boone, Iowa) maintained at 75% relative humidity with a cycle of 14 h of light (500 μmol m⁻² s⁻¹ PAR) and 10 h of darkness at 24 and 20° C., respectively, for a supply of 2- to 3-week-old rust-free leaves.

The inoculum used in these experiments is a mixture of P. pachyrhizi urediniospores obtained from infected soybean leaves collected from Gadsden County, Fla. in 2015 and 2016. Urediniospores are multiplied and maintained on detached leaflets of Williams 82 to produce adequate amounts of spores for the experiments. The details of maintenance and increase of spore numbers have been described elsewhere (Twizeyimana and Hartman 2010).

Soybean leaf discs (3-cm diameter each) are sprayed with 120 μl of the bacterial strain, the chemical fungicide, or a mixture of both. Leaf disks are then inoculated with 120 μl spore suspension (5×10⁴ spores/ml of sterile distilled water) of P. pachyrhizi a day after application of the fungicidal treatment. Both bacterial strain, chemical fungicide, and P. pachyrhizi inoculum applications are done using an atomizer attached to an air compressor (Twizeyimana and Hartman, 2010). Leaf disks are placed adaxial side down on saturated 20×20 cm filter paper (Whatman International Ltd., Kent, England) in a plastic container (Blister Box 20×20 cm, Placon, Madison, Wis.); two filter papers are used per box. Boxes with leaf disks are incubated in the dark for a period of 12 h followed by a cycle of 13 hours of light (380 μmol m⁻² s⁻¹) and 11 h of darkness inside a tissue chamber (Percival Scientific, Inc.) maintained at 23° C. and 95% RH. Prior to incubation, boxes are placed inside zip bags (Webster Industries, Peabody, Mass.).

The experimental design is a randomized complete block design with 2 replications and is repeated once. A negative inoculated control and a positive control using the fungicide Quadris® are also tested. Rust severity is scored by counting the number of sporulating uredinia in two arbitrary selected 1-cm diameter circle of leaf tissue from an inoculated leaf disk. Statistical significance differences (P<0.05) among the treatments are identified and evaluated.

### Example 3.2: Evaluation Against Powdery Mildew of Cucurbits

Powdery mildew on cucurbits is caused by Podosphaera xanthii. Leaf disks of squash leaves are used to assay for fungicidal activity. Leaf disks of healthy squash leaves are excised and cut into uniform leaf disks 35 mm in diameter using a large cork borer. An experimental unit consisted of a single leaf disk, each treated with a suspension of the selected bacterial strain and/or chemical fungicide. Controls are non-inoculated and inoculated leaf disks, AgBiome strain AFS000009 as a positive biological control, AFS000006 as a negative biological control, and the chemical fungicide tebuconazole at 10 ppm as an additional positive control. Each leaf disk is sprayed with 200 μL of the treatment (bacterial suspension, chemical fungicide, or a mixture of both) on the adaxial surface 24 hours before inoculation with the pathogen, Podosphaera xanthii (strain obtained from Dr. McGrath laboratory, Cornell University). After treatment with the fungicide, leaf disks were incubated in the dark for 24 hours at 23° C.

Following incubation, leaf disks are inoculated by spraying a 1×10⁶ suspension of P. xanihii conidia on the treated leaf surface, or for the positive control 10 μg/ml of the fungicide tebuconazole. Treatments are placed into sealed clear plastic boxes and incubated for six days at 25° C. with a relative humidity of 80% and a 12 hour photoperiod. This experiment is run once, with each treatment replicated two to three times. Each treatment is rated on a disease severity scale from 0 to 4, with 0 being no symptoms and 4 being greater than 50% of the leaf disk covered with colonies. The number of powdery mildew colonies is also recorded for each treatment. Data are analyzed in SAS JMP version 14.0.

### Example 4: Evaluation Against Sucking Pests

The pesticidal microbial strains recited herein may also be combined with chemical insecticides. These combinations may have an additive or a synergistic effect. The following examples describe combining acetamiprid with SONATA® (Bayer CropScience LP, comprising Bacillus pumilus, strain QST2808, Accession No. NRRL B-30087; aqueous suspension that contains a minimum of 1×10⁹ CFU/gram), DOUBLE NICKEL55™ (Certis USA, LLC, comprising Bacillus amyloliquefaciens strain D747; WDG that contains a minimum of 5×10¹⁰ CFU/gram), or CEASE® (BioWorks®, comprising Bacillus subtilis strain QST713; aqueous suspension that contains a minimum of 1×10⁹ CFU/gram). However, it will be appreciated by one of skill in the art that similar assays can be performed with any of the pesticidal microbial strains recited herein.

### Example 4.1: Determination of Chemical Insecticide Concentrations for Aphid Assays

To determine appropriate concentrations of chemical insecticide to test in combination with the bacteria strains described, insecticide dose-response curves are generated. Briefly, technical-grade of acetamiprid or any other chemical insecticide of interest is dissolved in an appropriate solvent (100 mg/mL) and subsequently in sterile water to make stock solutions of each at 100 μg AI/ml. Insecticides are prepared by appropriate dilution of the stock solutions to obtain final concentrations of active ingredient within the range from 0.0001 to 10 μg/ml. For example, a dilution of series of 0, 0.0001, 0.001, 0.01, 0.1, 1.0, and 10.0 μg/ml may be prepared. The dilution series is tested for activity against soybean aphids and green peach aphids by following the method described in Example 4.4. Once the lowest concentration of AI needed for activity is identified from that initial dilution series, additional assays with narrower ranges are subsequently performed. The minimal concentration of AI needed to have significant insecticidal activity against each pest is thereby determined.

### Example 4.2: Determination of Bacterial Strain Concentrations for Insecticidal Assays

Bacterial strains derived from SONATA®, DOUBLE NICKEL™, and CEASE® are each diluted with water to concentrations of 1×10⁸ CFU/ml, 1×10⁷ CFU/ml, 1×10⁶ CFU/ml, 1×10⁵ CFU/ml, 1×10⁴ CFU/ml, and 1×10³ CFU/ml. Each dilution of each bacterial strain is tested for activity against soybean aphids and green peach aphids by following the method described in Example 4.4. Once the lowest concentration of AI needed for activity is identified from that initial dilution series, additional assays with narrower ranges are subsequently performed. The minimal concentration of AI needed to have significant insecticidal activity against each pest is thereby determined. Although these examples are directed toward these three bacterial strains, it will be appreciated that any of the pesticidal microbial strains described herein can be assayed in a similar manner.

### Example 4.3: Determination of Synergistic Interactions Between Chemical Insecticides and Bacterial Strains for Insecticidal Assays

Once the minimal concentration of chemical insecticide or bacterial strain required for significant insecticidal activity is determined, the chemical insecticide and the bacterial strain are combined, each at concentrations at, near, and below the minimal concentration for activity. In each example, the percent disease control is determined for each component acting independently or in combination in aphid assays. An expected percent control for an additive interaction can be calculated using the Abbott method (described above). By comparing this calculated value with the experimentally observed disease control for each combination, those combinations that exhibit synergistic, rather than additive, interactions can be determined. It will be appreciated by one of skill in the art that similar assays may be performed between each of the chemical pesticides recited herein and each of the pesticidal microbial strains recited herein. Further, it will be appreciated by one of skill in the art that a similar assay may be performed between each of the chemical pesticides recited herein and a biostimulant, such as a plant extract derived from Reynoutria sachalinensis (e.g. REGALIA® from Marrone Biolnnovations).

### Example 4.4: Evaluation Against Aphids

The following in vitro assay is used to determine contact insecticidal activity against aphids (soybean aphids, Aphis glycines (SBA) and green peach aphids, Myzus persicae (GPA)). Aphid colonies were initiated at AgBiome from insects from North Carolina State University and Michigan State University. Five to ten aphids are removed from infested leaves with a paintbrush and placed on top of leaf discs cut from fresh un-infested leaves of 3-4 week old radish (or soybean) plants using a cork borer. One leaf disc is placed into each well of a 24-well plate on top of the agar solution. Plates are sealed with a pressure-sensitive adhesive film and 4 small air holes are punched into the film over each well. Plates are placed in a Percival growth chamber for 24 hours in order to allow aphids to acclimate before microbial application.

Leaf discs are removed from wells and submerged into treatment 3 times and then returned to each well. 24-well plates are placed under a fan to dry. Plates are re-sealed with a film and held in a Percival to maintain constant temperature and humidity. Observations for mortality, reproduction, and honeydew production are taken 3 days post-treatment. The bacterial strain or synthetic chemical pesticide is considered insecticidal when high aphid mortality, high nymph mortality, low reproduction and low honey dew production is observed in three or more independent assays.

What is claimed is:

1. A composition comprising:
(a) a biocontrol agent, wherein the biocontrol agent comprises:
(i) a cell, a spore, a forespore, or a combination of cells, spores, and/or forespores of one or more of the following bacterial strains: Bacillus amyloliquefaciens D747, Bacillus subtilis strain QST 713, Bacillus subtilis strain AQ30002, Bacillus subtilis strain AQ30004, Bacillus amyloliquefaciens strain GB03, Bacillus pumilus strain QST 2808, Bacillus pumilus strain GB34, Bacillus finnus strain CNMC 1-1582, Streptomyces lydicus strain WYEC108, Streptomyces griseoviridis strain K61, Agrobacterium radiobacter strain 1026, Agrobacterium radiobacter strain K84, Pseudomonas fluorescens strain A506, Bacillus thuringiensis subspecies aizawai strain GC-91, Bacillus thuringiensis subspecies kurstaki, Bacillus thuringiensis subspecies kurstaki strain EG7841, Bacillus thuringiensis subspecies kurstaki strain SA-12, Bacillus thuringiensis subspecies kurstaki strain ABTS-351, Bacillus thuringiensis subspecies kurstaki strain SA-11, Bacillus thuringiensis subspecies tenebrionis strain SA-10, Chromobacterium subtsugae strain PRAA4-1, Isaria fumosorosea Apopka Strain 97, Burkholderia spp. strain A396, and Bacillus thuringiensis subspecies aizawai strain ABTS-1857, or an active variant thereof, wherein the active variant comprises a cell, spore, forespore, or a combination of cells, spores, and/or forespores having a genome within a Mash distance of about 0.015, and/or
(ii) a cell, a spore, or a fungal part such as a piece of mycelium or hyphae, or a combination of cells, spores, and mycelia of one or more of the following fungal strains: Trichoderma harzianum strain KRL-AG2, Trichoderma harzianum strain T-22, Gliochladium vierns, aka Trichoderma vixens, strain GL-21, Coniothyrium minitans strain CON/M/91-8, Purpureocilium lilacinum, Ulocladium oudemansii U3 strain, Ulocladium oudemansii HRU3 strain, Beauveria bassiana strain GHA, or an active variant thereof wherein the active variant comprises a cell, spore, forespore, or a combination of cells, spores, and/or forespores having a genome within a Mash distance of about 0.015, and/or
(iii) a virus or virus isolate of one or more of the following viruses: Cydia pomonella granulovirus, Cydia pomonella granulovirus isolate V22, or polyhedral occlusion bodies of the nuclear polyhedrosis virus of Helicoverpa zea, and/or
(iv) a plant extract derived from Chenopodium ambrosioides or Reynoutria sachalinensis; and
(b) at least one chemical pesticide selected from the group consisting of a triazole fungicide, a strobilurin fungicide, an anilide fungicide, a pyridine fungicide, an aromatic fungicide, an organophosphorus fungicide, an aryl phenyl ketone fungicide, and a neonicotinoid insecticide;
wherein an effective amount of said composition controls a plant pathogen and/or plant pest.

2. The composition of claim 1, wherein said biocontrol agent is a bacterial or fungal strain or an active variant thereof, present at about 10³ CFU/gram to about 10¹² CFU/gram or at about 10³ CFU/ml to about 10¹² CFU/ml.

3. The composition of claim 2, wherein said bacterial or fungal strain or active variant thereof is present at about 10³ CFU/gram to about 10¹¹ CFU/gram or at about 10³ CFU/ml to about 10¹¹ CFU/ml.

4. The composition of claim 1, wherein said composition comprises a cell paste.

5. The composition of claim 1, wherein said composition comprises a wettable powder.

6. The composition of claim 1, wherein said plant pathogen is selected from the group consisting of Alternaria spp., Alternaria alternate, Alternaria solani, Aspergillus spp., Bipolaris maydis, Botryosphaeria dothidea, Botrytis spp., Botrytis cinerea, Bremia lactucae, Ceratobasidium spp., Cercospora spp., Cercospora nicotianae, Cercosporidium spp., Cladosprium caryigenum, Cochliobolus spp., Cochliobolus heterostrophus, Colletotrichum spp., Colletotrichum acutatum, Colletotrichum coffeanum, Colletotrichum graminicola, Diaporthe spp., Diaporthe citri, Didymella bryoniae, Diplocarpon rosae, Dreschlera spp., Elsinoe fawcetti, Entomosporium spp., Entyloma spp., Erisyphe spp., Erisyphe cichoracearum, Erisyphe graminis, Erisyphe (formerly Uncinula) necator, Erisyphe polygoni, Erwinia spp., Erwinia amylovora, Erwinia carotovora, Eutypa lata, Fusarium spp., Gloeosporium spp., Glomerella spp., Golovinomyces spp., Golovinomyces (Erisyphe) cichoracearum, Gymnosporangium juniperi-virginianae, Helminthosporium spp., Helminthosporium maydis, Hemileia vastatrix, Lanzia spp., Leveillula spp., Macrophomina phaseoli, Macrophomina phaseolina, Magnaporthe spp., Microsphaera diffusa, Moellerodiscus spp., Monilinia spp., Monilinia fructicola, Monilinia laxa, Monilinia vaccinia-corymbosi, Monosporascus cannonballus, Mycosphaerella citri, Mycosphaerella fijiensis, Mycosphaerella pomi, Myrothecium spp., Oidium spp., Oidiopsis spp., Olpidium spp., Peronospora spp., Peronospora mansherica, Pestalotia spp., Phayospora pachyrhizi, Phoma cucurbitacearum, Phomopsis spp., Phomopsis viticola, Phytophthora spp., Phytopthora infestans, Plasmopara viticola, Podosphaera spp., Podosphaera leucotricha, Pseudomonas spp., Pseudomonas syringae, Pseudomonas syringae pv. glycinea, Pseudomonas syringae pv. tomato, Pseudoperonospora spp., Puccinia spp., Puccinia pori, Puccinia sorghi, Pyricularia grisea, Pyricularia oryzae, Pythium spp., Ramularia spp., Rhizoctonia spp., Rhizoctonia solani, Sclerotinia spp., Sclerotinia sclerotiorum, Sclerotium spp., Sclerotium rolfsii, Sclerotium cepivorum, Septoria spp., Septoria glycines, Sphaceloma perseae, Sphaerotheca spp., Sphaerotheca macularis, Sphaerotheca pannosa, Taphrina deformans, Thanatephorus spp., Thielaviopsis basicola, Tilletia barclayana, Uromyces appendiculatus, Uromyces betae, Venturia spp., Verticillium spp., Wilsonomyces carpophilus, Xanthomonas spp., Xanthomonas arbicola pv. pruni, Xanthomonas campestris, Xanthomonas campestris pv. citri, Xanthomonas fragariae, and Zygophiala jamaicensis.

7. The composition of claim 1, wherein said plant pest is selected from the group consisting of Ostrinia nubilalis, Agrotis spp., Agrotis orthogonia, Agrotis Ipsilon, Helicoverpa spp., Helicoverpa zeae, Spodoptera spp., Spodoptera frupperda, Spodoptera exigua, Spodoptera eridania, Diatraea spp., Diatraea grandiosella, Elasmopalpus lignosellus, Diatraea saccharalis, Diabrotica spp., Diabrotica virgifera virgifera, Diabrotica longicornis barberi, Diabrotica undecimpunctata howardi, Melanotus spp., Cyclocephala spp., Cyclocephala borealis, Cyclocephala immaculata, Popillia japonica, Chaetocnema spp., Chaetocnema pulicaria, Sphenophorus maidis, Rhopalosiphum maidis, Anuraphis maidiradicis, Myzus persicae, Nezara viridula, Blissus leucopterus leucopterus, Melanoplus spp., Melanoplus femurrubrum, Melanoplus sanguinipes, Melanoplus differentialis, Hylemya spp., Hylemya platura, Hylemya coarctata, Agromyza parvicornis, Anaphothrips obscrurus, Solenopsis milesta, Tetranychus spp., Tetranychus turkestani, Tetranychus urticae, Chilo partellus, Elasmopalpus lignosellus, Feltia subterranea, Phyllophaga crinita, Eleodes spp., Conoderus spp., Aeolus spp., Oulema melanopus, Sphenophorus maidis, Sipha flava, Blissus leucopterus leucopterus; Contarinia sorghicola, Tetranychus spp., Tetranychus cinnabarinus, Tetranychus urticae, Pseudaletia umpunctata, Hypera punctata, Schizaphis graminum, Macrosiphum avenae, Mayetiola destructor, Sitodiplosis mosellana, Meromyza americana, Frankliniella spp., Frankliniella fusca, Cephus cinctus, Aceria tulipae, Cylindrocupturus adspersus, Smicronyx spp., Smicronyx fulus, Smicronyx sordidus, Suleima helianthana, Homoeosoma electellum, Zygogramma exclamationis, Bothyrus gibbosus, Neolasioptera murtfeldtiana, Heliothis virescens, Pectinophora gossypiella, Anthonomus grandis; Aphis spp., Aphis gossypii, Pseudatomoscelis seriatus, Trialeurodes abutilonea, Lygus spp, Lygus lineolaris, Thrips spp., Thrips tabaci, Colaspis brunnea, Lissorhoptrus oryzophilus, Sitophilus oryzae, Nephotettix nigropictus, Acrosternum hilare, Pseudoplusia includens, Anticarsia gemmatalis, Plathypena scabra, Epilachna varivestis, Empoasca fabae, Acrosternum hilare, Sericothrips variabilis, Schizaphis graminum, Euschistus serous, Jylemya platura, Mayetiola destructor, Petrobia latens, Vrevicoryne brassicae, Phyllotreta spp., Phyllotreta cruciferae, Phyllotreta striolata, Phyllotreta nemorum, Meligethes spp. Meligethes aeneus, Meligethes rufimanus, Meligethes nigrescens, Meligethes canadianus, Meligethes viridescens, Leptinotarsa spp., Leptinotarsa decemlineata, Spartocera batatas, Charidotella (=Metriona) bicolor, Cylas spp., Cylas formicarius, Cylas puncticollis, Cylas brunneus, Naupactus (=Graphognathus) spp., Conoderus spp., Conoderus rudis, Conoderus scissus, Blosyrus spp., Acraea acerata, Agrius convolvuli, Synanthedon spp., Euscepes postfasciatus, Peloropus batatae, Omphisia anastomasalis, and white grubs—larvae of various species of scarabid beetles.

8. The composition of claim 1, wherein said triazole fungicide comprises at least one of propiconazole, tebuconazole, difenoconazole, tetraconazole, triflumizole, prothioconazole, metconazole, and flutriafol.

9. The composition of claim 1, wherein said strobilurin fungicide comprises at least one of azoxystrobin, pyraclostrobin, fluoxastrobin, and trifloxystrobin.

10. The composition of claim 1, wherein said anilide fungicide comprises at least one of fenhexamid, flutolanil, penflufen, and boscalid.

11. The composition of claim 1, wherein said aromatic fungicide comprises chlorothalonil.

12. The composition of claim 1, wherein said aryl phenyl ketone fungicide comprises metrafenone.

13. The composition of claim 1, wherein said organophosphorus fungicide comprises fosetyl-aluminum.

14. The composition of claim 1, wherein said pyridine fungicide comprises fluazinam.

15. The composition of claim 1, wherein said neonicotinoid insecticide comprises acetamiprid.
